(19) United States
(12) Patent Application Publication
(10) Pub. No.: US 2023/0374851 A1
(43) Pub. Date: Nov. 23, 2023

(54) FRAMELESS SUPPLEMENTAL WINDOW FOR FENESTRATION

(71) Applicant: WexEnergy LLC, Rochester, NY (US)

(72) Inventors: Ronald M. WEXLER; Paul J. YARNALL

(21) Appl. No.: 18/029,827

(22) PCT Filed: Oct. 1, 2021
(86) PCT No.: PCT/US2021/053146

§ 371 Date: Mar. 31, 2023

Related U.S. Application Data
(60) Provisional application No. 63/087,011, filed on Oct. 2, 2020.
(60) Provisional application No. 63/213,642, filed on Jun. 22, 2021.
(60) Provisional application No. 63/218,722, filed on Jul. 6, 2021.

(51) Int. Cl. E06B 7/28; E06B 9/24

(52) U.S. Cl. CPC E06B 7/28; E06B 9/24; E06B 2009/2464; E06B 2009/2476

(57) ABSTRACT

A frameless supplemental window for fenestration incorporating infiltration blockers suitable for use with existing windows. The supplemental window, in one embodiment, comprises plastic sheet material with bullnose edging around it. Corner braces add rigidity and strength to corners in several embodiments. An attachment mechanism secured either to the sheet material or the bullnose edge functions to fasten and/or seal the supplemental window to an existing window. Infiltration blockers fastened to the sheet or bullnose prevent or minimize air leakage around various window elements. The bullnose edging and infiltration blockers function to substantially enclose (i.e. trap) a volume of air between the window pane and the plastic sheet material. The supplemental window is configured such that the layer of air enclosed is of an optimum thickness within a preferred range of 0.15 to 0.75 inches to maximize thermal insulation properties of the supplemental window.

### RELATED APPLICATIONS

This application claims priority to U.S. Application Serial Nos. 63/218,722, filed Jul. 6, 2021, 63/213,462, filed Jun. 22, 2021, and 63/087,011 filed Oct. 2, 2020, which are related to U.S. application Ser. No. 16/265,746, filed Feb. 1, 2019 and U.S. application Ser. No. 16/677,361, filed Nov. 7, 2019, which is a continuation-in-part of U.S. application Ser. No. 14/644,642, filed Mar. 11, 2015, which is a continuation-in-part of U.S. application Ser. No. 14/540,030, filed Dec. 12, 2014, which is a continuation-in-part of U.S. application Ser. No. 14/315,503, filed Jun. 26, 2014, now U.S. Pat. No. 9,234,381, which is a continuation-in-part of U.S. application Ser. No. 13/735,449, filed Jan. 7, 2013, now U.S. Pat. No. 8,923,650, all of which are incorporated herein by reference in their entirety.

### FIELD

The present technology relates generally to fenestration and in particular to a frameless supplemental window incorporating infiltration blockers and related method of construction and mounting for use with existing windows.

### BACKGROUND

In recognition of the ecological and cost impact of fossil fuels and other conventional energy sources, significant effort has been expended in developing methods for more efficient use of such energy sources. An important area of energy use for which greater energy efficiency is needed is the heating and cooling of spaces in which human activity is desired. Many approaches have been developed to decrease the amount heat transfer through the shell of such spaces. One of the most active and important areas of activity is the transfer of energy through fenestration where the activity has included use of window films or inserts, increasing the number of glazings per opening, and window treatments such as drapes, blinds, etc. While these approaches have shown considerable improvement in building energy efficiency, significant problems prevent more widespread and effective utilization.

Several problems exist in the approaches to minimizing heat transfer through fenestration. In particular for existing windows, it is desirable to maintain undistorted optical transparency, operation of the window treatments and windows and the aesthetics of the interior view of the window while providing thermal insulation. Furthermore, reuse of the insulating materials is highly desirable so that new materials do not need to be purchased each season. Supplemental windows known in the art either require the end user to customize one or more supplemental windows features to the dimensions of each window at the site of installation or are designed in ways that make size customization difficult in manufacturing.

When adding supplemental window features such as films, film support elements and window treatments, ease of installation (including measurement and fabrication), reusability and storage and aesthetics during and after use are very important while obtaining the thermal and radiation insulation desired. With window films intended for creating an additional “dead air” insulating layer adjacent to the window as well as window treatments, the dimension of the “dead air” space perpendicular to the window pane is subject to the film attachment areas that are generally dictated by existing features of the window and/or frame. In addition, such window films often must be mounted in such a way that inhibits the operability of non-fixed windows. Further, such window films are generally made for use only on the interior side of the window pane. Other window films, such as tints, infrared or ultraviolet reflective, or low-e films, generally adhere directly to the window pane and do not allow for simultaneous formation of an insulating layer.

Another problem with existing solutions is that most do not have any features designed to eliminate or reduce air flow or leakage around various elements of the window while maintaining operability of the window and associated window treatments with the supplemental window remaining in place. For example, it is common in sliding windows to have air leakage through the gaps between the jamb and the window frame, between the upper and lower sashes, between the sashes and the parts of the window frame that are in contact with them when in a closed state.

There is thus a need for a reduced cost frameless supplemental window that overcomes the disadvantages of prior art supplemental windows and that is effective at minimizing heat loss, retaining transparency and minimizing refractive index changes in the non-perimeter area of the window pane, is relatively simple to manufacture, prevents or minimizes air leakage between window elements, is easy to install and remove and does not impede the operability of the existing window.

### SUMMARY

The present technology is a frameless supplemental window for fenestration suitable for use with existing windows. The supplemental window, in one embodiment, comprises sheet material with an edging seal around it. In several embodiments, corner braces add rigidity and strength to corners in several embodiments. In other embodiments, corner braces also provide a portion of the corner closure of the edging seal. An attachment mechanism secured either to the sheet material or the edging functions to fasten and/or seal the supplemental window to an existing window. The edging functions to substantially enclose (i.e., trap) a volume of air between the window pane and the plastic sheet material. The supplemental window is configured such that the layer of trapped air is of an optimum thickness within a preferred range of 0.15 to 0.75 inches to maximize thermal insulation properties and mechanical stability of the supplemental window when mounted. Additional insulation may be provided by incorporating aerogel or porous glass layers with the sheet material or material that is placed over or on a frame portion of a window.

Several advantages of the supplemental window include (1) frameless designs that significantly reduce material cost; (2) decreased heat transfer through the window pane area; (3) retaining undistorted visual transparency through the window; (4) decreased heat transfer through the various window elements other than the window pane by the use of infiltration blockers; (5) having a reduced cost of manufacture; (6) ease of mounting and dismounting; (7) designable so as to not impede the operability of the existing window or associated window treatments; and (8) self adjusting dimensions to fit the window while allowing for measurement error.

The aesthetics of the fenestration during and after use of the supplemental window can be maintained. This relates to maintaining the appearance of the interior view of the fenestration and its immediate surrounding as well as the ability to see through the fenestration when desired. Also, it relates to the ability to return the fenestration to its original state when the supplemental element is not being used without the need to repair mounting areas.

Operability of the fenestration and associated treatment during use of the supplemental window can be maintained without the need to demount the entire supplemental window. Since the fenestration is often designed for opening and closing, it is beneficial to maintain this capability while the supplemental window is in place or to design the supplemental window to be very easily dismounted and remounted. This would allow for temporarily bringing fresh air into the space adjacent to the fenestration. This can be particularly useful during periods of moderate temperatures within a heating or cooling season.

The supplemental window also provides the ability to gain energy efficiency improvement during both heating and cooling seasons. The advent of spectrally selective, infrared reflective and low-emissivity coatings or laminates for window films provides for additional energy savings. Incorporation of such coatings or films in the sheet, infiltration blocker and/or edging provides an opportunity for combining these additional energy saving technologies with the insulating properties provided by the substantially enclosed air volume provided by the present technology. Optimal placement of such films, however, requires the ability to move such films to either keep heat in during the heating season or keep heat out in the cooling season.

Additional advantages may be provided by incorporating active layers such as electrochromic, thermochromic, liquid crystal, solar cells or similar components as layers or films added to the supplemental window. Such components may provide energy benefits such as dynamic shading, dynamic light blocking or energy collection in addition to the supplemental window insulation and/or ease of mounting to an existing window.

There is thus provided in accordance with the technology, a supplemental window apparatus, comprising a substantially non porous sheet material having dimensions defining a perimeter area of a window pane, a spacer and attachment mechanism operative to releasably attach the supplemental window apparatus to the window pane, wherein the spacer and attachment mechanism determine the distance between the window pane and the sheet material when the supplemental window apparatus is attached to the window pane, an infiltration blocker configured to substantially enclose the outward interior side of a volume of gas between the window pane and the sheet material when the supplemental window apparatus is installed, inhibit air leakage around one or more window elements into an interior space by simultaneous contact with both a movable window element and a stationary window element, and wherein the sheet material is positioned substantially parallel to the window pane.

There is also provided in accordance with the technology, a supplemental window apparatus, comprising an infiltration blocker constructed from a substantially non porous material, an attachment mechanism operative to releasably attach the infiltration blocker to an interior or inward facing surface of at least one of a window element and a second supplemental window apparatus, with a portion of the infiltration blocker residing on the interior side of the interface defined by two window elements, and wherein the infiltration blocker is operative to inhibit air leakage around one or more window elements into an interior space by simultaneous contact with at least one of, both a movable window element and a stationary window element, and both at least a portion of a second supplemental window apparatus and a stationary window element.

There is further provided in accordance with the technology, a supplemental window apparatus for improving the thermal insulating properties of an existing window, comprising a substantially non porous sheet material having dimensions defining a perimeter area of a window pane, an edge seal attached to the sheet material and operative to substantially enclose a volume of air between the window pane and the sheet material, a corner brace positioned in one or more corners of the supplemental window apparatus, each corner brace operative to provide support to the sheet material in the corner regions and to substantially block air movement through the supplemental window in the corner regions, a spring affixed to the pane side of the sheet material and configured to apply an outward force against a respective corner brace, an infiltration blocker configured to substantially enclose the outward interior side of a volume of gas between the window pane and the sheet material when the supplemental window apparatus is installed, inhibit air leakage around one or more window elements into an interior space by simultaneous contact with both a movable window element and a stationary window element, wherein attachment to the existing window is made via an adhesive strip located between the existing window element and at least one of the edge seal and the infiltration blocker, wherein a distance between the window pane and the sheet material when the supplemental window apparatus is installed is determined by at least one of the edge seal, the corner brace and the spring, and wherein the sheet material is positioned substantially parallel to the window pane.

### BRIEF DESCRIPTION OF THE DRAWINGS

The technology is herein described, by way of example only, with reference to the accompanying drawings, wherein:

FIG. 1 is a diagram illustrating a front view of a first example frameless supplemental window;

FIG. 2 is a diagram illustrating a front view of a second example frameless supplemental window;

FIG. 3 is a diagram illustrating a side sectional view A-A′ of the example window of FIG. 2;

FIG. 4A is a diagram illustrating a perspective view of one embodiment of the frameless supplemental window;

FIG. 4B is a diagram illustrating a perspective view of another embodiment of the frameless supplemental window;

FIG. 4C is a diagram illustrating a perspective view of an additional embodiment of the frameless supplemental window;

FIG. 5A is a diagram illustrating a first example of the corner brace;

FIG. 5B is a diagram illustrating a second example of the corner brace;

FIG. 5C is a diagram illustrating a third example of the corner brace;

FIG. 5D is a diagram illustrating a fourth example of the corner brace;

FIG. 6A is a diagram illustrating a first example of the spring mechanism;

FIG. 6B is a diagram illustrating a second example of the spring mechanism;

FIG. 6C is a diagram illustrating a third example of the spring mechanism;

FIG. 6D is a diagram illustrating a fourth example of the spring mechanism;

FIG. 6E is a diagram illustrating a fifth example of the spring mechanism;

FIG. 6F is a diagram illustrating a sixth example of the spring mechanism;

FIG. 7A is a diagram illustrating a first example of the corner sealing mechanism;

FIG. 7B is a diagram illustrating a second example of the corner sealing mechanism;

FIG. 7C is a diagram illustrating a third example of the corner sealing mechanism;

FIG. 7D is a diagram illustrating a fourth example of the corner sealing mechanism;

FIG. 7E is a diagram illustrating a fifth example of the corner sealing mechanism;

FIG. 7F is a diagram illustrating a sixth example of the corner sealing mechanism;

FIG. 8A is a diagram illustrating a first example of the attachment mechanism that pierces the sheet material;

FIG. 8B is a diagram illustrating a second example of the attachment mechanism that pierces the sheet material;

FIG. 8C is a diagram illustrating a third example of the attachment mechanism that pierces the sheet material;

FIG. 9A is a diagram illustrating a first example of the attachment mechanism that does not pierce the sheet material;

FIG. 9B is a diagram illustrating a second example of the attachment mechanism that does not pierce the sheet material;

FIG. 9C is a diagram illustrating a third example of the attachment mechanism that does not pierce the sheet material;

FIG. 9D is a diagram illustrating a fourth example of the attachment mechanism that does not pierce the sheet material;

FIG. 10A is a diagram illustrating a side sectional view of an example frameless supplemental window;

FIG. 10B is a diagram illustrating a side sectional view of an example frameless supplemental window incorporating two enclosed air layers;

FIG. 11A is a diagram illustrating a perspective view of a first example bullnose corner;

FIG. 11B is a diagram illustrating a perspective view of a second example bullnose corner;

FIG. 11C is a diagram illustrating a perspective view of a third example bullnose corner;

FIG. 11D is a diagram illustrating a perspective view of a fourth example bullnose corner;

FIG. 11E is a diagram illustrating a perspective view of a fifth example bullnose corner;

FIG. 12A is a diagram illustrating a perspective view of another embodiment of the frameless supplemental window;

FIG. 12B is a diagram illustrating a perspective view of an additional embodiment of the frameless supplemental window;

FIG. 12C is a diagram illustrating a perspective view of another embodiment of the frameless supplemental window;

FIG. 13A is a diagram illustrating a perspective view of an additional embodiment of the frameless supplemental window;

FIG. 13B is a diagram illustrating a side sectional view B-B′ of the example window of FIG. 13A;

FIG. 13C is a diagram illustrating an exploded view of the example window of FIG. 13A;

FIG. 14 is a diagram illustrating a front view of a first example frameless supplemental window incorporating infiltration blockers;

FIG. 15 is a diagram illustrating a side sectional view C-C′ of the example window of FIG. 14 incorporating a first example infiltration blocker;

FIG. 16 is a diagram illustrating a side sectional view C-C′ of the example window of FIG. 14 incorporating a second example infiltration blocker;

FIG. 17 is a diagram illustrating a side sectional view C-C′ of the example window of FIG. 14 incorporating a third example infiltration blocker;

FIG. 18 is a diagram illustrating a side sectional view C-C′ of the example window of FIG. 14 incorporating a fourth example infiltration blocker;

FIG. 19 is a diagram illustrating a side sectional view D-D′ of the example window of FIG. 14;

FIG. 20 is a diagram illustrating a perspective view of a corner portion of the example frameless supplemental window of FIG. 14 with infiltration blockers;

FIG. 21A is a diagram illustrating a top perspective view of a corner portion of an example supplemental window incorporating a reverse bullnose seal;

FIG. 21B is a diagram illustrating a bottom perspective view of a corner portion of an example supplemental window incorporating a reverse bullnose seal;

FIG. 21C is a transparent isometric view of an exemplary frameless supplemental window apparatus when installed in an existing window, with a corner of a sash/frame of the existing window cut away for clarity;

FIG. 21D is a side cross-sectional view of the exemplary frameless supplemental window apparatus when installed in an existing window shown in FIG. 21C;

FIG. 21E illustrates a top view (omitting tab 880) of the exemplary frameless supplemental window apparatus when installed in an existing window shown in FIG. 21C;

FIG. 21F is a side cross-sectional view of an exemplary configuration of an edge seal for use with the frameless supplemental window apparatus when installed in an existing window shown in FIG. 21C;

FIG. 21G is a side cross-sectional view of an exemplary configuration of an edge seal when interacting with a tab extending away from the window pane when the frameless supplemental window apparatus is installed;

FIG. 21H is a side cross-sectional view of another exemplary configuration of an edge seal when interacting with a tab extending away from the window pane when the frameless supplemental window apparatus is installed;

FIG. 21I is a side cross-sectional view of an exemplary configuration of an edge seal when interacting with a tab extending toward the window pane when the frameless supplemental window apparatus is installed;

FIG. 21J is a side cross-sectional view of another exemplary configuration of an edge seal when interacting with a tab extending toward the window pane when the frameless supplemental window apparatus is installed;

FIG. 21K is a side cross-sectional view of another exemplary configuration of an edge seal interacting with a sealing material when the frameless supplemental window apparatus is installed;

FIG. 22 is a diagram illustrating a top view of an example awning type window with a frameless supplemental installed therein;

FIG. 23 is a diagram illustrating an isometric view of a corner portion of the window of FIG. 22;

FIG. 24 is a diagram illustrating a side sectional view E-E′ of the window of FIG. 22;

FIG. 25 is a diagram illustrating an isometric view of a corner portion of a window with a frameless supplemental window where attachment is via the infiltration blockers;

FIG. 26 is a diagram illustrating a side sectional view of the window of FIG. 25;

FIG. 27 is a diagram illustrating a perspective view of an example supplemental window with infiltration blocker in the area of the check rail and jamb;

FIG. 28 is a diagram illustrating a first example frameless supplemental without a bullnose seal and incorporating infiltration blockers;

FIG. 29 is a diagram illustrating a second example frameless supplemental without a bullnose seal and incorporating infiltration blockers overlapping in corner areas;

FIG. 30 is a diagram illustrating a side sectional view in the region of the check rail of a third example frameless supplemental without a bullnose seal and incorporating infiltration blockers; and

FIG. 31 is a diagram illustrating a side sectional view of a fourth example frameless supplemental without a bullnose seal and incorporating infiltration blockers.

FIGS. 32A and 32B are cross sectional views of an edge region of an exemplary supplemental window apparatus when mounted.

FIG. 33A is a cross sectional view of an edge region of an exemplary supplementary window having a thin creased edge seal.

FIGS. 33B through 33L illustrate additional exemplary creased seals.

FIGS. 33M through 33P illustrate embodiments of very low clearance supplemental window apparatuses

FIGS. 34A and 34B illustrate an embodiment of corner closure that may be employed when using a flap.

FIGS. 35A through 35C are cross sectional views of exemplary supplemental window apparatuses incorporating an active device.

FIGS. 36A through 36E illustrate further embodiments for attaching a supplemental window apparatus to a window.

FIGS. 36F and 36G illustrate a slot as found in FIGS. 36B-36E.

FIGS. 37A through 37D illustrate embodiments for closure around a muntin

FIGS. 37E and 37F illustrate embodiments for offsets.

FIGS. 38A through 38C illustrate embodiments for cutouts.

FIGS. 39A through 39C illustrate embodiments for cutouts.

FIGS. 40A through 40E illustrate embodiments for cutouts and edge spacers.

FIGS. 41A and 41B illustrate embodiments for liners.

FIGS. 42A through 42H illustrate embodiments for tiling of supplemental window apparatuses.

### DETAILED DESCRIPTION

The technology is described below, with reference to detailed illustrative embodiments. It will be apparent that the technology can be embodied in a wide variety of forms, some of which may be quite different from those of the disclosed embodiments. Consequently, the specific structural and functional details disclosed herein are merely representative and do not limit the scope of the invention.

The present technology provides for several embodiments for mounting of sheet material in or over fenestration and substantially enclosing or trapping a volume of gas in or adjacent to the fenestration. The term “frameless supplemental window” in the present technology refers to a supplemental window that lacks a substantially rigid or non-flexible structure completely surrounding an area that is approximately the same size as the window pane on which the supplemental window is to be mounted.

In the present technology, in one embodiment, sheet material, a spacer or post of predetermined dimension perpendicular to the sheet material, a bullnose edge seal, a corner brace, spring mechanism and infiltration blocker are combined together to provide a frameless supplemental window unit that substantially encloses and traps a volume of gas (typically air but not limited to air). Optionally, the sheet material (typically clear but may be tinted or coated) may function as a portion of the edge seal. In one embodiment, the post may contact or attach to the window pane of the fenestration. The sheet material can be any desired type of material such as, but not limited to, clear, non-opaque, translucent, low emissivity, semi-transparent, opaque, visible light transmitting, infrared reflecting or a material having minimal refractive distortion when viewed from the interior side of the window, etc. The extent of visible light transmission properties of the sheet material is not critical to the insulation aspect of the technology, although it is preferred to maintain as much as much undistorted optical clarity as possible to maintain the function of the window for viewing through the fenestration.

In a further embodiment, the sheet material may comprise an electrically or thermally active material, layer or device, such as electrochromic, polymer dispersed liquid crystal or solar cell materials, layers or devices or thermochromic materials. When electrically active components are used, stiffening parts located at or near the perimeter of the supplemental window may provide a dual function of acting as a busbar oriented perpendicular to the active layer. With the busbar stiffener having a much smaller dimension parallel to the windowpane compared to its dimension perpendicular to the windowpane, the optical and aesthetic impact of the busbar on the viewing area of the window is minimized while maximizing the stiffening effect and providing electrical conductivity in the desired region of a device. Electrical connection of the stiffener to the electrically active component may be accomplished through via holes in the sheet when the electrically active component resides on the opposite side of the sheet from the stiffener. The power source for active materials requiring external power may be derived from a battery or from an AC power source such as a wall outlet located near the window to which the supplemental window apparatus is attached. Connection from such external power to the supplemental window apparatus may be made using an electrically conductive wire, strip or similar connection. When using a battery, the battery may be attached to the supplemental window apparatus. In one example, the battery is attached to the supplemental window apparatus in a location that is not optically intrusive, such as at a corner or edge. When a flap is present as part of the supplemental window apparatus, the battery may be attached to the flap. In one example the smallest dimension of the battery is positioned parallel to the flap.

Note that such embodiments may be specified using manual measurement of the fenestration or portions thereof or, specified and delivered using the methods described in U.S. Pat. No. 8,923,650 to Wexler cited supra and U.S. application Ser. No. 14/320,973, entitled “System And Method Of Measuring Distances Related To An Object” to Wexler et al., both of which are incorporated herein by reference in their entirety. In addition to these measurement methods, the methods described in U.S. application Ser. No. 14/320,973 may be used to confirm the accuracy of manual measurements taken by the user that are provided to the service provider or fabricator as well as to provide feedback to the manual measurement taker regarding such accuracy, optionally including a request for re-measurement is the measurements do not pass certain criteria.

Various terms are used in the art to describe aspects of fenestration and windows in particular. In describing the present technology, “window” may refer to window components within a single frame that includes one light or multiple lights that are not separated by a mullion or transom. In describing the present technology, the terms “interior” and “exterior” are used to describe the indoor side and outdoor side, respectively, relative to a perimeter wall in which the fenestration resides. “Inward” and “outward” refers to location in a direction closer to and further from, respectively, the center of the fenestration. The term “window element” refers to any window part including but not limited to the window pane, frame, sash, rail, style, muntin, track, check rail, jamb, or parts thereof.

Note that various people or entities may perform different aspects of the present technology. An “end user” refers to a person or entity or their designee, that specifies, orders, installs or uses the supplemental parts of the present technology and may perform digital image capture, supply metadata and/or confirmation of design steps of the process of the present technology. A “service provider” refers to a person or entity performing a service that is part of the method of the present technology such as reviewing and accepting or confirming orders from an end user, providing image processing capability, designing (as a “designer”), fabricating (as a “fabricator”) or installing (as an “installer”) parts, or providing support for installation of such parts.

Each supplemental window embodiment creates a substantially “dead air” space or layer of substantially enclosed or trapped air adjacent to a window pane, preferably having a dimension between the window pane and clear sheet in the range of approximately 0.15 to 0.75 inches that provides insulating properties and preferably inhibits the formation of convective loops. A dimension less than about 0.15 inches will likely impact insulating properties and a dimension greater than about 0.75 inches will likely lead to undesirable convective heat transfer. Such “dead air” spaces optionally may have a desiccant material contacting the “dead air” space to keep the humidity of the space low and decrease the possibility of condensation forming in the space, particularly when one side of the space is a window pane in direct contact with the outdoors.

To allow for actuation of window or window treatment operating elements with the supplemental parts mounted, the plastic sheet may be mounted such that the entire supplemental window unit, or a portion thereof is mounted so as not to interfere with movement or actuation of any window treatment, window treatment operating elements or moveable portions of the window. One aspect of the current technology that enables opening and closing of the window, especially for vertical or horizontal sliding windows, is the capability for easy mounting and dismounting of part of the custom supplemental window apparatus.

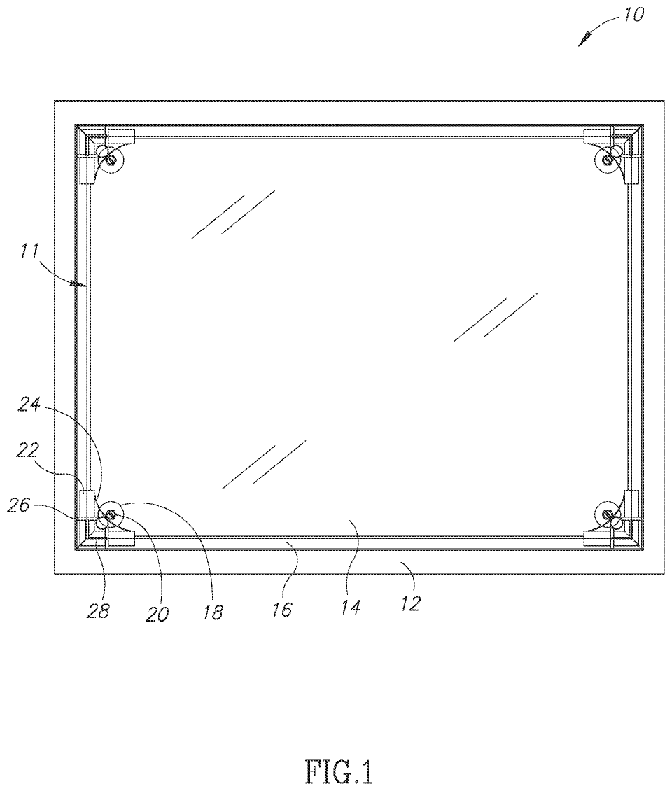

A diagram illustrating a front interior view of a first example frameless supplemental window is shown in FIG. 1. The window, generally referenced 10, comprises an existing window frame or sash 12, a frameless supplemental window 11 mounted on the existing window and window pane (not in view) exterior to the supplemental window 11. Note that the supplemental window may be mounted to the exterior side of the window pane such that the window pane faces the interior side of the supplemental window. The supplemental window comprises sheet material 14, a bullnose edge or seal 16, corner brace 22, post 20 with attachment mechanism 18 (e.g., suction cup), spring 24 and seals 26 and 28 (e.g., pile, O-ring, gel, dry adhesive material, foam, etc.). Note that the sheet material defines a perimeter area that extends between the edge of the sheet projected onto the window pane and the nearest edge of the window pane. Also, note that while the seal 16 of this embodiment and seal embodiments described infra show a bullnose shape and a spiral shape, other shapes that seal to the sheet and form an enclosed space with the window pane are contemplated by and may be used in the current technology. Such other shapes may include, but are not limited to, “[” shape, “<” shape or “˜” shape edge or seal. When attaching a seal to a planar sheet, it may be beneficial to form a cross-sectional seal shape having a planar portion for attaching to the sheet and a corner that is bent or formed to aid in conforming to a corner brace or closure such as described infra.

The sheet material may comprise, for example, a polymer plastic material such as polyethylene terephthalate (PET), polyethylene terephthalate glycol (PET-G) or polypropylene (UV stabilized preferred) or thin flexible glass such as is known in the art. Additional insulating properties may be obtained by adding or incorporating into, on or with the sheet, aerogel or porous glass materials such as those described in U.S. Published Patent Application No. 2019/0333490, the disclosure of which is incorporated by reference in its entirety. When using polymer plastic material such as PET, the recommended thickness is in the range from about 3 to about 20 mil. When forming the spacer and foot from the sheet material such that all are formed from a single continuous piece of material, 10 to 20 mil thickness is employed to minimize optical distortions and keep such distortions localized to the perimeter area. Also, this thickness range provides for 1) a thin slot dimension and smaller constraint step when a constraint is used so that less material use is required, 2) improved user handling compared to smaller thicknesses, 3) maintaining a light weight and 4) ease of forming the spacer and foot. Note that polymer plastic sheets thicker than approximately 60 mil may lead to pane attachment failure and more difficult handling for the user. Sheets thinner than about 3 mil may lead to handling difficulty in manufacture, ease of out of plane deformation/deflection when mounted and reduced durability. The factors used in determining the thickness include ease of handling by the user, weight constraint for reduced cost, the mounting integrity and the size of the attachment (i.e. higher weight may necessitate larger attachment area to the window pane. For example, to stay within a standard “mini” size suction cup total rating of about 2 pounds for four suction cups, a sheet thickness less than about 70 mil is required for PET material or less than about 40 mil for flexible glass for a sheet area of about two square feet.). When using other attachment mechanisms, however, such as dry adhesive or 3M VHB acrylic adhesive mechanisms describe infra, thicker sheet material may be used as a result of high load capability and larger attachment surface area. The combination of thermally shaped seal beam strength and sheet thickness provides ease of handling. For PET, a sum of the edging seal and sheet thicknesses is preferably greater than about 6 mil for ease of handling.

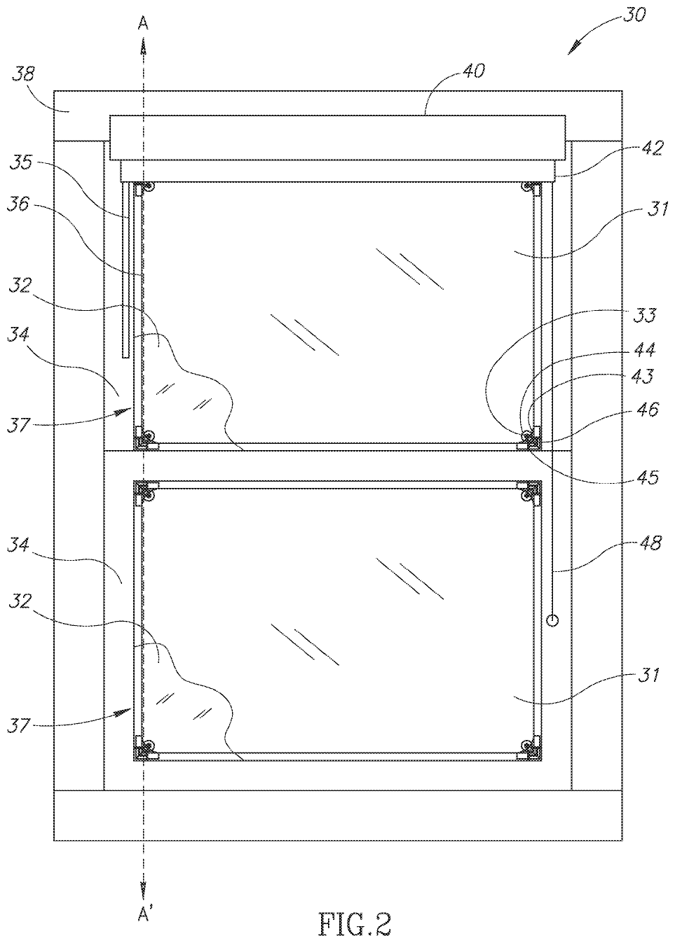

A diagram illustrating a front view of a second example frameless supplemental window is shown in FIG. 2. The vertical sliding window (e.g., double hung window), generally referenced 30, comprises an existing window frame 38 such as found in vertical sliding (single or double hung) windows having a bottom sash that is moveable. The upper and lower window sashes each have a frameless supplemental window installed on the upper and lower window panes 31, respectively. The sheet material 32 of the lower and upper supplemental windows is partially shown for illustration purposes and normally covers all or nearly all of the window pane. The window 30 comprises an existing window frame 38, upper and lower sash 34 holding the window panes 31, upper and lower frameless supplemental window 37, window treatment (e.g., blind) including header 40, retracted blind 42, lift cord 48 and wand 35. Each supplemental window 37 comprises sheet material 32, a bullnose edge or seal 36, corner brace 46, post 33 with attachment mechanism 44 (e.g., suction cup), spring 43 and seal (e.g., pile, O-ring, gel, dry adhesive material, foam, etc.) 45.

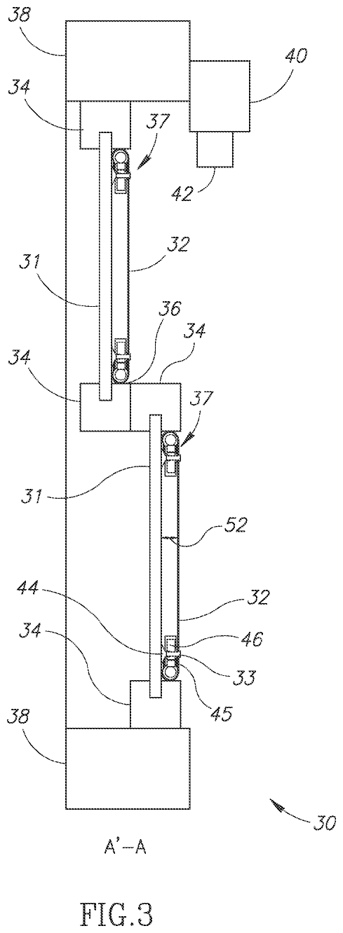

A diagram illustrating a side sectional view A-A′ of the example window of FIG. 2 is shown in FIG. 3. The window, generally referenced 30, comprises lower and upper existing window frame and sill 38, window treatment (e.g., blind) including header 40, retracted blind 42, upper and lower window pane 31, upper and lower sash rails 34 of the upper and lower windows and upper and lower supplemental windows 37. Both upper and lower supplemental windows 37 comprise sheet material 32, corner brace 46, post 33 with attachment mechanism 44 (e.g., suction cup), bullnose edge or seal 36, seal (e.g., pile, O-ring, gel, foam, etc.) 45 creating substantially enclosed (or trapped) space (e.g., air) 52 between the plastic sheet and window pane.

In the window of FIGS. 2 and 3, the attachment mechanism and viewable area through the plastic sheet are predominantly within the pane viewable area. For interior or exterior mounting, the supplemental window unit spacing and thickness dimensions perpendicular to the pane 31 that would reside within the sash-to-sash interface during opening and closing operation of the window may beneficially be made smaller than the spacing and thickness dimensions of the supplemental window unit perpendicular to the pane 31 that would not reside in the sash-to-sash interface during operation of the window. As is also shown in FIGS. 2 and 3, the supplemental window unit on the top sash is exterior to the movement path of the bottom sash so that the window remains operable with the supplemental window unit in place.

In the case of vertical or horizontal sliding windows, the supplemental window sheet to pane spacing dimension over the stationary portion may beneficially be made smaller (e.g., to as small as about 0.15 inch) than the supplemental window sheet to pane spacing dimension over the sliding portion to allow the custom supplemental window unit to remain in place when opening the window by sliding the sliding portion. In such a case, the supplemental window members for mounting the plastic sheet should also have a dimension perpendicular to the attached sheet of less than about 0.25 inch. A similar mounting arrangement may be used for horizontal sliding windows to allow operability of the window. Alternatively, operability of the sliding portions of windows may be achieved by dismounting the supplemental parts on the stationary sash prior to opening the window and remounting after closing the window. In such cases, the supplemental window unit spacing dimension on the non-moving sash may be made larger than the distance between the non-moving sash pane and movable sash.

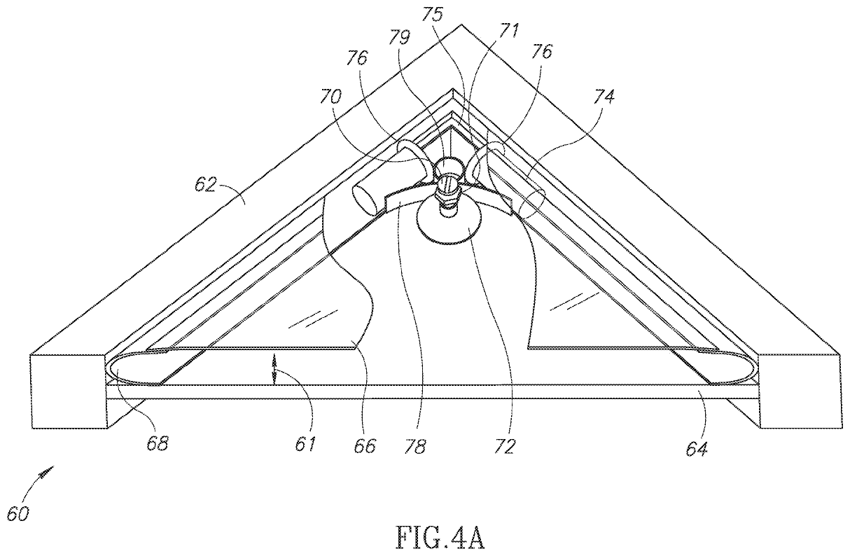

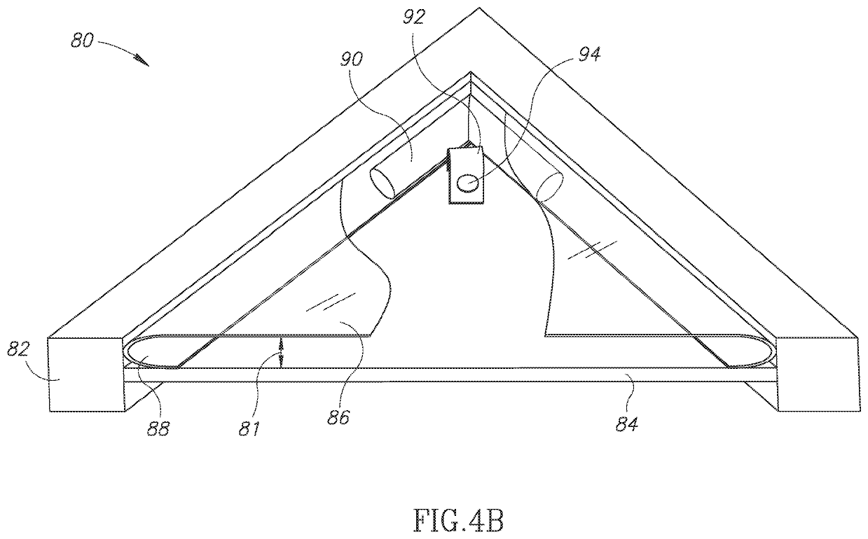

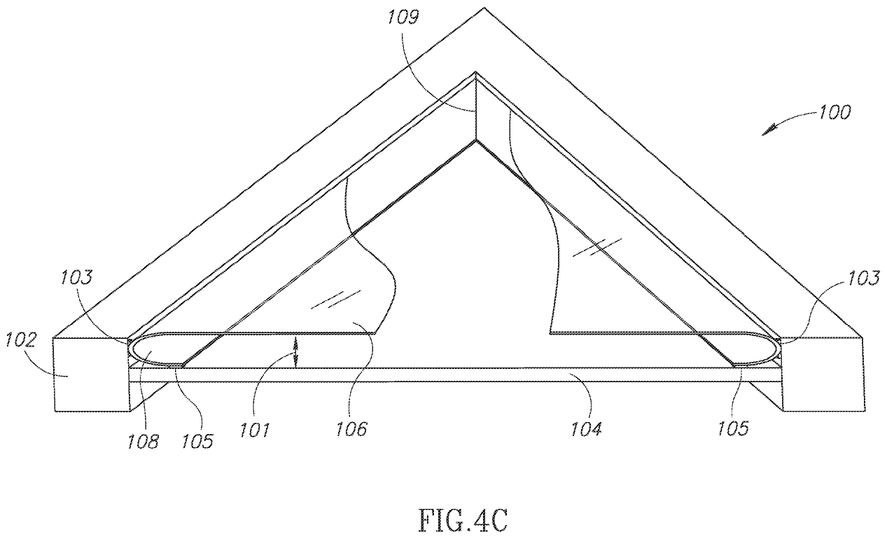

A diagram illustrating a perspective view of one embodiment of the frameless supplemental window is shown in FIG. 4A. The window, generally referenced 60, comprises the window frame or sash 62, window glass pane 64, sheet material 66, bullnose edge seal 68, corner brace 74, O-ring or pile seal 76, post 70, attachment mechanism 72 and springs 78, 79. While two springs are shown, either one alone may be used or both may be used together. The sheet material is only partially shown to allow the corner area of the supplemental window to be shown. In one embodiment, sheet material 66 is a part separate from but bonded to the bullnose edge seal part 68. They may comprise the same or different materials and/or the same material but different thicknesses. Alternatively, sheet 66 and edging 68 may be fabricated from the same single sheet of material as a unitary element.

While edging 68 is shown in a preferred attaching configuration to the surface of sheet 66 that is closer to pane 64, this attachment may alternatively be made to the surface of sheet 66 that is further from pane 64. The bullnose edge can be formed by forcing the edge into an arced shape and heat treating the material while in such arced shape such that the material retains an approximate ‘U’ shape after the heat source is removed. The arc generated by the bullnose edge compresses upon mounting, contacts the pane near its perimeter substantially enclosing the air space and aids in keeping the sheet material from sagging toward the window pane. Suitable materials for use as the bullnose edge include polyethylene terephthalate (PET), polyethylene terephthalate glycol-modified (PETG), polypropylene, or polyethylene, e.g., about 2 mil to about 10 mil thick, preferably about 2 mil to about 6 mil thick PET commercially available under a variety of trade names. When using PET, PETG, polyethylene or polypropylene, an ultraviolet stabilizer may be incorporated in the material to improve the useful life of the supplemental window. Ultraviolet absorbing stabilizers may be incorporated in the material or a cap layer to also inhibit ultraviolet degradation of items on the interior side of the supplemental window apparatus. Such ultraviolet absorbing stabilizers are beneficially used to extend the lifetime of supplemental window insulation materials. For example, a cap layer, containing ultraviolet absorbing material, placed on the exterior surface of sheet material can extend sheet lifetime while simultaneously inhibiting degradation of items on the interior side.

The edge material may be optically clear, semi-transparent, translucent or opaque. Non-limiting examples of non-clear materials include plastic materials comprising gas or air micro-voids or high index materials, such as an inorganic oxide or sulfate materials, such as may be found in commercially available materials such as the well known Melinex™ or Hostaphan™ line of film products such as manufactured by Mitsubishi Polyester Film, Inc., Mitsubishi Plastics, Inc., Greer, South Carolina, USA. While the edge material embodiments described show the edge material to comprise an open arc, the edge material may comprise a closed arc such as would be formed using, for example, extruded tubing having a wall thickness similar to that described for the open arc.

The post 70 pierces and is fastened to the sheet material via any suitable mechanism such as a screw 70 and nut 71. The attachment mechanism 72 is fastened to the portion of the post adjacent to the pane 64. In this example, the attachment mechanism is a suction cup. Additional options for the attachment mechanism are described in more detail infra. The spring mechanism in this example comprises a relatively flat plastic or metal band 78 fastened to a circular shaped element 79. Resting against the post, the function of the spring mechanism is to apply an outward force against the corner brace 74 to maintain its position against the corner of the window frame or sash 62. Alterative options for the spring mechanism are described in more detail infra.

The corner brace 74 may be fabricated from any suitable material such as a solid plastic or a closed cell foam and functions to (1) provide structural rigidity to the corner portions of the supplemental window, (2) provide a platform for one or more seals 76 to prevent the leakage of air into or out of the trapped air layer 61 formed between the sheet material 66 and the window pane 64, or (3) provide a mechanism for preventing such leakage in instances when the corner is not otherwise sealed. Alternative options for the corner brace and sealing mechanisms are described in more detail infra.

Note that in this embodiment, the combination of the post and attachment mechanism not only provides the means of attaching the supplemental window to the windowpane but also sets the optimum spacing between the window pane and the sheet material. Alternatively, these functions may be provided by independent elements, e.g., a separate discreet offset spacer may be inserted between the window pane and the sheet material, the spacer function is provided by a spacer mechanism (e.g., post, etc.) or any other suitable means for providing this function. In these alternative embodiments, the attachment mechanism is not required to perform any spacing function and thus there is no spacing related constraint on the dimensions of this element.

Note that the spacing function can be achieved in numerous ways with the actual implementation not critical to the technology. In one embodiment, the spacing function can be provided by a discrete spacer part (not shown). In another embodiment, the spacer function can be incorporated into the attachment mechanism (i.e. the post or mounting mechanism) can be made a specific length to provide the proper spacing between the window pane and plastic sheet. In yet another embodiment, the spacer function can be provided by a stiff bullnose edge material or a closed corner comprised of a contiguous or welded bullnose edge material constructed using any suitable means such as thermoforming. Alternatively, the spacing function can be incorporated into the corner brace via a projection or other means where the thickness of the corner brace and any projection is set to a length that provides the proper spacing between the window pane and plastic sheet.

A diagram illustrating a perspective view of another embodiment of the frameless supplemental window is shown in FIG. 4B. The window, generally referenced 80, comprises the window frame or sash 82, window glass pane 84, sheet material 86, bullnose edge seal 88, corner brace 90, optional O-ring or pile seal (not shown), spring mechanism 92 and fastener 94. The sheet material is only partially shown to allow the corner area of the supplemental window to be shown. In one embodiment, sheet material 86 is separate from but bonded to the bullnose edge seal 88. They may comprise the same or different materials and/or the same material but different thicknesses. Alternatively, they made be fabricated from the same single sheet of material as a unitary element. The bullnose edge can be formed by forcing the edge into an arced shape and heat treating the material while in such arced shape such that the material retains an approximate ‘U’ shape after the heat source is removed.

In this embodiment, the spring mechanism 92 comprises a ‘U’ shaped piece of plastic or metal fastened to the sheet material via any suitable means 94 such as a screw, rivet, adhesive, etc., which may or may not pierce the sheet material. The function of the spring mechanism is to apply force against the corner brace 90 to maintain the position of the corner brace in the corner of the window frame 82. The spring mechanism may or may not also function to determine the optimal spacing 81 for the trapped air layer between the sheet material 86 and the window pane 84. Spring mechanism 92 may be used in conjunction with attachment mechanisms described both supra and infra.

A diagram illustrating a perspective view of an additional embodiment of the frameless supplemental window is shown in FIG. 4C. This example embodiment is not only frameless but also lacks a corner brace and spring unlike the embodiments of FIGS. 4A and 4B described supra. The window, generally referenced 100, comprises the window frame or sash 102, window glass pane 104, sheet material 106 and bullnose edge seal 108. The sheet material is only partially shown to allow the corner area of the supplemental window to be shown. The sheet material 106 can be separate from but bonded to the bullnose edge seal 108 as described supra, or as shown in this embodiment, they may be constructed from the same material as a single integrated entity. They may comprise the same or different materials and/or the same material but different thicknesses. Alternatively, they made be fabricated from the same single sheet of material as a unitary element. The bullnose edge can be formed by forcing the edge into an arced shape and heat treating the material while in such arced shape such that the material retains an approximate ‘U’ shape after the heat source is removed.

In this embodiment, the corners of the bullnose edge are mitered and bonded using any suitable means, such as gluing, heat welding, laser welding, ultrasonic welding, solvent welding, stapling, etc. Regardless of the actual mechanism used to form the mitered corners, it is important that the bond be substantially air tight so as to prevent leaks of air into or out of the enclosed or trapped air layer 101. The portion of such bullnose edge corner that is perpendicular to sheet 106, shown as corner 109, may be a contiguous piece of bullnose edge material or may be a joint formed by separate bullnose edge 108 pieces bonded using any of the suitable means described supra.

In addition, the bottom portion of the bullnose edge seal 108 optionally comprises a strip 105 of sealing material substantially along the entire perimeter defined by the bullnose edge seal adjacent to pane 104. This sealing material may comprise any suitable material such as an oil coating, grease coating, gel, dry adhesive material, foam, rubber, etc. Examples of suitable dry adhesive materials include double sided tape, nanosuction adhesive material EverSTIK Nanosuction material sold by UM! Brands, Chino, California, USA, materials and methods such as those described in U.S. Pat. Nos. 8,206,631; 8,398,909; and U.S. Publication Nos. 2012/0319320; 2012/0328822; and 2013/0251937 or Geckskin™ materials and structures. Preferably, the properties of the material are sufficient to provide functions of both (1) sealing the enclosed air layer; and (2) affixing (i.e. adhering) the supplemental window to the window pane. These functions may be achieved by a single strip 103 or 105 of material placed, respectively, at the side of the bullnose edge contacting the window frame or sash 102, or at the bottom (near the pane 104) of the bullnose edge. Alternatively, they may be achieved utilizing two separate strips of materials: (1) a first strip 105 on the bottom of the bullnose edge for sealing the trapped air layer; and (2) a second strip 103 on the side of the bullnose edge for contacting the supplemental window to the window frame or sash. Alternatively, the functions of the strips may be reversed with the strip on the side of the bullnose edge providing sealing and the strip on the bottom of the bullnose edge providing adhesion to the window pane.

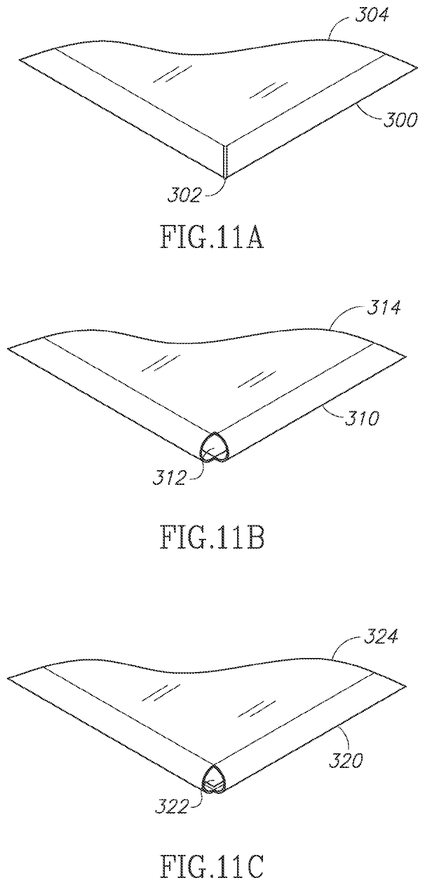

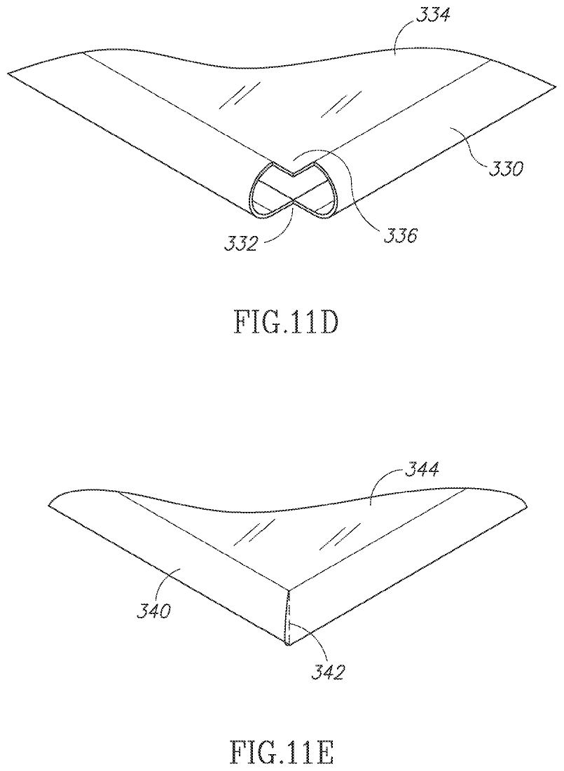

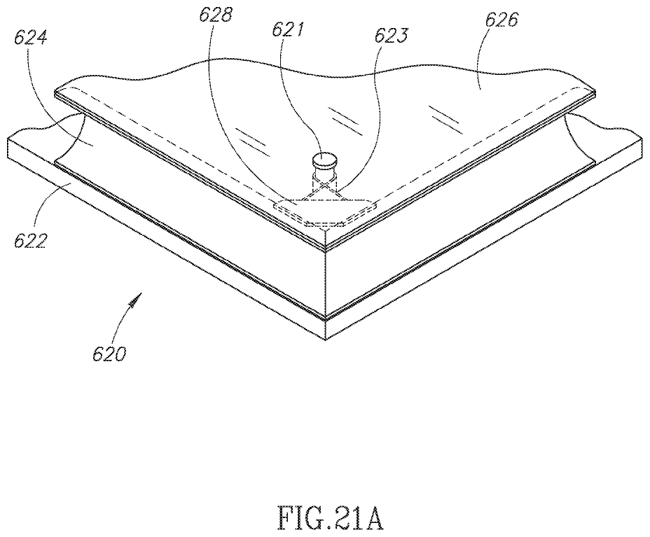

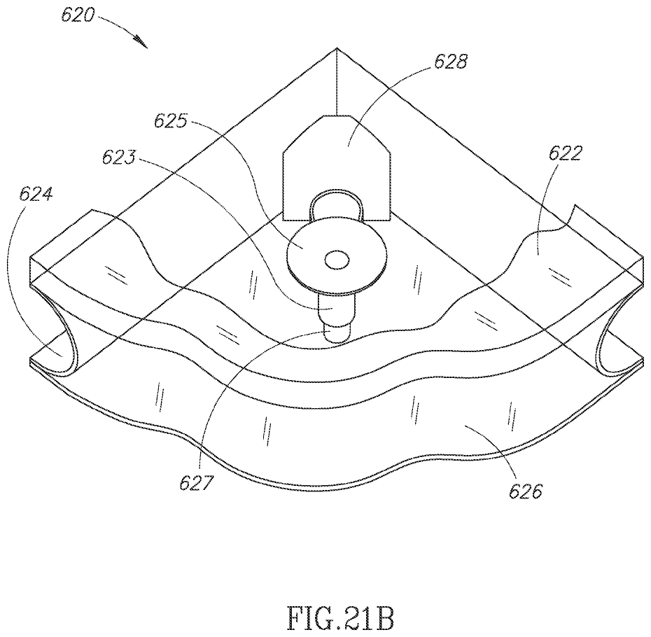

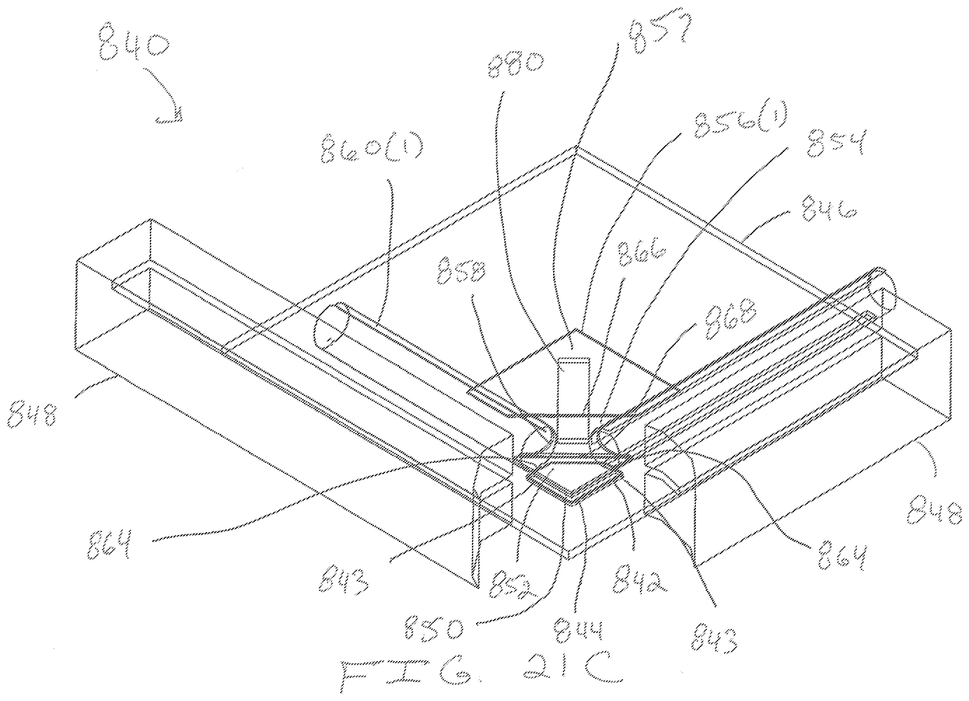

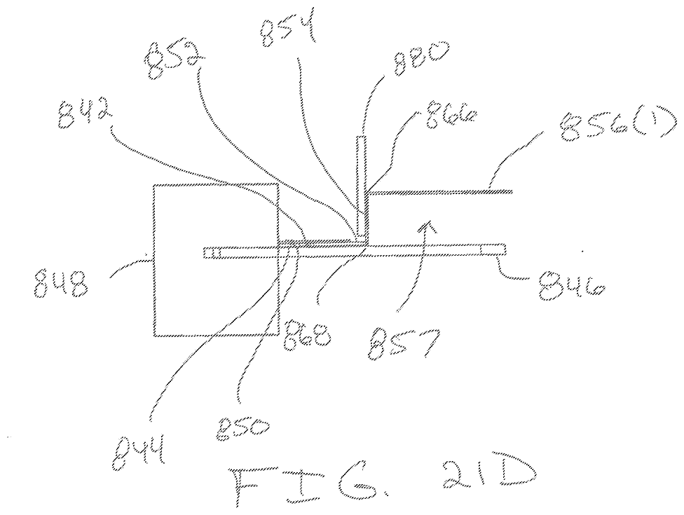

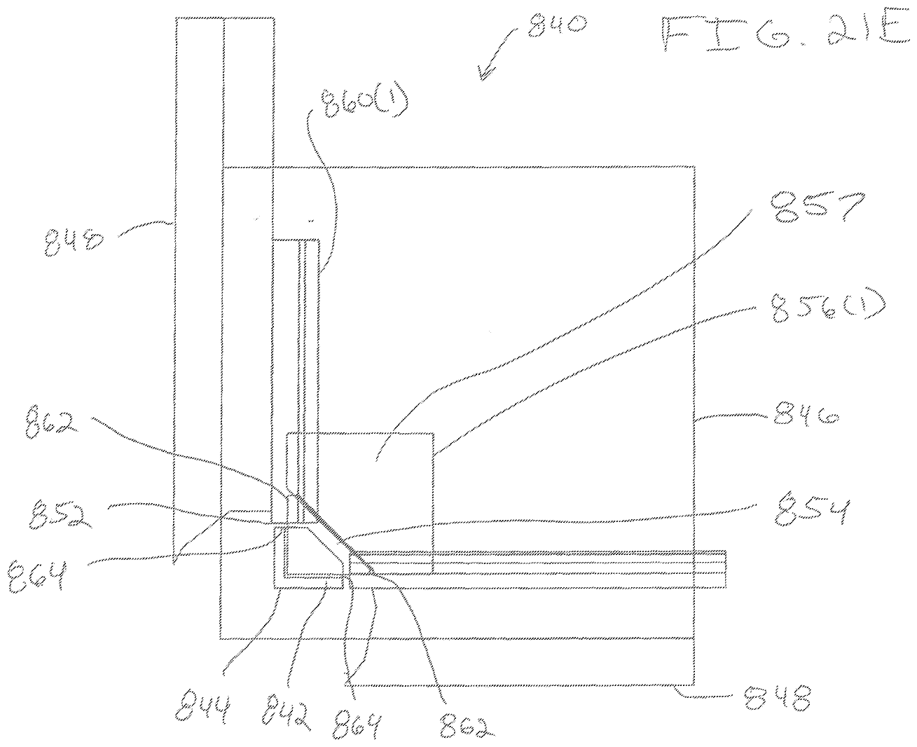

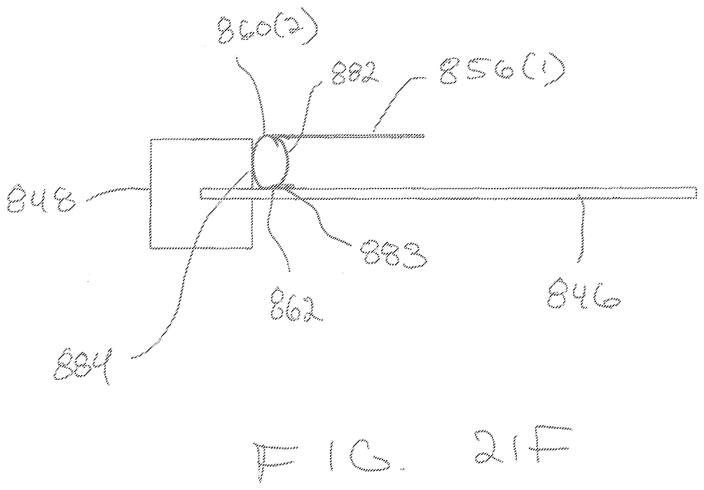

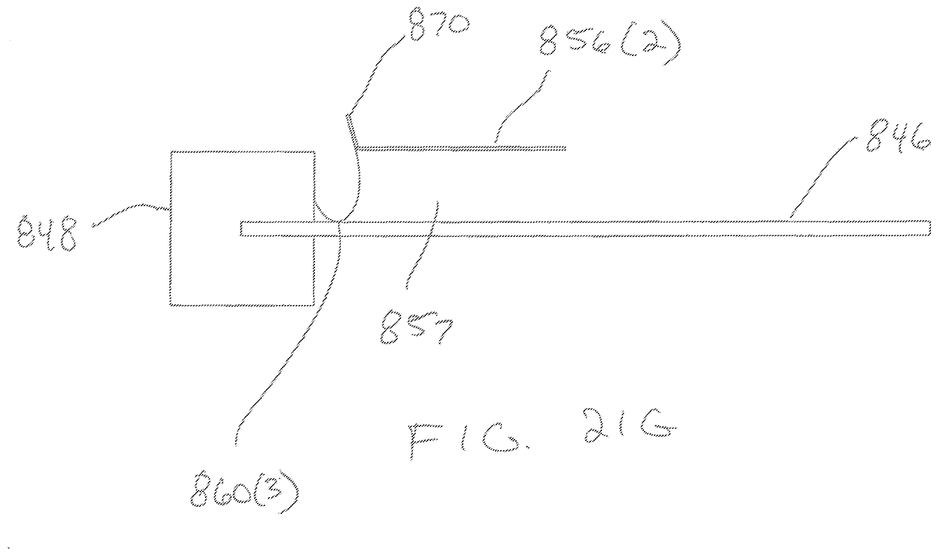

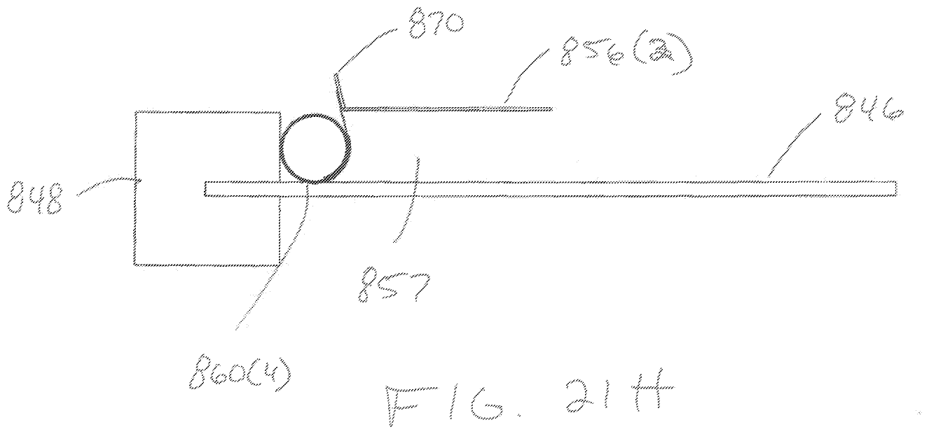

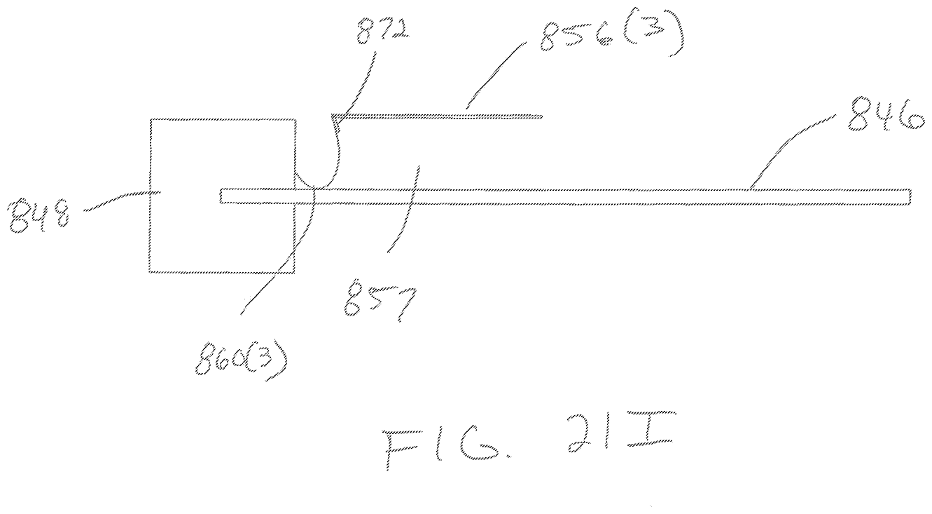

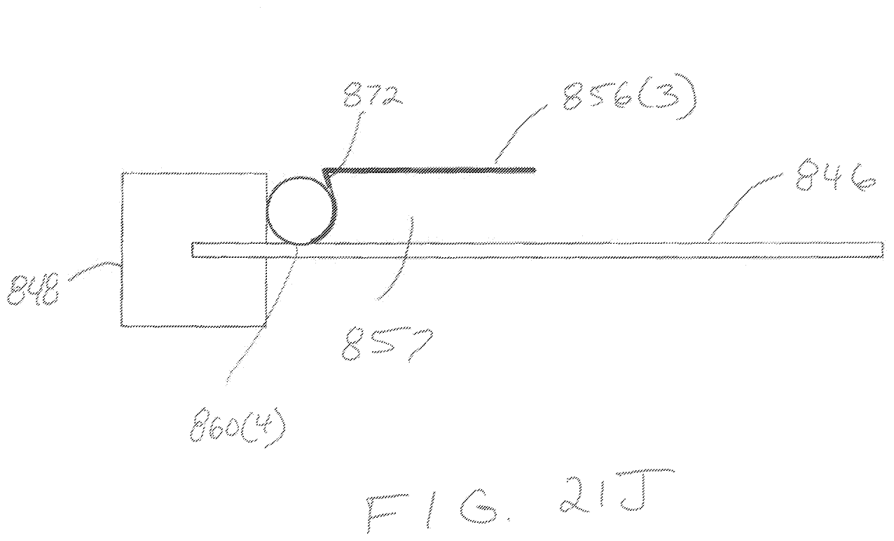

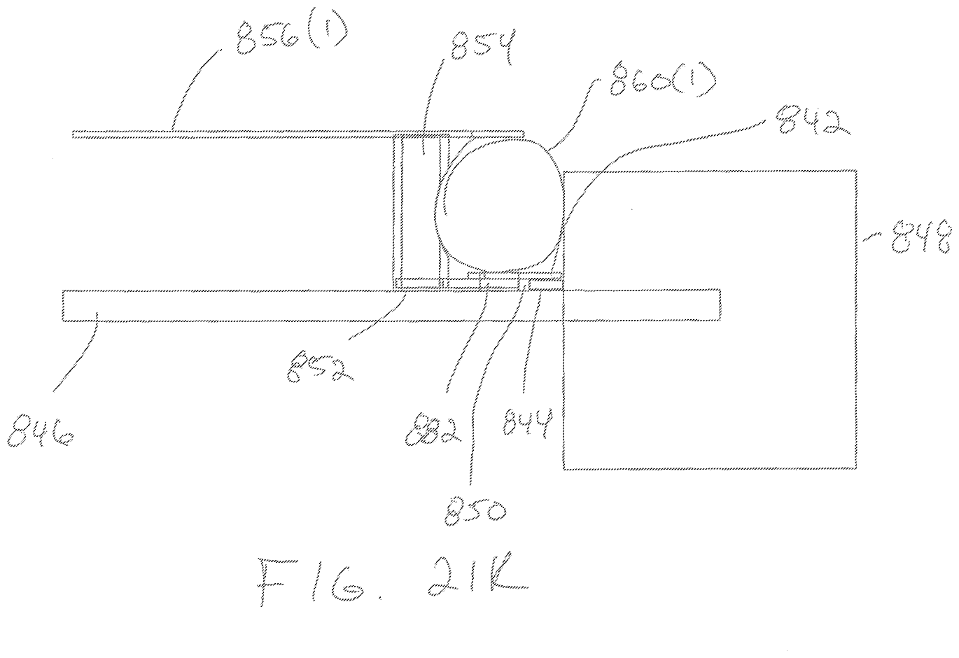

In the embodiment of FIG. 4C, the bullnose edge seal along edges or at corners such as in FIG. 11A described infra provide the desired optimum sheet to pane spacing. While the bullnose edge seal embodiments described supra show the open portion of the ‘U’ shape to the inward side of the bullnose edge seal, those skilled in the art will recognize that the bullnose edge seal may alternatively be open in the outward direction such as shown in FIGS. 21A and 21B. In such embodiments, the ends of the bullnose edge seal may be mitered and corner openings may be blocked with corner braces such as described infra, placed outward of the bullnose edge seal. Alternatively, any corner opening of such embodiments may be blocked with a truncated rectangle (also known as a snip corner rectangle), for example an elongated octagon, of plastic film or sheet that is formed and configured to provide an inward bullnose shape and placed between the spring and bullnose edge seal. When mounted, such an embodiment may be configured with the bullnose edge seals contacting the corner formed by the window sash and pane.

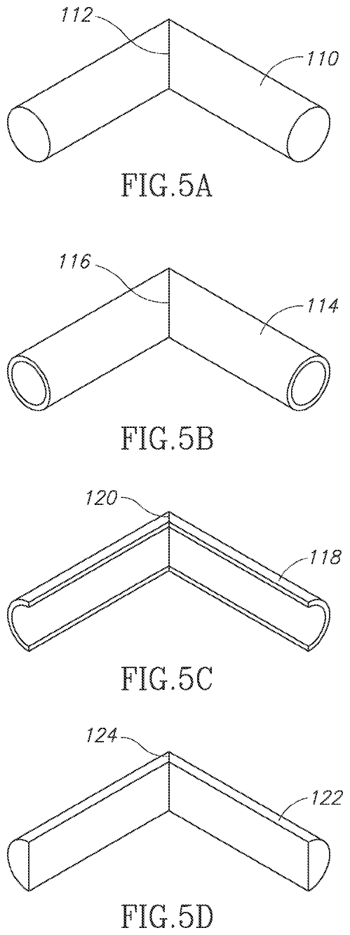

Several options for the construction of the corner brace component will now be described. A diagram illustrating a first example of the corner brace is shown in FIG. 5A. In this embodiment, the corner brace comprises a substantially solid cylindrical shaped material 110 having a mitered or otherwise formed inside corner 112. The corner brace may be constructed from any suitable material such closed cell foam, solid plastic, etc. As described supra, the corner brace may function to provide structural rigidity and corner closure for the supplemental window when placed in a window frame or sash.

A diagram illustrating a second example of the corner brace is shown in FIG. 5B. In this embodiment, the corner brace comprises a substantially hollow cylindrical shaped material 114 having a mitered or otherwise formed inside corner 116. The corner brace may be constructed from any suitable material such closed cell foam, solid plastic, etc.

A diagram illustrating a third example of the corner brace is shown in FIG. 5C. In this embodiment, the corner brace comprises an approximate half hollow cylindrical shaped material 118 having a mitered or otherwise formed inside corner 120. The corner brace may be constructed from any suitable material such closed cell foam, solid plastic, etc.

A diagram illustrating a fourth example of the corner brace is shown in FIG. 5D. In this embodiment, the corner brace comprises an approximate half solid cylindrical shaped material 122 having a mitered or otherwise formed inside corner 124. The corner brace may be constructed from any suitable material such closed cell foam, solid plastic, etc.

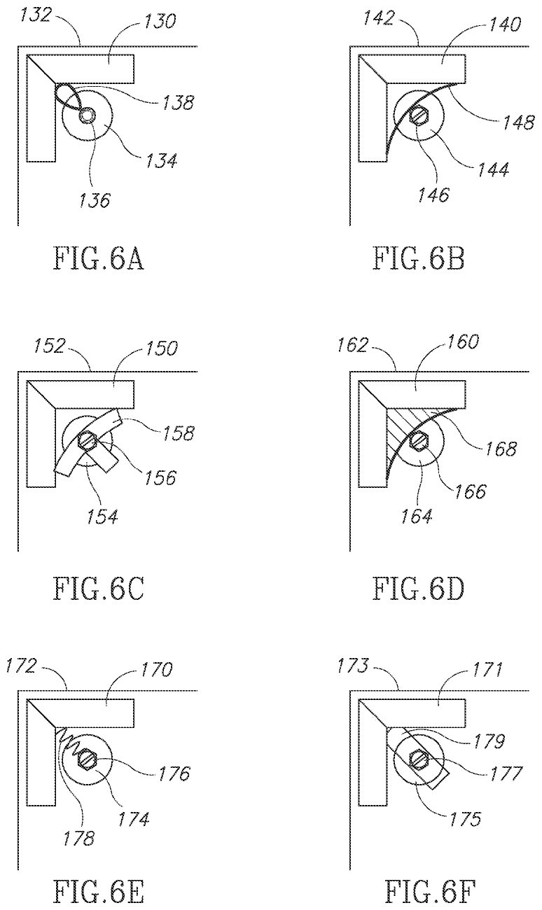

Several options for the construction of the spring mechanism will now be described. A diagram illustrating a first example of the spring mechanism is shown in FIG. 6A. In one embodiment, the spring 138, comprises a substantially rectangular plastic material configured to form a figure ‘8’ shape having two loops. The thickness of the spring is in the range of approximately 0.002 inch to approximately 0.010 inch, with a range of approximately 0.003 inch to 0.007 inch preferred. The spring may be formed by bending or thermoforming the plastic material such that the post 136 may be inserted through one of the loops. In some embodiments, one of the loops can be attached to the corner brace 130.

In another embodiment, the spring 138 is a fashioned as an elliptical or tear drop shaped figure ‘8’ loop from any suitable flexible material, e.g., plastic, metal, etc. One of the two loops wraps around the post 136 (held in position by the suction cup 134 when mounted). Note that this portion of the spring is shown in dashed lines indicating it lies under the cap and may not be visible if the cap is not made of a transparent material. Pushing against the post 136, the other loop is operative to apply an outward spring force to push the corner brace 130 and the bullnose corner 132 into the corner of the window frame or sash (not shown). While the figure ‘8’ shape shown in FIG. 6A shows both loops closed, it will be appreciated by those skilled in the art that one or both of the loops may be open while maintaining the spring functionality and post wrapping functionality. It is also noted that a nut is not required in both of the above embodiments in contrast to the embodiments of FIGS. 6B to 6F.

A diagram illustrating a second example of the spring mechanism is shown in FIG. 6B. In this embodiment, the spring 148 is fashioned as a flat or curved band from any suitable flexible material, e.g., plastic, metal, etc. It is compressed and placed between the post 146 (held in position by the suction cup 144) and corner brace 140 and operative to apply an outward spring force to push the brace 140 and the bullnose corner 142 into the corner of the window frame (not shown).

A diagram illustrating a third example of the spring mechanism is shown in FIG. 6C. In this embodiment, the spring 158 is fashioned as a ‘T’ shaped flat or curved band from any suitable material, e.g., plastic, metal, foam (such as closed cell foam), etc. It is compressed and placed between the post 156 (held in position by the suction cup 154) and corner brace 150 and operative to apply an outward spring force to push the brace 150 and the bullnose corner 152 into the corner of the window frame (not shown).

A diagram illustrating a fourth example of the spring mechanism is shown in FIG. 6D. In this embodiment, the spring 168 is fashioned as a trapezoidal or triangular shaped piece from any suitable compressible material, e.g., foam, etc. It is compressed and placed between the post 166 (held in position by the suction cup 164) and corner brace 160 and operative to apply an outward spring force to push the brace 160 and the bullnose corner 162 into the corner of the window frame (not shown).

A diagram illustrating a fifth example of the spring mechanism is shown in FIG. 6E. In this embodiment, a conventional spring 178, such as a helical spring, constructed from any suitable material, e.g., plastic, metal, etc. It is compressed and placed between the post 176 (held in position by the suction cup 174) and corner brace 170 and operative to apply an outward spring force to push the brace 170 and the bullnose corner 172 into the corner of the window frame (not shown).

A diagram illustrating a sixth example of the spring mechanism is shown in FIG. 6F. In this embodiment, the spring 179 is fashioned as a “C”, “U” or tear drop shape from any suitable flexible material strip, e.g., plastic, metal, etc., with a hole near each end of the strip. When formed in a “C”, “U” or tear drop shape with the two holes aligned, the post and/or suction cup neck are inserted through the two holes. When mounted, the spring is compressed between post 177 (held in position by suction cup 175) and corner brace 171 and operative to apply an outward spring force to push the brace 171 and the bullnose edge seal corner 173 into the corner of the window frame or sash. As shown, a triangular portion of the strip 179 may optionally be omitted along each edge near the portion of the arc that contacts the corner brace to aid in keeping spring 179 positioned at the corner.

Several options for the construction of the corner sealing mechanism will now be described. Note that in each option, a solid corner brace is used as an example. It is appreciated that each sealing mechanism option may be modified to accommodate any of the corner brace options shown in FIGS. 5A, 5B, 5C and 5D.

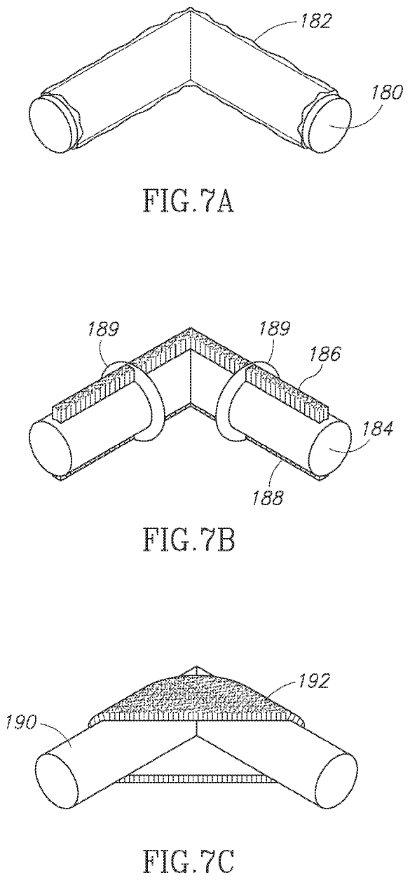

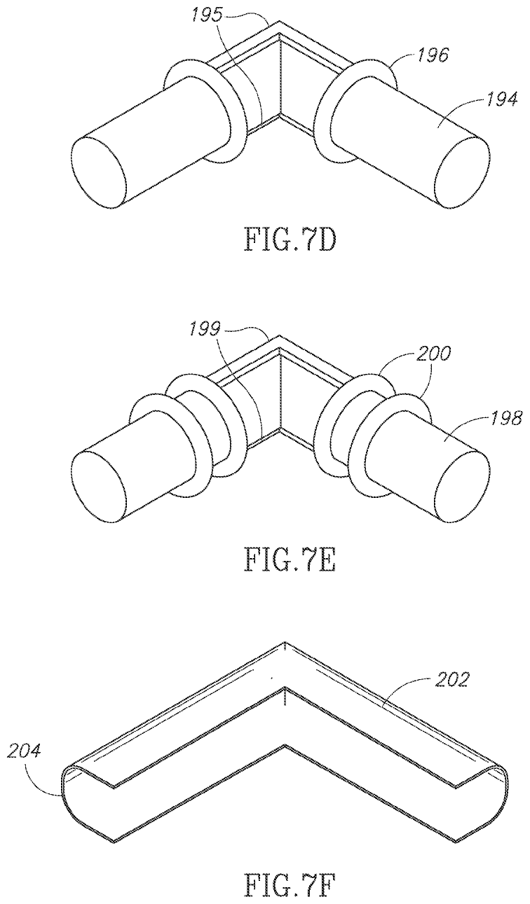

A diagram illustrating a first example of the corner sealing mechanism is shown in FIG. 7A. This first example corner sealing mechanism comprises a substantially solid corner brace 180 coated either wholly or partially with a suitable material 182. The corner brace 180 arm cross section may take any appropriate shape such as cylindrical, rectangular, square, elliptical, etc. so long as its combination with other sealing materials inhibits air flow into or out of the substantially enclosed space. It may comprise a solid plastic or a compressible foam material (open or closed cell) having sufficient rigidity and impermeability in combination with material 182 to provide the necessary strength, shape and sealing to the corners of the supplemental window. The coating or layer 182 may comprise a material that has sealing properties such as an oil, grease, gel, etc. In addition, it may comprise a material that is sufficiently tacky to hold the corner brace in its proper position. Such a material may comprise, gel, releasable adhesive, glue, etc. In addition, the coating may comprise a material having both sealing and tacky properties.

A diagram illustrating a second example of the corner sealing mechanism is shown in FIG. 7B. This second example corner sealing mechanism comprises a substantially impermeable corner brace 184 having one or more strips 186, 188 (two shown in this example) of a suitable material. The corner brace may take any appropriate shape such as cylindrical, rectangular, square, elliptical, etc. It may comprise a solid plastic or a compressible foam material (open or closed cell) having sufficient rigidity to provide the necessary strength to the corners of the supplemental window. The strips of material are preferably located on the top (sheet side) and bottom (pane side) portions of the corner brace 184 such that one of the strips contacts the sheet and the other strip contacts the pane when mounted. The strips 186, 188 may comprise a material that have sealing properties such as an oil, grease, gel, O-ring cord, etc. or air transport inhibition properties such as foam or pile. In addition, it may comprise a material that is sufficiently tacky to hold the corner brace in its proper position. Such a material may comprise, gel, releasable adhesive, glue, etc. In addition or alternatively, the strips may comprise a material having both sealing and tacky properties. Additional sealing is also be provided by O-ring seals 189, comprising pile, foam or a suitable elastomer such as silicone, placed on the arms of the corner brace 184.

A diagram illustrating a third example of the corner sealing mechanism is shown in FIG. 7C. This third example corner sealing mechanism comprises a substantially impermeable corner brace 190 having one or more sealing bands 192 (one shown in this example) wrapped around the arms of the corner brace. The band 192 comprises a suitable material to provide sealing and/or tackiness/grip. The corner brace may take any appropriate shape such as cylindrical, rectangular, square, elliptical, etc. It may comprise a solid plastic or a compressible foam material (open or closed cell) having sufficient rigidity to provide the necessary strength, shape and sealing to the corners of the supplemental window. The band 192 may comprise a material that has air flow inhibition properties such as pile, foam or an elastomer such as silicone, and sealing properties such as an oil, grease, gel, etc. In addition, it may comprise a material that is sufficiently tacky to hold the corner brace in its proper position. Such a material may comprise, gel, releasable adhesive, glue, etc. In addition, the band may comprise a material having both sealing and tacky properties. Band 192 preferably extends over the brace midline at the brace corner so as to inhibit air movement between the enclosed space and the air outside the enclosed space when the supplemental window is mounted.

A diagram illustrating a fourth example of the corner sealing mechanism is shown in FIG. 7D. This fourth example corner sealing mechanism comprises a substantially impermeable corner brace 194 having one or more O-rings 196 and strips 195 on each arm of corner brace 194 each made of a suitable material. The corner brace may take any appropriate chase such as cylindrical, rectangular, square, elliptical, etc. It may comprise a solid plastic or a compressible foam material (open or closed cell) having sufficient rigidity to provide the necessary strength to the corners of the supplemental window. The O-rings may be constructed from elastomer, plastic, pile, foam or any other suitable material as long as it provides sufficient sealing properties. The strips of material 195 are preferably located on the top (sheet side) and bottom (pane side) portions of the corner brace 194. The strips 195 may comprise any material having appropriate sealing properties such as elastomer (such as silicone), plastic, pile, foam, felt etc. In addition, it may comprise a material that is sufficiently tacky to hold the corner brace in its proper position. Such a material may comprise, gel, releasable adhesive, glue, etc.

A diagram illustrating a fifth example of the corner sealing mechanism is shown in FIG. 7E. This fifth example corner sealing mechanism comprises a substantially impermeable corner brace 198 having two or more O-rings 200 on each arm of the corner brace and strips 199 each made of a suitable material as described supra. The corner brace may take any appropriate shape such as cylindrical, rectangular, square, elliptical, etc. It may comprise a compressible foam material (open or closed cell) having sufficient rigidity to provide the necessary strength to the corners of the supplemental window. The double O-rings 200 on each arm of the corner brace provide additional sealing abilities and may be constructed from elastomer (such as silicone), plastic, pile, or any other suitable material as long as it provides sufficient sealing properties. The strips of material 199 are preferably located on the top (sheet side) and bottom (pane side) portions of the corner brace 198. The strips 199 may comprise any material having appropriate sealing properties such as elastomer, plastic, pile, foam, felt, etc. In addition, it may comprise a material that is sufficiently tacky to hold the corner brace in its proper position. Such a material may comprise, gel, releasable adhesive, glue, etc.

A diagram illustrating a sixth example of the corner sealing mechanism is shown in FIG. 7F. This sixth example corner sealing mechanism comprises a corner brace 202 having a ‘U’ shaped approximate half hollow cylindrical shaped material 204 having a mitered or otherwise formed inside corner. The corner brace may be constructed via, thermoforming or injection molding for example, from any suitable material such as rigid plastic, flexible plastic, etc. For example, for flexible corner braces, polyethylene terephthalate having a thickness in the range of approximately 3 to 20 mil may be used.

Several options for the attachment mechanism for embodiments where the attachment mechanism pierces the sheet material will now be described. Note that the holes in the sheet may be made using any suitable means such as a hole punch or laser or ultrasonic cutting. In addition, the supplemental window may comprise attachment means anywhere along its perimeter and not just in the corners, e.g., along the sides, etc. In addition to the embodiments described infra, commercially available products such as the Suction Cup with Push Tack, available from Popco, Inc., Minnetonka, Minneapolis, may be used. When using such a tack and suction cup configuration, the neck or nub portion of the suction cup may function as the post with the sheet held between the cap of the tack and the end of the neck/nub.

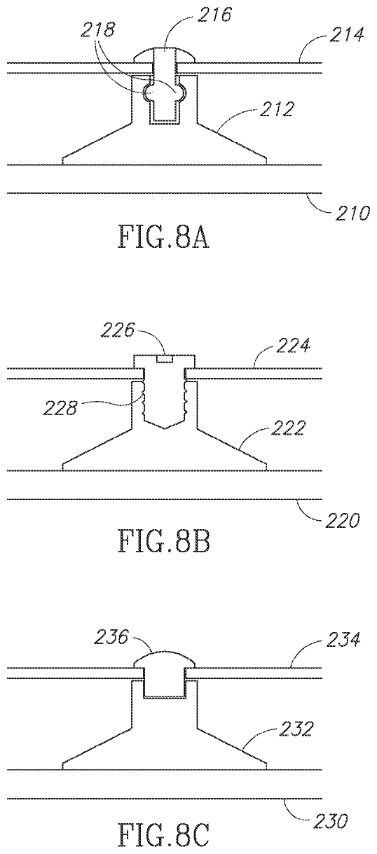

A diagram illustrating a first example of the attachment mechanism that penetrates or pierces the sheet material is shown in FIG. 8A. In this first attachment mechanism example the suction cup 212 is fastened to the sheet material 214 via a cap 216 having dimples, a ring, tab or barbs 218 that fit into a corresponding recess in the neck or nub of the suction cup 212. The cap 216 pierces the sheet and is operative to snap into neck or nub portion of the suction cup. The suction cup is attached to the window pane 210 when the supplemental window is installed. Note that the length of the cap 216 can vary according to the dimensions of the suction cup used and the desired optimum distance between the sheet and the pane. The combination of the compressed suction cup and its post (when in an installed position) determine the distance between sheet and pane.

FIG. 8B is a diagram illustrating a second example of the attachment mechanism that penetrates or pierces the sheet material is shown in FIG. 8B. In this second attachment mechanism example the suction cup 222 is fastened to the sheet material 224 via a screw 226 having threads 228 that mate into a corresponding threaded receptacle in the neck or nub of the suction cup 222. Alternatively, the threads of screw 226 may cut into the material within a recess of the suction cup neck or nub. The screw 226 pierces the sheet and is operative to screw into top portion of the suction cup. The suction cup is attached to the window pane 220 when the supplemental window is installed. Note that the length of the screw 226 can vary according to the dimensions of the suction cup used and the desired distance between the sheet and the pane. The combination of the screw (when in an installed position) and the compressed suction cup determine the distance between sheet and pane.

A diagram illustrating a third example of the attachment mechanism that penetrates or pierces the sheet material is shown in FIG. 8C. In this third attachment mechanism example the suction cup 232 is fastened to the sheet material 234 via a rivet or cap 236 having that is friction fit and held in place when inserted into a corresponding recess in the neck or nub of the suction cup 230. The cap 236 pierces the sheet and is operative to fit into top portion of the suction cup. Alternatively or in addition, a barb or tab (not shown) may be provided on the cap 236 that fits into corresponding recess on the suction cup to guide and/or secure the placement of the cap. The suction cup is attached to the window pane 230 when the supplemental window is installed. Note that the length of the cap 236 can vary according to the dimensions of the suction cup used and the desired distance between the sheet and the pane. The combination of the cap (when in an installed position) and the compressed suction cup determine the distance between sheet and pane.

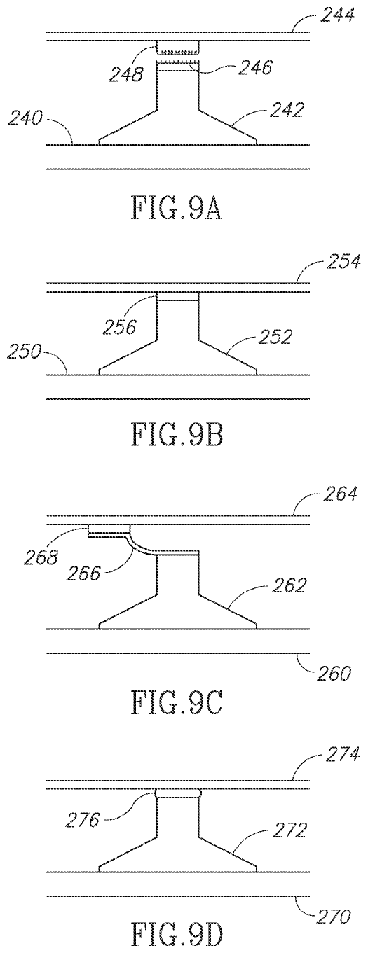

Several options for the attachment mechanism for embodiments where the attachment mechanism does not pierce the sheet material will now be described. A diagram illustrating a first example of the attachment mechanism that does not pierce the sheet material is shown in FIG. 9A. In this first example, the suction cup 242 is fastened to the sheet 244 using a hook and loop fastener, such as Velcro. One side 248 of the Velcro (hook or loop) is attached to the sheet using adhesive, tape, glue, etc. while the other side 246 is attached to the top of the suction cup (e.g., a post portion). In this manner, the attachment mechanism is operative to both attach to the window pane 240 but also determine the distance between the sheet and pane.

A diagram illustrating a second example of the attachment mechanism that does not pierce the sheet material is shown in FIG. 9B. In this second example, the suction cup 252 is fastened to the sheet 254 using adhesive, glue, tape or other adhesive based bonding technique. In this manner, the attachment mechanism is operative to both attach to the window pane 250 but also determine the distance between the sheet and pane.

A diagram illustrating a third example of the attachment mechanism that does not pierce the sheet material is shown in FIG. 9C. In this third example, the suction cup 262 is fastened to the sheet 264 using a commercially available dry adhesive material 268 such as EverSTIK, Geckskin™, etc. or other dry adhesive such as described in U.S. Pat. Nos. 8,206,631; 8,398,909; and U.S. Publications Nos. 2012/0319320; 2012/0328822; and 2013/0251937 and described at www.nanogriptech.com. Depending on the material used, an arm 266 may be required to attach the suction cup 262 to the material 268. In this manner, the attachment mechanism is operative to both attach to the window pane 260 but also determine the distance between the sheet and pane.

In an alternative embodiment, supplemental window's spacing arrangement (e.g., suction cup) may be attached using a releasable, dry surface-adhesive device including, for example, an adhesive pad that may have a tether component attached, the adhesive pad including a planar backing layer having high in-plane stiffness and a planar layer of elastic material having an adhesive surface on at least one side for adhering to the pane, wherein the elastic material is impregnated onto the backing layer on at least the side opposing the adhesive surface, as described in WO 2012/078249, WO 2014/152485, WO 2014/123936 and WO 2014/144136, all of which are incorporated herein by reference in their entirety.

When using a releasable, surface-adhesive device, the elastic material preferably comprises a siloxane-based, such as polydimethylsiloxane, urethane-based, or acrylate-based elastomer. Such attachment by adhesive, vacuum or releasable, surface-adhesive device may be made to the interior or exterior surface of the pane. When using suction cups, attachment of the suction cup to the window pane may include use of an additional material between the suction cup and the pane. For example, water, saltwater, saliva, or other water based solution, such as liquid soap or dishwashing soap or solution may be used. Preferred materials include vegetable or cooking oil such as canola, sunflower or corn oil, petroleum jelly, or a grease, such as a petroleum or silicone grease based grease, e.g., polydimethylsiloxane.

A diagram illustrating a fourth example of the attachment mechanism that does not pierce the sheet material is shown in FIG. 9D. In this fourth example, the suction cup 272 is fastened to the sheet 274 using any suitable well-known welding technique. In this manner, the attachment mechanism welded 276 to the sheet is operative to both attach to the window pane 270 but also determine the distance between the sheet and pane.

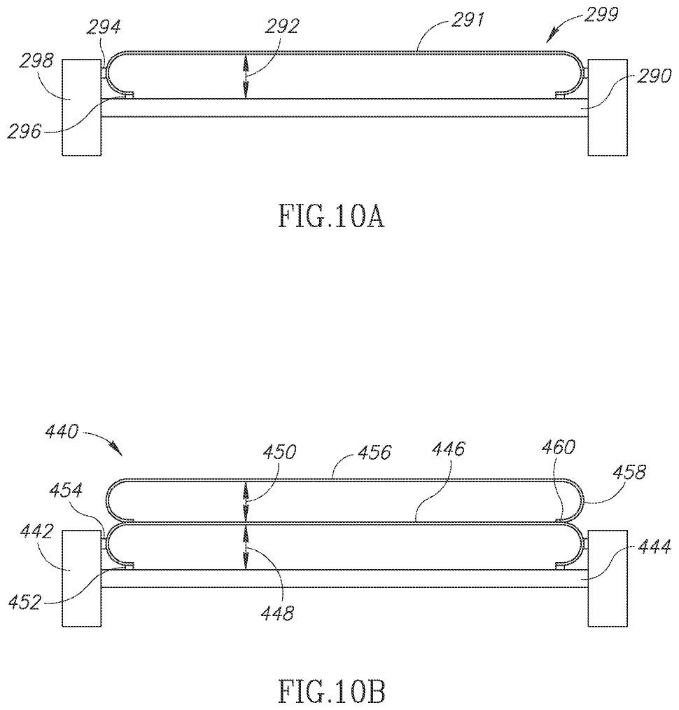

A diagram illustrating a side sectional view of an example frameless supplemental window is shown in FIG. 10A. In this example embodiment, the supplemental window 299 does not have corner braces. It is similar to the frameless and corner braceless embodiment shown in FIG. 4C described supra.

The sheet material 291 can be separate from but bonded to the bullnose edge seal or they may be constructed from the same material as a single entity. In this case, they comprise the same material and may be the same thickness. The bullnose edge can be formed by thermoforming, i.e. wrapping the edges around a mold or form and heat treating the material such that the material retains an approximate ‘U’ or arc shape after the heat source is removed.

Alternatively, the edge may be stretched, and optionally cut, such that the edge portion of the single entity is thinner than the sheet portion. Further, it will be appreciated by those skilled in the art that the edging seal may be curved in the opposite direction shown so that such edging seal may contact the inward facing surface or the interior facing surface of the frame or sash. In such cases, dry adhesive materials described supra, for example, may be used to seal the edging seal to the frame or sash while using spacing attachment means such as those described in FIGS. 8A, 8B, 8C and 9A, 9B, 9C, 9D to provide (1) attachment to and (2) the desired spacing from the pane to the sheet.

In the embodiment shown in FIG. 10A, the corners of the bullnose edge are mitered and bonded using any suitable means, such as gluing, taping, heat welding, ultrasonic welding, laser welding, stapling, etc. Regardless of the actual mechanism or method used to form or join the mitered corners, it is important that the bond be substantially air tight so as to prevent leaks of air into or out of the trapped air layer 292.

The bottom portion (the portion near window pane 290) of the bullnose edge comprises a strip 296 of sealing material substantially along the entire perimeter formed by this portion of the bullnose edge. This sealing material may comprise any suitable material such as oil, grease, gel, dry adhesive or nanosuction adhesive material, foam, elastomer, etc. Preferably, the properties of the sealing material are sufficient to provide functions of both (1) sealing the enclosed air layer; and (2) affixing (i.e. attaching) the supplemental window to the window pane 290. These functions may be achieved by a single strip 296 of material placed at the bottom (near the pane 290) of the bullnose edge or a single strip 294 of material placed at the bullnose edge contacting window frame or sash 298.

Alternatively, the above functions can be achieved utilizing two separate strips of materials: (1) a first strip 296 on the bottom of the bullnose edge for sealing the enclosed air layer; and (2) a second strip 294 on the side of the bullnose edge for attaching the supplemental window to the window frame or sash 298. Alternatively, the functions of the strips in this embodiment may be reversed with the strip on the side of the bullnose providing sealing and the strip on the bottom of the bullnose edge providing adhesion to the window pane. In the embodiment of FIG. 10A, the bullnose edge seal along edges or at corners such as in FIG. 11A, described infra, may provide the desired optimum sheet to pane spacing.

A diagram illustrating a side sectional view of an example frameless supplemental window incorporating two enclosed air layers is shown in FIG. 10B. In this multi-sheet embodiment, generally referenced 440, a second sheet 456 is added over the first sheet 446. The dimensions of the second substantially enclosed space 450 provided in this embodiment are approximately the same as the dimensions provided by the first substantially enclosed space 448 between the first sheet 446 and the window pane 444 described supra. These dimensions are those that set the distance between the two sheets and the sheet and the pane to be optimal for maximizing the thermal insulating properties of the supplemental window. The first sheet 446 is attached to the pane 444 using techniques described in detail supra. For example, strip 452 may function to either seal or attach the supplemental window to the pane or may perform the functions of both sealing and attaching. Similarly, strip 454 may function to either seal or attach the supplemental window to the pane or may perform both functions of sealing and attaching.

The spacing between the first and second sheets may be achieved, for example, using a post through both sheets (not shown) with nuts or other retaining means on both sides of the first sheet, a seal, such as a bullnose seal (which may include a corner seal closure, not shown, such as shown in FIG. 11A infra) sized and having the necessary stiffness to provide the desired spacing and attached to both sheets for edges and/or a brace at the corner of each level. For panes having edge dimensions of greater than about 15 inches, it is beneficial to provide one or more additional spacing posts or braces along the edges of the enclosed spaces of this embodiment. Alternatively, as in the embodiment of FIG. 10A, the bullnose 458 may substantially determine the spacing between the first and second sheets.

The second cavity 450, between the first and second sheets, may be permanently formed by mitering and welding edging 460 as described supra and welding, adhering or otherwise bonding the edging 458 to both sheets. Attachment to the pane 444 may be accomplished by means described supra. Optionally, a single post through both sheets in each of the corners may be provided with suction cup attachment to the pane. Alternatively, the second cavity may be releasably formed using releasable adhesive 460 as described supra between the second seal 458 and the first sheet 446 or a portion of the first seal 459 that is approximately parallel to and nearest first sheet 446. Other means for attaching the second sheet to the first sheet include a first bolt (not shown) with a tap or other attachment mechanism for a second bolt or bolts, threaded rod, nut and tapped cylinder/spacer between the first and second sheets and one or more bolts.

With the seals attached inward from the edge of each sheet, rigid clip spacers may be added at several perimeter locations to maintain sheet-to-sheet spacing in multi-sheet embodiments. The corners may be mitered and welded or closed using adhesive to entirely enclose the second cavity 450 when attached to a first sheet.

Several options for the bullnose corner will now be described. A diagram illustrating a perspective view of a first example bullnose corner is shown in FIG. 11A. In this first example, the bullnose edge 300 is either attached to sheet 304 perimeter region or formed as an extension of the sheet 304 perimeter region. The corner portion of the bullnose is cut such that when the bullnose is shaped, a miter 302 is formed that is bonded using any suitable means, such as glue, adhesive, welding, tape etc. In this case, the bonding of the miter forms a substantially air tight seal and may be constructed to provide the optimum sheet to pane spacing to maximize the thermal insulation properties of the supplemental window.

A diagram illustrating a perspective view of a second example bullnose corner is shown in FIG. 11B. In this second example, the bullnose edge 310 is either attached to or formed from an extension of the sheet 314 perimeter region. The corner portion of the bullnose is cut such that when the bullnose is shaped, an approximately 90 degree junction 312 is formed by the bottom portions of the edge material near the pane. Alternatively, the bottom corners of the edge material may be cut so they do not form a junction (not shown). The opening formed in the corner is sealed by placing a corner brace with suitable sealing into the corner.

A diagram illustrating a perspective view of a third example bullnose corner is shown in FIG. 11C. In this third example, the bullnose edge 320 is either attached to or formed from an extension of the sheet 324 perimeter region. The corner portion of the bullnose is cut such that when the bullnose is shaped, an approximately 90 degree junction 322 is formed whereby the bottom portions of the bullnose material are allowed to overlap onto each other. The opening formed in the corner is sealed by placing a corner brace with suitable sealing into the corner.

A diagram illustrating a perspective view of a fourth example bullnose corner is shown in FIG. 11D. In this fourth example, the bullnose edge 330 is either attached to or formed from an extension of the sheet 334 perimeter region. The corner portion of the bullnose is cut such that when the bullnose is shaped, an approximately 90 degree junction 332 is formed whereby a squared off portion 336 of the corner the sheet material extends outward of junction 332. Note that the alternative configurations to an approximately 90 degree junction described supra may also be used in this sheet corner outward extension embodiment. The extended sheet material provides a portion of the corner closure when used in conjunction with corner braces shown in FIGS. 7A, 7B, 7C, 7D and 7E. Alternatively, a similar extending material portion may be formed by appropriate cutting of the top portion (the portion near the sheet) of the bullnose edges shown in FIGS. 11B and 11C. The opening formed in the corner is sealed by placing a corner brace with suitable sealing into the corner.

A diagram illustrating a perspective view of a fifth example bullnose corner is shown in FIG. 11E. In this fifth example, the bullnose edge 340 is either attached to or formed from an extension of the sheet 344 perimeter region. The corner portion of the bullnose is cut such that when the bullnose is shaped, an overlapping miter 342 is formed with grease applied to aid in sealing. The mitered edges of the bullnose, however, are not bonded to each other, but rather simply abut each other. Any air leakage is sealed utilizing a corner brace with suitable sealing placed into the corner.

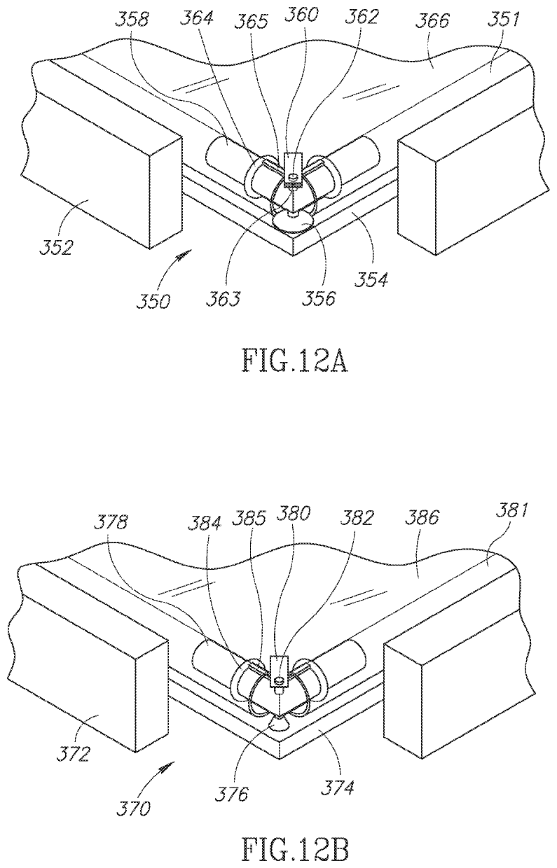

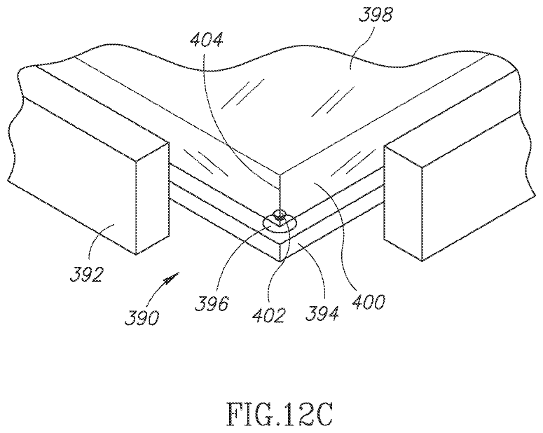

A diagram illustrating a perspective view of another embodiment of the frameless supplemental window is shown in FIG. 12A. The window corner, generally referenced 350, comprises a window frame or sash 352 (shown cutaway for clarity), window pane 354, corner brace 358, seal 364 comprising O-rings, O-ring cord, pile, foam, etc., sheet material 366, post 362, suction cup 356 and one or more constraints 360. This embodiment consists of a sheet 366 and bullnose edge seal 351 that is open at each corner. The corner is sealed with the corner brace 358 having a pile or O-ring cord strip 364 on both the pane and sheet sides of the corner brace. In addition, each arm of the brace has a seal comprising a ring of pile or elastomer 364. Through the corner of the corner brace is a post 362 that is held in place using a suction cup 356 or other means described supra that attaches to the pane 354. At the sheet end of the post is a first constraint 360 that functions to press against the sheet preventing the sheet from separating from the pane (thus defining the pane sheet separation) and seals. Optionally, a second constraint 363 may be placed on the post so as to sandwich the sheet thus forming a slot and also defining the pane to sheet separation distance.

A diagram illustrating a perspective view of an additional embodiment of the frameless supplemental window is shown in FIG. 12B. The window corner, generally referenced 370, comprises a window frame 372 (shown cutaway for clarity), window pane 374, corner brace 378, seal 384 comprising O-rings, pile, etc., sheet material 386, post 382, attachment means 376 and one or more constraints 380. This embodiment consists of a sheet 386 and bullnose edge seal 381 that is open at each corner. The corner is sealed with the corner brace 378 having a pile or elastomer cord strip 384 on both the pane and sheet sides of the corner brace. In addition, each arm of the brace has a ring of pile or elastomer 384. Through the corner of the corner brace is a post 382 that is held in place against the pane using glue, double sided tape, adhesive, dry adhesive materials, including nanosuction material such as EverSTIK material, Geckskin™, nanoGriptech materials as described at www.nanogriptech.com and manufactured by nanoGriptech, Inc., Pittsburgh, Pennsylvania, USA, etc. At the sheet end of the post is a first constraint 380 that functions to press against the sheet preventing the sheet from separating from the pane. Optionally, a second constraint (not shown) may be placed on the post so as to sandwich the sheet thus forming a slot and also defining the pane to sheet separation distance.

A diagram illustrating a perspective view of another embodiment of the frameless supplemental window is shown in FIG. 12C. The window corner, generally referenced 390, comprises a window frame or sash 392 (the corner portion shown cutaway for clarity), window pane 394, sheet material 398, bullnose edge seal 400 and attachment means 396. This embodiment consists of a sheet and bullnose edge seal as well as an attachment means comprising a suction cup, fastened through a hole in the mitered corner portion of the bottom of the bullnose (i.e. nearest the pane), with a protruding cap (e.g., mushroom shaped, flat, etc.).

The bullnose 400 may comprise a single continuous strip or two or more strips. At the corner, the bullnose edge is preferably mitered and may comprise a single continuous piece of material or may comprise more than one piece of material for the perimeter. To complete the substantial enclosure, ends and mitered portions of the compressible bullnose edge material may be overlapped, abutted or joined, preferably using adhesive, welding or heat sealing. Note that when the edge is comprised of one piece, the ends of the piece may be joined at a corner, in which case the ends of the piece are mitered, or the ends of the piece may be joined along a perimeter edge, in which case the ends of the piece may be cut so as to abut or slightly overlap to enable joining by methods described supra.

Attachment to the pane is achieved utilizing any of the attachment means described supra on the pane side surface of the bullnose. As a non-limiting example, shown in FIG. 12C is a suction cup 396 with a cap 402 with the suction cup on the pane side of the bullnose edge seal near the window pane. The cap is held in a hole in the bullnose with the cap on the opposite side of the hole from the compressible portion of the suction cup.

Optionally, a washer comprising foam or an elastomer may be used between the cap and bullnose edge seal 400. In addition, a portion of compressed circumference of the suction cup may reside inward from the bullnose edge seal to pane contact region. In such cases, a foam sheet such as open cell foam, pile or other suitable sealing material may be placed between the sealing portion of the suction cup and the bullnose edging to ensure inhibition of air movement into or out of the enclosed space when the suction cup is compressed.

Optionally, a post may be attached to the suction cup (not shown). The length of the post may be such that when it is attached to the suction cup, it nearly touches the sheet. The post may be depressed by the end user by pressing on the sheet immediately adjacent to the end of the post during mounting to provide a force on the suction cup which leads to compression of the suction cup and its attachment to the pane.

In another embodiment, the top of the suction cup or an extension from the suction cup comprises magnetic material or a ring magnet (preferably constrained by a post through its center) that may be repelled by a magnet held by the end user external to the space to be enclosed, such that pressure is applied to the top of the suction cup which leads to its attachment to the pane. Similarly, when strips of dry adhesive material described supra are used for attachment, such strips may comprise magnetic material to enable additional pressure to be applied to the attachment regions during mounting by a magnet held by the end user.

Each corner of the bullnose edge is mitered 404 and sealed on both the sheet side and the pane side. The bullnose may optionally be thermoformed to form an arc. Sealing of the miters may be accomplished using any suitable technique, such as but not limited to, adhesive, adhesive tape or preferably welded. Similarly, when using a single continuous strip, which may be notched (at locations that substantially match the corner to corner dimensions of the sheet material) to form miters, the ends of the strip may be joined using adhesive, adhesive tape, welded or any other suitable bonding technique. Further, when using a suction cup, the region between the suction cup top surface and the pane side of the bullnose edge may be filled with a foam sheet, for example open or closed cell foam, pile or other suitable sealing material to aid in maintaining the enclosure integrity.

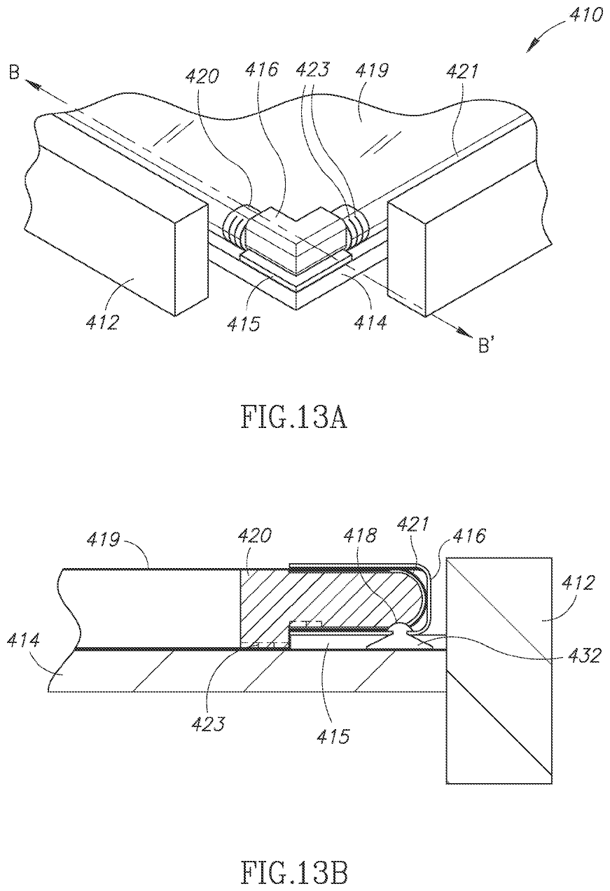

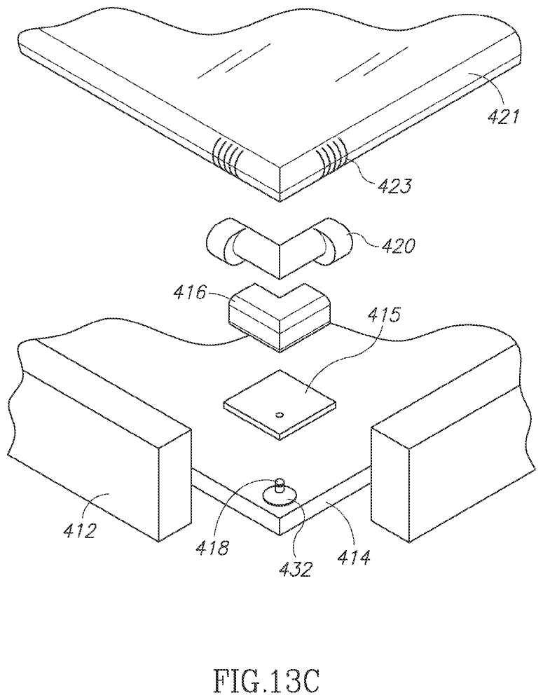

A diagram illustrating a perspective view of an additional embodiment of the frameless supplemental window is shown in FIG. 13A. A diagram illustrating a side sectional view B-B′ of the example window of FIG. 13A is shown in FIG. 13B. A diagram illustrating an exploded view of the example window of FIG. 13A is shown in FIG. 13C. The window corner, generally referenced 410, comprises a window frame or sash 412 (shown cutaway for clarity), window pane 414, constraint 416, sheet 419, insert 420, optional sheet portion 415, mushroom cap 418, suction cup 432 and bullnose edge seal 421 having one or more slits 423.

This embodiment consists of a sheet and bullnose edge seal held at each corner using a support mechanism consisting of a constraint 416 and foam insert 420 with the constraint attached to the window pane 414 via one of the suitable pane attachment mechanisms described supra, for example, such as suction cup 432. In one example embodiment, the pane attachment means comprises a suction cup 432 connected to the base of the constraint 416 through a hole that engages the mushroom cap 418 of the suction cup 432. The constraint 416 is positioned so as to constrain the separation between the pane 414 and the sheet 419 and thus determine the distance between them. Preferably, the bullnose edge corner fits into the corner support mechanism, (i.e. the constraint 416) and is optionally friction fit in the support using a foam insert 420. Preferably, the bullnose edge seal includes multiple slits 423 to each side of the edge of the support so that the step from the constraint 416 to the pane 414 may be substantially closed. Such closure is aided by use of an insert 420 in the bullnose edge seal in this location. Insert 420 may be sized and shaped to conform to the step from constraint 416 to pane 414. As such, insert 420 may be constructed from a solid rigid material or a conformable foam material. The gap between the suction cup and bottom of the constraint may optionally be filled with a sheet 415 such as foam, pile or other suitable sealing material. Similarly, slits such as those just described and as described in U.S. application Ser. No. 14/315,503 cited supra may be used in the edging seal in the region where the edging seal crosses any protruding muntins that may be present on the window pane.

Those skilled in the art will recognize that adhesive may be used on the outward pane side surface of constraint 416 instead of using suction cup 432 for attachment, sheet 415 may be omitted leaving a slot between constraint 416 and window pane 414 and that other elements as shown in FIGS. 21A through 21F may be used in this embodiment.

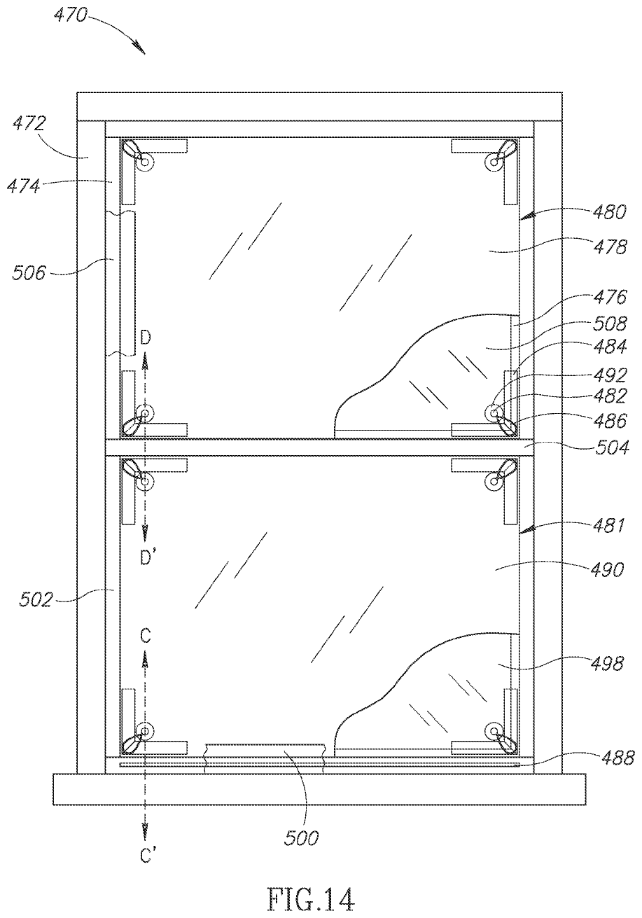

The air infiltration blocker of the present technology is useful in inhibiting or minimizing airflow that may enter around one or more window elements into an interior space. A diagram illustrating a front view of a first example frameless supplemental window incorporating infiltration blockers is shown in FIG. 14. The window, generally referenced 470, comprises an existing window frame 472 and a vertical sliding window (for example purposes single or double hung) including a lower sash 502 that is movable and an upper sash 474 that may or may not be movable. The upper and lower sash 474, 502 hold the window panes 478, 490, upper and lower frameless supplemental windows 480, 481, which include infiltration blockers 506, 500, respectively. Lower sash 502 also includes a horizontal handle 488 to aid in opening the window.

The upper and lower window sashes each have a frameless supplemental window with infiltration blockers installed on both upper window pane 478 and lower window pane 490, respectively. The sheet material 498 and 508 of the lower and upper supplemental windows, respectively, is partially shown for illustration purposes and normally covers nearly all or all of the window pane. The upper window sash has infiltration blocker 506 shown cutaway for clarity purposes only. Similarly, the lower window sash has infiltration blocker 500 shown cutaway for clarity purposes as well. Both infiltration blockers 506, 500 are installed on the three non-checkrail sides of the upper and lower sash, respectively. Note that at the top of the lower sash, there is an infiltration blocker (not shown for clarity) that extends upward and to the exterior to cover the sealing interface at the check rail 504. Each supplemental window 480, 481 comprises sheet material 508, 498, respectively. Supplemental windows 480, 481 also include edges or seals 476 corner braces 484, posts 482 with attachment mechanisms 492 (e.g., suction cup), and springs 486. It is noted that seal materials (e.g., pile, O-ring, gel, dry adhesive material, foam, etc.) as described supra may be used. Note that the springs 486 are shown comprising the spring shown in FIG. 6A, they may comprise the springs as shown in FIGS. 6B-6F described supra.

Normally, on the top sash of FIG. 14, infiltration blockers are installed on the vertical sides and the horizontal top of the sash and optionally overlap each other. For clarity, only a section 506 of the infiltration blocker on the left sash is shown. Note that the infiltration blockers normally extend to the corners of the window. At the top corners of the upper sash of FIG. 14, the vertical and horizontal portions of the infiltration blocker normally contact each other and the infiltration blocker closer to the sash may contact the sash. In addition, the horizontal infiltration blockers may be sized to contact the jamb at each side of the sash and the vertically oriented infiltration blockers may be sized to contact the header of the window frame. Additionally, foam or pile (not shown) may be used at the corners of the sashes between the infiltration blockers and the sash or stile to further inhibit air movement toward the interior.

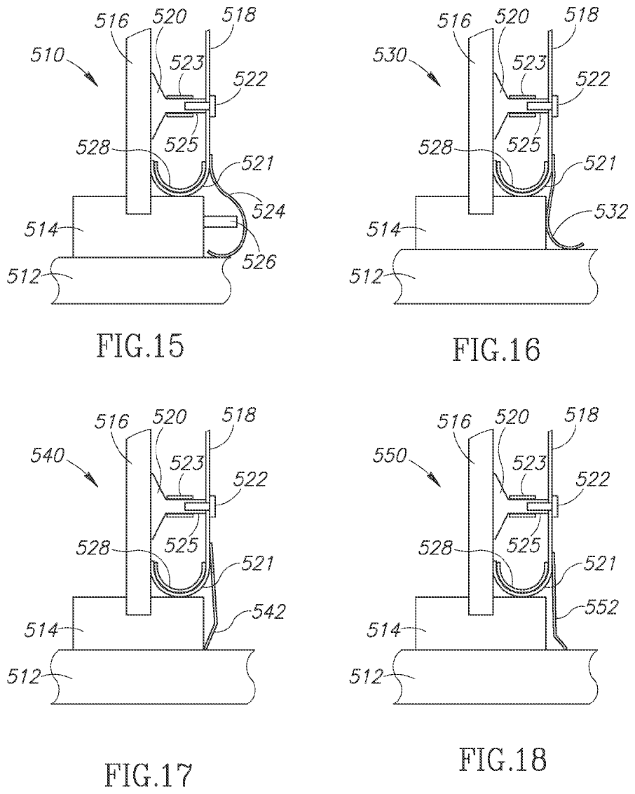

Normally, on the bottom sash of the window shown in FIG. 14, infiltration blockers are installed in which each piece of plastic comprises an arc such that the film contacts the nearest parallel jamb or the sill. For clarity they are omitted from FIG. 14 but shown in FIG. 15, described infra. In the particular embodiments shown, with reference to FIG. 15, the horizontal infiltration blocker at the bottom of the bottom sash forms an arc that is concave to the exterior of the film while the infiltration blockers are concave to interior of the film as shown in FIG. 16, described infra. Alternative embodiments may reverse the concavity of these arcs, so long as the end of each arc contacts the respective inward facing surface of the window frame (i.e. the jambs and the sill). Another embodiment shown in FIGS. 17 and 18, described infra, the infiltration blocker lies substantially parallel to the window pane with a small bend near its point of contact with the jamb. Such a configuration with little or no projection of the infiltration blocker toward the interior is desirable to allow opening of the lower sash without the need to dismount supplemental window parts on the upper sash.

A diagram illustrating a side sectional view C-C′ of the example window of FIG. 14 incorporating a first example infiltration blocker is shown in FIG. 15. This sectional view, generally referenced 510, comprises sill 512, the bottom rail 514 of the lower sash, window pane 516, sheet 518, spring 523, attachment mechanism 520 (e.g., suction cup), post 525 (shown in this example as that portion of the attachment mechanism extending from the suction cup, often referred to as the neck or nub, to the underside of the sheet), cap 522, corner brace 528, bullnose or edge seal 521, horizontal handle 526 and infiltration blocker 524. The installation of the supplemental window onto the window pane creates a substantially enclosed or trapped space (e.g., air) between the plastic sheet and window pane. Infiltration blocker 524 is attached to sheet 518 and extends over rail 514 and handle 516 and is compressed by contact with sill 512. The infiltration blocker is shown having an arc that provides additional space to the interior side rail 514 which is preferable in cases where the rail has a handle 526 attached to aid opening and closing the lower sash. Note that the springs 523 are shown comprising the spring shown in FIG. 6A, they may comprise the springs as shown in FIGS. 6B-6F described supra.

A diagram illustrating a side sectional view C-C′ of the example window of FIG. 14 incorporating a second example infiltration blocker is shown in FIG. 16. In this sectional view, generally referenced 530, the bottom rail 514 is shown without a handle as in FIG. 15. The remainder of the components shown are similar to that of FIG. 15 with the exception that the infiltration blocker 532 is shown with an arc that bends toward, and may optionally contact, rail 514. Alternatively, the arc of infiltration blocker 532 may bend away from rail 514. When considering the installation of the infiltration blocker 532 on the vertical sides of the window, either of the above configurations for the arc allows the lower sash to be raised (and the upper sash to be lowered) while the infiltration blocker remains in sliding contact with the corresponding frame or jamb.

A diagram illustrating a side sectional view C-C′ of the example window of FIG. 14 incorporating a third example infiltration blocker is shown in FIG. 17. In this sectional view, generally referenced 540, the bottom rail 514 is shown without a handle as in FIG. 15. The remainder of the components shown are similar to that of FIG. 15 with the exception that the end of the infiltration blocker 542 bends toward rail 514 with little or no bowing. When mounted to the upper sash, this lack of bowing toward the sliding path of the lower sash allows the lower sash to freely move past the infiltration blocker to open the window. In one embodiment, infiltration blocker 542 is sufficiently thin and flexible so that when installed on the upper sash it fits between the jamb or frame and stile or header and top rail of the upper sash. Similarly, infiltration blocker 542, when installed on the upper sash, may fit between the jamb or frame and stile of the lower sash, allowing the lower sash to be opened and closed without dismounting of the upper sash supplemental window or infiltration blocker. Alternatively, the end of infiltration blocker 542 may bend away from rail 514. In addition, as described infra, the check rail member separation may also be sufficient to allow infiltration blocker 542 to fit between the check rail members.

A diagram illustrating a side sectional view C-C′ of the example window of FIG. 14 incorporating a fourth example infiltration blocker is shown in FIG. 18. In this sectional view, generally referenced 550, the bottom rail 514 is shown without a handle as in FIG. 15. The remainder of the components shown are similar to that of FIG. 15 with the exception that the end of the infiltration blocker 552 is shown bending away from the lower rail. Alternatively, the infiltration blocker may bend toward the lower rail or comprise an arc shape similar to those described supra.

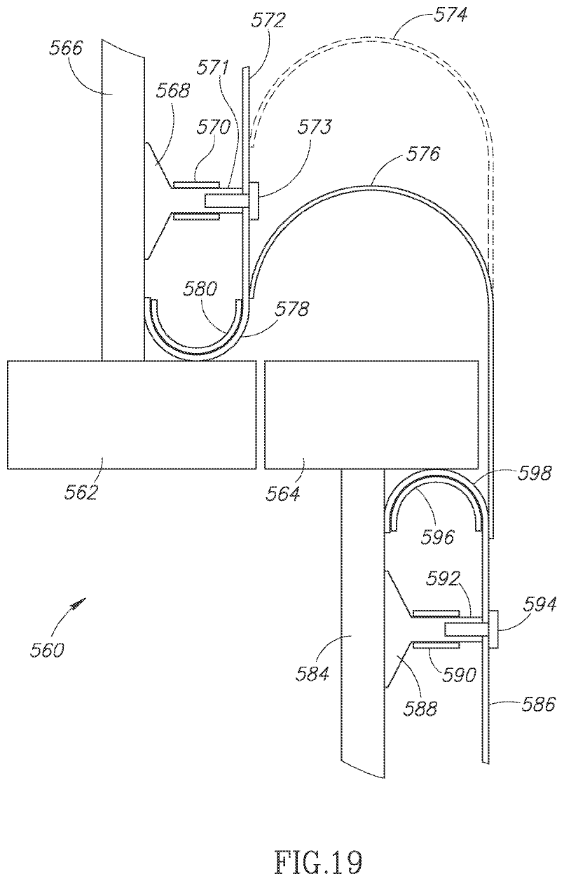

A diagram illustrating a side sectional view D-D′ along the check rail of the example window of FIG. 14 is shown in FIG. 19. An infiltration blocker covers the interface between the upper and lower sashes. In this case, the infiltration blocker is shown attached to the supplemental window unit attached to the lower sash pane thus allowing for operability of the lower sash. Additionally, foam or pile (not shown) may be used at the corners of the sashes between the infiltration blockers and the sash or stile to further inhibit air movement toward the interior.

The sectional view looking along the checkrail, generally referenced 560, comprises a lower sash and an upper sash. The lower sash comprises a top rail 564, window pane 584, sheet 586, post 592, spring 590, attachment mechanism 588 (e.g., suction cups), cap 594, corner brace 596 and bullnose or edge seal 598, creating substantially enclosed or trapped space (e.g., air) between the plastic sheet and window pane. The upper sash comprises a bottom rail 562, window pane 566, sheet 572, post 571, spring 570, attachment mechanism 568 (e.g., suction cups), cap 573, corner brace 580 and bullnose or edge seal 578, creating substantially enclosed or trapped space (e.g., air) between the plastic sheet 572 and window pane 566 and infiltration blocker 576. Note that the springs 590 may comprise the springs as shown in FIG. 6A describes supra.

The infiltration blocker 576 is attached to sheet 586 of the supplemental window attached to the lower sash and extends over the check rail members 564 and 562 contacting bullnose or edge seal 578 of the supplemental window attached to the upper sash. Alternatively, the infiltration blocker may be extended as shown in dashed lines 574 to contact sheet 572 above the post 571 and cap 573 of the supplemental window attached to the upper sash. In either case, the infiltration blocker functions to close the space immediately above the check rail which may be a source of air leakage between the upper and lower sashes.

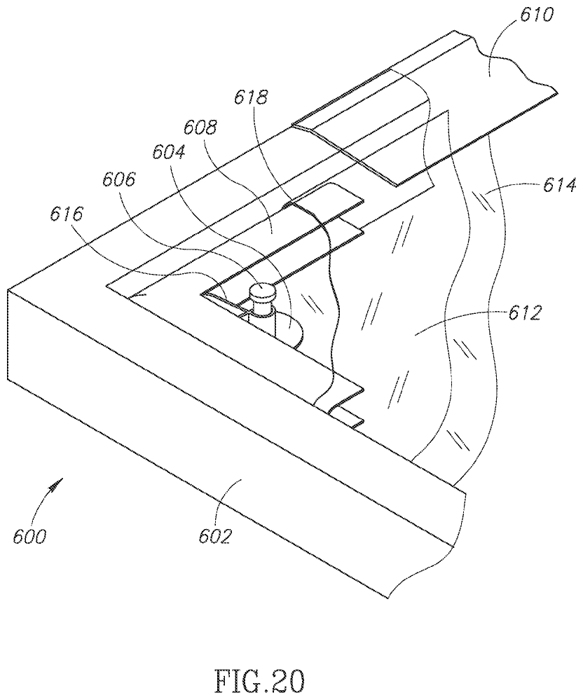

A diagram illustrating a perspective view of a corner portion of the example frameless supplemental window of FIG. 14 with infiltration blockers is shown in FIG. 20. The perspective view, generally referenced 600, of a corner portion of the window comprises sash 602, corner brace 608, sheet 612, window pane 614, attachment mechanism (e.g., suction cup, etc.) 604, cap 606, spring 616 and infiltration blocker 610 (shown partially for clarity purposes). When installed, the attachment mechanism functions to attach the supplemental window to the window pane. The spring applies a force against the corner brace so as to push the corner brace as well as the bullnose seal edge 618 into the corner of the window sash 602. Infiltration blocker 610 is attached to the sheet 612 and functions to prevent or minimize air leakage around one or more window elements, e.g., sash 602 and adjacent jamb, sill or header (not shown), into the interior air space. Note that the springs 616 may comprise the springs as shown in FIG. 6A describes supra.

A diagram illustrating a perspective view of a corner portion of an example supplemental window incorporating a reverse bullnose seal is shown in FIGS. 21A and 21B.

In these perspective views, generally referenced 620, an alternative to the bullnose seal depicted in previous Figures is shown. In this embodiment, the bullnose edge seal is reversed such that rather than having a convex outward shape, the bullnose seal has a concave outward shape 624. The bullnose edge seal 624 is shown attached to the edge of the sheet 626 and sealed against the window pane 622. A corner support 628 attached to the pane side of the sheet (1) provides pressure against the mitered corners of the reverse bullnose seal, (2) aids in forming a tight corner seal against the pane and sash or frame, as well as (3) aiding in sealing against air leakage around the reverse bullnose by being shaped to substantially following the contours of the inward sides of the reverse bullnose when mounted on a window.

The corner support 628 is configured to have a ‘U’ shape whereby the top of the corner support 628 is attached to the sheet and then forms an arc and contoured tip to form a relatively tight fit with the inward sides of the reverse bullnose seal 624. A spring 623, such as shown in FIG. 6A, functions to push against the post and the corner support 628. Cap 621, post 627 and attachment mechanism (e.g., suction cup) 625 are also shown for attaching the supplemental window to the pane. In this embodiment, the optimum insulating distance can be set by the edge seal itself, by use of a spacer (not shown) or use of an attachment mechanism (e.g., suction cup) as described in detail supra.

In a further embodiment, corner support 628 may be formed from a sufficiently strong or thick material, such as a material similar or the same as sheet 626, so that corner support 628 acts as a spacer. In this case, cap 621, spring 623, attachment mechanism 625, and post 627 as shown in FIGS. 21A and 21B may be omitted and an adhesive attachment mechanism may be used between window pane 622 and corner support 628. Though FIGS. 21A and 21B show corner support 628 with a ‘U” shape, alternative shapes such as a ‘Z’ or [symbol] shape may be used for corner support 628. Attachment of corner support 628 to sheet 626 may be made using adhesive which is preferably transparent.

Another example of a frameless supplemental window apparatus 840 is illustrated in FIGS. 21C-21E. The frameless supplemental window apparatus 840 incorporates and has the same structure and operation as the other disclosed examples herein except as illustrated and described below. The frameless supplemental window apparatus 840 is illustrated as installed in an existing window having a window pane 846 held by a sash or frame 848, by way of example only, although the frameless supplemental window apparatus 840 may be utilized with other types of window configurations. In this example, the frameless supplemental window 840 includes a constraint 842, a foot 852, a leg or spacer 854, a sheet 856, an edge seal 860, and an optional tab 880, although the frameless supplement window apparatus 840 may include additional types and/or numbers of elements in other configurations. This example of the frameless supplemental window apparatus provides a number of advantages including providing easier mounting and dismounting, improved operability of the existing window to which the frameless supplemental window apparatus is installed, and fewer parts leading to lower manufacturing costs.

Referring now more specifically to FIG. 21C, which illustrates the corner of sash/frame 848 cut away for clarity, the constraint 842 is attached to the window pane 846 of the existing window using an adhesive 844. Although a single constraint is described, it is to be understood that a constraint may be utilized in each corner of an existing window. Strong, clear adhesive materials that are compatible with glass and plastic, such as 4905 or 4910 VHB acrylic adhesives manufactured by 3M Manufacturing, Maplewood, Minnesota, may be employed, although other suitable adhesives may be utilized for attaching the constraint 842 to the window pane 846. When such adhesives are placed at windowpane 846 perimeter locations such as abutting the edges of the sash/frame 848 at the corners, they provide an aesthetically unobtrusive attachment of the constraint 842 to the windowpane 846. In one example, the constraint 842 has edges configured to be located parallel and adjacent or abutting to the sash/frame 848 at each inward facing interior surface corner of the sash/frame 848 that holds windowpane 846.

In this example, the adhesive 844 discussed above is applied along the entire length of each outward edge of the constraint 842 to form an “L” shape, but not under the entire constraint 842, although the adhesive could be applied in other manners. The application of adhesive 844 in this manner provides for a slot 850 that is formed extending under the constraint 842 to the edge where the adhesive 844 is and between at least a portion of the constraint 842 and the windowpane 846. The height of the slot 850 is determined based on the thickness of the adhesive 844, when constraint 842 is applied to the window pane 846, in the direction perpendicular to the window pane 846, although other manners for setting the height could be used, such as with a spacer of a specified height held in place by the adhesive 844 by way of example only. The slot 850 is defined by the volume between the constraint 842 and the window pane 846 where the adhesive 844 does not extend beyond the edges of the constraint 842 and is sized and configured to detachably receive at least a portion of the foot 852 of the frameless supplemental window apparatus 840 as illustrated and described below. The slot 850 has dimensions parallel to the window pane 846 that allow for movement of the foot 852 within the slot 850 to aid in accommodating measurement error and on site adjustment during installation of the frameless supplemental window apparatus 840. In this example, the constraint 842 includes triangular or truncated edges 864 to allow a portion of the foot 852 to extend beyond the truncated edges 864 when installed in the slot 850 between the constraint 842 and windowpane 846, although other configurations may be employed.

Additionally, the constraint 842 when adhered by adhesive 844 to the window pane 846 is rigid to facilitate insertion of the foot 852 into the slot 850 as discussed below, although other types and/or numbers of materials with other properties could be used. In one example, the constraint 842 is fabricated with a notch (not shown) along the non-adhered edge to allow for insertion and removal of the foot 852 from the slot 850 with less required force.

In this example, the constraint 842 is configured with a low profile, or thickness perpendicular to the window pane 846, in order to allow clearance when installed on an existing window, although the constraint may have other sizes and configurations. By way of example, the total thickness of the constraint 842 and the adhesive 844 perpendicular to the window pane 846 is less than about 0.25 inch, and in some examples less than 0.125″, although other combined thicknesses of the constraint 842 and the adhesive 844 may be utilized. This thickness is typically less than the clearance required for sliding a sash when the frameless supplemental window apparatus 840 is installed on a vertical or horizontal sliding window. By keeping the combined thickness of the constraint 842 and the adhesive 844 to less than the clearance distance from the stationary window pane 846 to the sliding sash, the sliding sash may be opened without obstruction by removing the frameless supplemental window apparatus 840 from the stationary window pane 846 as discussed below. In one example, when using the frameless supplemental window apparatus 840 with prime windows that slide to open (e.g., vertical sliding or horizontal sliding) having a sash lock, the constraint 842 is configured with a dimension, in the direction of sash sliding, larger than that of the sash lock in the direction of sash sliding, to enable placement of the constraint 842 in the corner of the window pane 846, while allowing the frameless supplemental window apparatus 840 to be held in place by the constraint 842 without disruption of the sealing edge by the sash lock hardware attached to the prime window stationary window pane 846.

The foot 852 is configured to be inserted into the slot 850 formed by the attachment of the constraint 842 to the windowpane 846 to provide a seal against the window pane 846. The foot 852 is sized and configured to slide into and out of the slot 850 at each corner of the windowpane 846 to provide a releasable attachment of the frameless supplement window apparatus 840 to the existing window. When installed, foot 852 is substantially parallel to and contacting windowpane 846. In this example, the foot 852 includes tips 862 that are not covered by the constraint 842 when the foot 852 is inserted into the slot 850 as shown in FIG. 21E that interact with the edge seal 860 when installed as described below.

Referring again to FIG. 21C, the spacer 854 is coupled to the foot 852, by example through an adhesive, although in another example the spacer 854 and the foot 852 are formed from the same continuous sheet of material by providing a bend in the material between the spacer 854 and the foot 852. In one example, the spacer 854 and the foot 852 are formed to create a right angle, although the spacer 854 and the foot 852 may alternatively form a continuous arc as illustrated for the corner support 628 shown in FIGS. 21A and 21B. Referring again to FIG. 21C, in this example, the spacer 854 includes a cut edge 858 that is cut to enable conformity with edge seal 860 as shown in FIG. 21C, although the spacer 854 may have other configurations. Optionally, in one example the cut edge 858 of the leg spacer 854 and the conforming portion of the edge seal 860 are welded or adhered together or sealed with grease at or along the arc of contact of these parts.

Other examples utilizing a spacer, such as spacer 854 formed from the sheet 856 by way of example only, are also contemplated in the present technology. In one example, a corner brace such as shown in FIGS. 5A, 5B, and 7A through 7E may be used with the spacer 854 and an edge seal such as shown in FIGS. 3, 4A, 4B, 4C, 10A, 10B, and 11A through 11E. In such configurations, the corner brace may be mechanically or adhesively attached to the spacer 854 such that the spacer edges contact the corner brace while the corner brace exerts an outward force against the edge seal. In one example, the spacer 854 is formed from the same continuous material as the sheet 856 and, as described below, may be used with edge seals 860 also formed from the same continuous material as the sheet 856.

The sheet 856 is coupled to the spacer 854, such that the sheet 856 extends parallel to the windowpane 846 when the frameless supplemental window 840 is installed. In this example, the sheet 856 is substantially planar throughout, although in other examples the sheet 856 may contain edges that are bent either away from the window pane 846 to form a flap 870 (FIGS. 21G and 21H), or toward the window pane 846 to form a flap 872 (FIGS. 21I and 21J), when the frameless supplemental window apparatus 840 is mounted, as discussed below. Sheet 856 has vertical and horizontal dimensions substantially similar to the windowpane 846 vertical and horizontal dimensions on which it is to be mounted. The windowpane 846 dimensions are defined by the inward interior surfaces of the window element (in this case sash/frame 848) that holds windowpane 846.

In one example, the sheet 856, the foot 852, and the spacer 854 are formed from a single continuous, unitary piece of material by utilizing corner cuts to form the shape of the foot 852, the spacer 854, and the sheet 856, although the sheet 856, the foot 852, and the spacer 854 may alternatively be formed from different pieces of material and adhesively attached or welded to one another. For example, foot 852 and spacer 854 may be fabricated from a single piece of material with a small additional section to allow for attachment (e.g., welding or adhesive) of a surface parallel to sheet 856. Suitable examples of materials for these parts are discussed herein supra. In the example illustrated in FIGS. 21C-21E, the foot 852 and the spacer 854 have been formed by cutting and forming or bending near the corner of the sheet 856. In this way, the sheet 856, the spacer 854, and the foot 852 are fabricated from a single, continuous, unitary piece of material. Forming the parts from a single piece of material, without requiring additional assembly and attachment, advantageously provides a frameless supplemental window apparatus with fewer parts and less manufacturing requirements, thus leading to anticipated lower costs. As shown, the bent portions at or near a first intersection 866 between the sheet 856 and the spacer 854 and a second intersection 868 between the spacer 854 and the foot 852, as shown in FIG. 21D, act as cantilever springs that allow further bending when pressure is applied by the end user during attaching and detaching of the frameless supplemental window apparatus 840. In addition, when such pressure is applied, flexing of sheet 856 may also occur during mounting and dismounting of frameless supplemental window apparatus 840.

In this example, the sheet 856, when installed, provides an air gap 857 between the sheet 856 and the windowpane 846, as shown in FIG. 21D. The thickness or spacing of the air gap 857 is determined by the combination of the height of the foot 852 above the window pane 846 and the height of the spacer 854 in the direction perpendicular to the window pane 846. Thus, the spacing, and thus the volume, of the air gap 857 is substantially independent of the thickness of the adhesive 844 used to attach the constraint 842 to the window pane 846.

Referring again to FIG. 21C, the edge seal 860 is constrained inward along interior surfaces of sash/frame 848 to provide sealing between the edges of the frameless supplement window apparatus 840 and the sash/frame 848. Optionally, the edge seal 860 may also comprise sealing material as shown in FIG. 10A such that sealing is provided to the sash/frame 848 along the length of the edge seal 860.

In one example, as illustrated in FIG. 21F, the edge seal 860 has a cross-sectional shape approximating a “3” where one end of the cross-section of the edge seal 860 attaches to or is formed from the sheet 856, one arc of the cross-section conforms to the cut edge 858 of the leg spacer, the middle portion of the “3” in the cross-section aligns with a step formed by the foot tip 862 at the surface of the window pane 846, and the other arc of the cross-section rolls so as to form a self-touching spiral when constrained by the window pane 846, the sash/frame 848, the sheet 856, and/or the first end or arc of the edge seal 860. When a “3” cross-section is employed for the edge seal 860, as shown in FIG. 21F, the portion of the edge seal 860 attached to the sheet 856 and conforming to the cut edge 858 of the spacer 854 may have a larger thickness than the remaining portion of the cross-section of the edge seal 860, by way of example. This provides more robustness and rigidity to the frameless supplemental window apparatus 840 while enabling compression and compliance of the outward arc of the edge seal 860 with the window pane 846, the sash/frame 848, and either the sheet 856 or the thicker portion of the edge seal 860 as the spiral is formed. The edge seal 860 having more than one cross-sectional thickness may be fabricated from more than one piece of material using adhesive or welding, or from a single piece that is formed with the different thicknesses. Optionally, further sealing of the middle portion of the “3” cross-section of the edge seal 860 near the tips 862 of the foot 852 may be provided by the application of grease, such as silicone grease.

In one example, the edge seal 860 includes a slit positioned along its cross-section therein so that the slit is aligned against the side of one of the tips 862 of the foot 852 when installed, eliminating the need for multiple slits when the edge seal 860 has a cross section such as shown in FIG. 21H. Cutting, slitting or notching of the edge seal 860 may be done in a self-aligned manner with foot 852 since the edge seal 860 does not need to overlay the constraint 842.

Referring now to FIG. 21K, in one example the edge seal 860 overlays the constraint 842. In this example, an additional sealing material 882 similar to that shown in FIG. 10A is provided to close the gap that forms between the edge seal 860 and the window pane 846 between the tips 862 of the foot 852 along the edge between adjacent corners. Examples of materials described supra for sealing materials may be used advantageously with outward concave edge seals so that the end user may easily exert pressure on the sealing material 882/window pane 846 contact area. Alternatively, a thin plastic film may be provided on the sealing material 882. Such plastic film inhibits sticking of the sealing material 882 in undesired locations on the window pane 846 during mounting, while providing a smooth surface to contact the window pane 846. In an alternative example, the thin plastic film may be welded directly to the edge seal 860. In these examples, the thickness of the sealing material 882 or the combined thickness of the sealing material 882 and the plastic film is chosen to be the same or slightly thicker than the combined thickness of the constraint 842 and the adhesive 844. This example may also benefit from the use of coating or layer materials (described supra) on the edge seal 860, a corner closure, the spacer 854, and/or the constraint 842.

In examples where perimeter edges of the sheet 856 are bent, as shown in FIGS. 21H-21J, the edge seal 860 is bonded (using adhesive or welding) to the bent portion of the edges of the sheet 856. The sheet edges are bent to allow the edge seal 860 to conform to the cut edge 858 of the spacer 854 or other corner closure. FIGS. 21G and 21H illustrate flaps 870 formed by bending the edges of the sheet 856 away from the window pane 846 along each perimeter edge of the sheet 856 to which the edge seal 860 is attached without (FIG. 21G) and with (FIG. 21H) spiral formation of the edge seal 860, respectively. FIGS. 21I and 21J illustrate flaps 872 formed by bending the edges of the sheet 856 toward from the window pane 846 along each perimeter edge of the sheet 856 to which the edge seal 860 is attached without (FIG. 21I) and with (FIG. 21J) spiral formation of the edge seal 860, respectively. The bend angle of flaps 870 or 872 to the sheet 856 is preferably such that the edge seal 860, when attached to the outward facing surface of the flap 870/872, conforms to the shape of the cut edge 858 of the leg spacer 854 or other corner closure having an outward force on the edge seal 860. In the case of sheet edges bent toward the side to which the window pane 846 resides when mounted to form the flap 872 as illustrated in FIGS. 21I and 21J, the cut edge 858 of the leg spacer 854 may be modified to accept the flap 872 in a friction fit manner, with the edge seal 860 attached to the outward surface of the flap 872.

When such bent sheet edges/flaps 870 or 872 are used, advantages gained include added sheet rigidity and additional surfaces for the end user to grip the frameless supplemental window apparatus 840 during mounting or dismounting. The flaps 870 and 872 also allow for substantially aligning seal materials with the profile of the cut edge 858 of the spacer 854 or other corner closure when the edge seal 860 is attached to the flaps 870/872 of the sheet 856. Further, the seal material may be directed by the flaps 870/872 of the sheet 856 enabling the spacer 854 to apply an outward force on the edge seal 860. As described supra, gap closure between the edge seal 860 and the spacer 854 corner closure may be accomplished using for example grease, foam, pile, etc.

As illustrated in FIGS. 21H and 21I, a perimeter edge of the sheet 856 is bent such that when attached to the window pane, the flap 870 is directed away from the window pane 846 and the edge seal 860 is attached to the flap 870. The flap 870 may be continuous along each sheet edge or, optionally, may for example be cut, slit, or notched in one or more locations to aid bending of the sheet 856 during mounting or dismounting of the frameless supplemental window apparatus 840. Attachment of the edge seal 860 to the flap 870 may be made along perimeter edge length with an adhesive or by welding. The cross-sectional edge seal 860 shape may form a “J” as shown in FIG. 21G or, by making the edge seal 860 from a wider strip of plastic the edge seal 860 may roll back on itself as illustrated in FIG. 21H. When rolled back on itself, the edge seal 860 may form a tube and/or coiled spring that can advantageously have its diameter adjusted parallel to the window pane 846 constrained by the location of the mounted position of the spacer 854 and the sash/frame 848, forming an additional air space within the coiled spring. These advantages are obtained due to the congruent nature of the frameless supplemental window apparatus 840 and the area of the windowpane 846 in the opening formed by inward interior surfaces of the sash/frame 848.

Alternatively, as illustrated in FIGS. 21I and 21J, the flap 872 may be directed toward the windowpane 846 when the frameless supplemental window apparatus 840 is mounted. While FIG. 21I is shown with the edge seal 860 attached to the outward facing surface of the flap 872, the edge seal 860 may alternatively be attached to the inward facing surface of the flap 872 as shown in FIG. 21J. In this example, the cut edge 858 of the spacer 854 near the sheet 856 (as shown in FIG. 21C) (furthest from the window pane 846 when mounted) may be notched to accommodate and/or friction fit the flap 872 or the edge of the spacer 854 may be slit so that the flap 872 is held by the spacer 854 near its shaped edge. It is also noted that the spiral direction edge seal 860 may be reversed from that shown in FIG. 21I, when attached to the outward facing surface on flap 872, thus reducing the spring constant of the edge seal when compressed against the window pane.

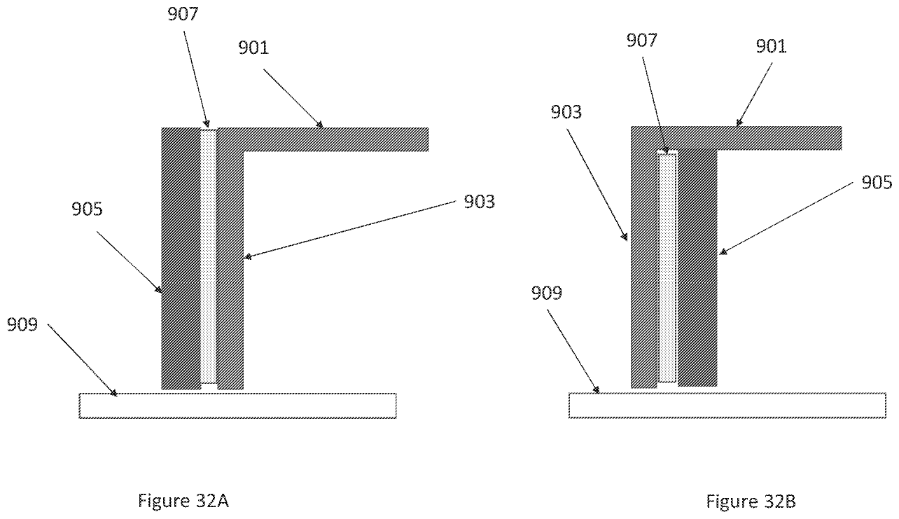

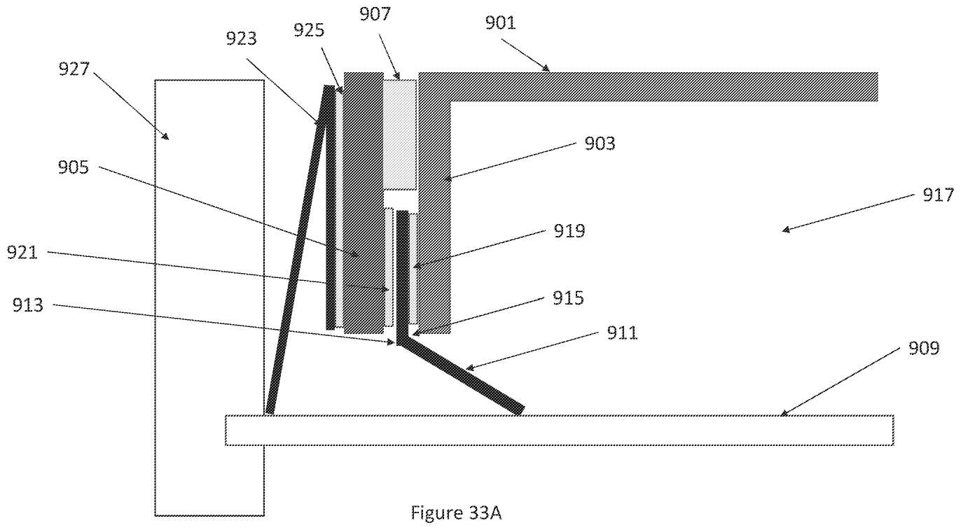

Flaps such as illustrated in FIGS. 21I and 21J are particularly useful in adding rigidity to sheet materials of the present technology. When such flaps are formed to be nearly perpendicular to the sheet, further rigidity may be accomplished. In another embodiment, FIGS. 32A and 32B illustrate respective cross section views of one edge region of a respective supplemental window apparatus when mounted. In this embodiment, stiffener 905 is attached to flap 903. Attachment of stiffener 905 to flap 903 may be accomplished with adhesive 907. Stiffener 905 may be comprised of materials with higher modulus than sheet 901 such as a metal, or a reinforced plastic, such as glass or carbon fiber reinforced plastic, that provide additional rigidity with respect to bowing or bending along the length of the edge. As shown in FIGS. 32A and 32B, stiffener 905 has a small cross-section when viewing through windowpane 909 while having sufficient length perpendicular to windowpane 909 to inhibit bowing. In other words, the ratio of stiffener 905 height (the dimension perpendicular to the windowpane) to width (the dimension perpendicular to flap 903) is greater than 1, and in some examples greater than about 2. Such a configuration has the advantage of providing rigidity while having very little effect on the transparent area or aesthetics of the supplemental window apparatus. Stiffener 125 may be attached on either the outward (FIG. 32A) or inward face (FIG. 32B) of flap 123. Stiffener 905 is formed of a material having a relatively low density (for example, less than about 5 grams per cubic centimeter) and relatively high modulus (for example, greater than about 1,000,000 psi) for example aluminum, a reinforced plastic (e.g., glass fiber or carbon fiber reinforced plastic), wood or wood/polymer composite to limit the weight added to the apparatus while maintaining stiffness and beam strength along the edge length. Attachment of stiffener 125 to flap 123 may be accomplished using adhesive 907 or a plurality of bolts or rivets along the length of the stiffener and flap. When using a flap with added aluminum stiffener, the width of the stiffener 905 when viewed parallel to the flap is in the range of about 0.005 inch to about 0.125 inch. In one example, the width of stiffener 905, when made of aluminum, should be in the range of about 0.010 inch to about 0.10 inch and in other examples, the width should be in the range of about 0.015 inch to about 0.065 inch. The use of stiffeners is especially useful for supplemental window apparatus edge lengths greater than about 30 inches.

Another embodiment for adding rigidity utilizes folding of flap 903. Such folding may be either to the inward or outward side of the flap. Such folding may lead to the form of a cross-sectional shape, such as a “L”, “V” or “U” shape. Alternatively, one or more 180 degree bends in flap 903 may be used.

In another embodiment, it can be useful for the sheet to have a small amount of curl, especially in the direction of the longer sheet dimension, such that the supplemental window apparatus is constructed with the midpoint of a long dimension forced toward the windowpane upon mounting. Such a curl may be induced by winding of the sheet material around a core or exposing the sheet to heat when in a slightly curled configuration. Since the seal will be on the convex side of the curl, the seal will maintain the air gap spacing near the midpoint, while the sheet connection to spacer elements at the corners constrain the ends of the sheet to the desired gap dimension. To inhibit the center of the sheet from approaching or contacting the windowpane and to maintain an optimal separation between the sheet and windowpane, an offset may optionally be attached to one of the sheet or windowpane at a substantially centered location. Such an optional offset may be optically transparent and attached by transparent means such as colorless, transparent adhesive or welding to the sheet so as to minimize optical distortion in the viewing area of the window. The shape, size and material of an optional offset may be chosen to minimize the thermal conduction between the windowpane and sheet. For example, a colorless, transparent plastic, ceramic or glass offset may be used that is pointed or rounded on one side while having a flat portion for attachment on the opposite side, such as, for example, a hemisphere shape.

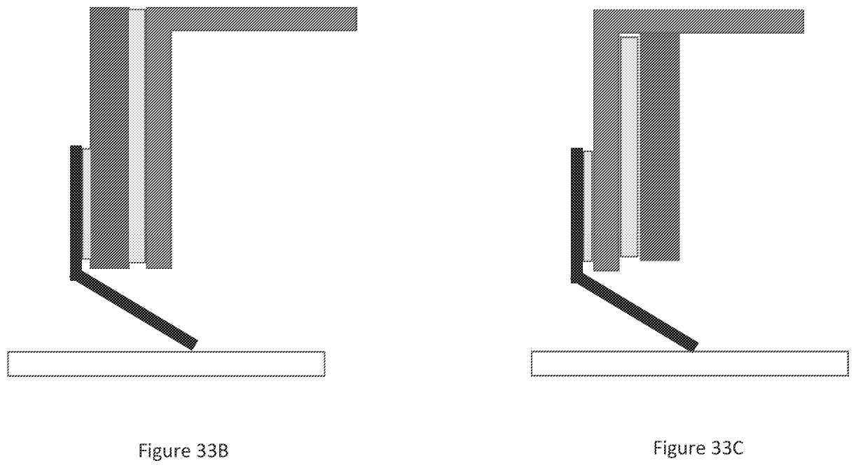

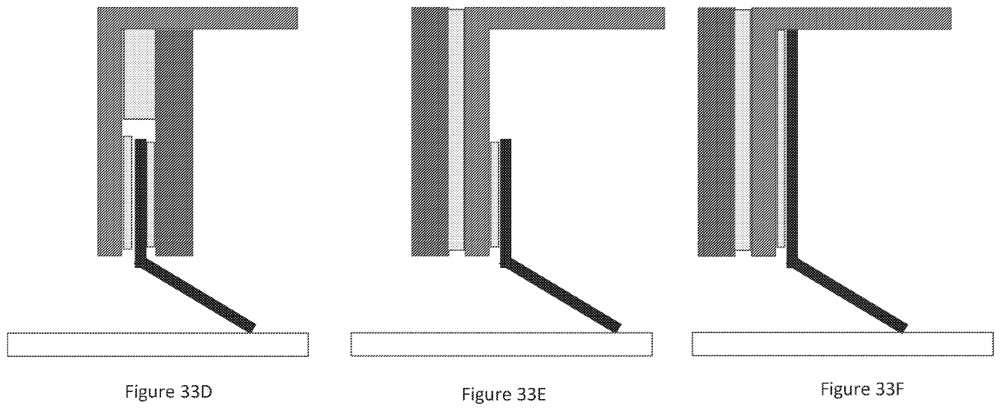

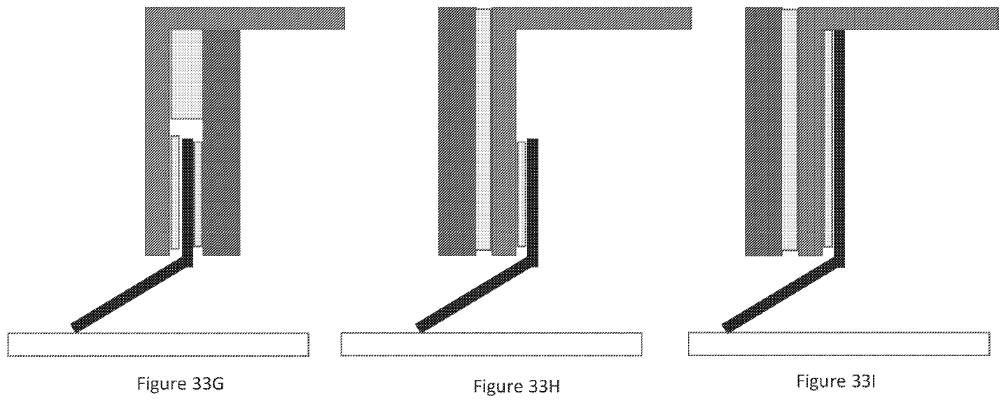

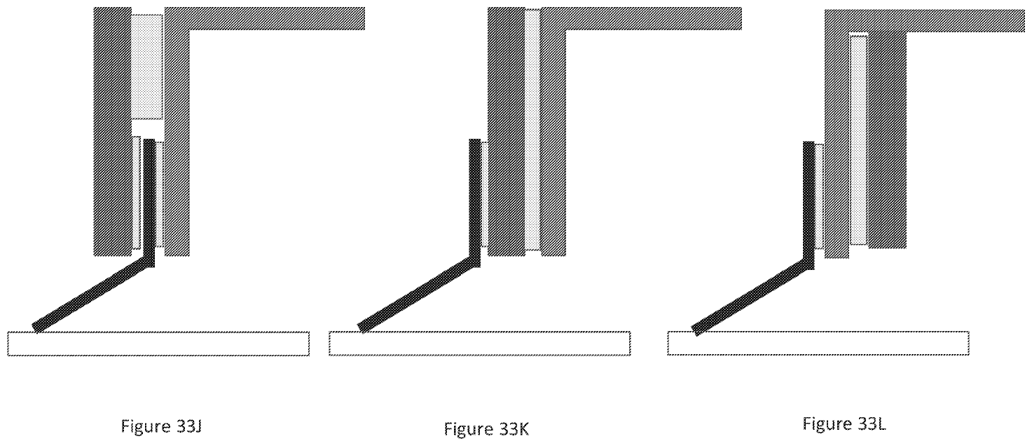

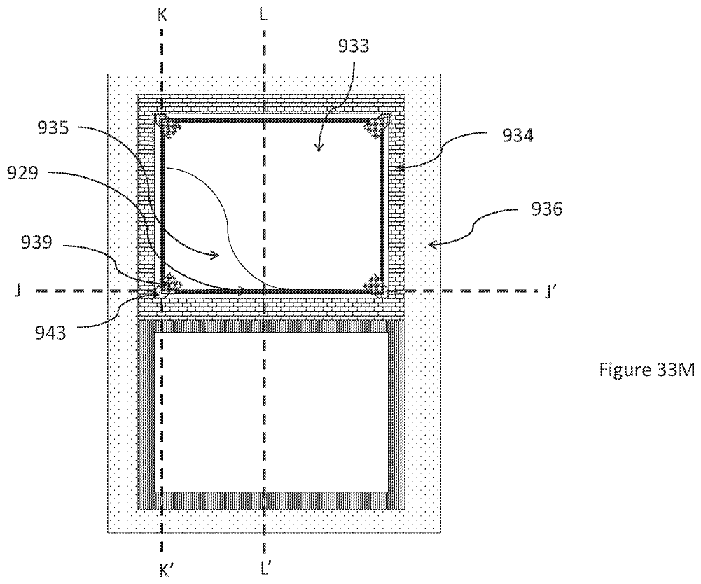

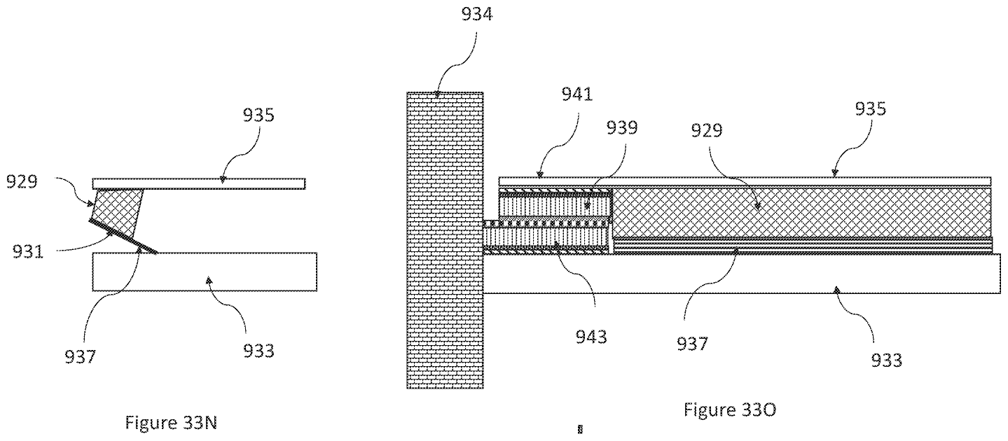

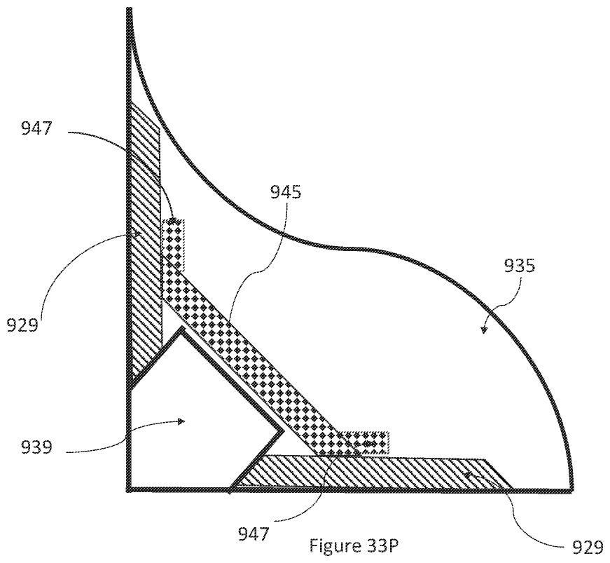

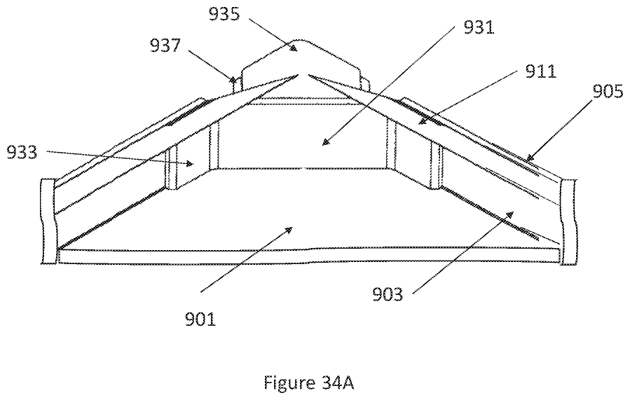

While the flap shown in FIGS. 21I and 21J is shown with a gap between the edge closest to the windowpane and the windowpane, it is understood by those skilled in the art that the flap edge may closely approach or touch the windowpane in a manner similar to that shown in FIGS. 32A, 32B and 12C. In such a configuration, the air between the windowpane and the sheet provides some insulating value. To ensure contact with the windowpane in such cases and further improving the insulating value of trapped air gap 917, a seal, such as a spiral seal as described above, may be added along the length of each flap. Alternatively, a thin creased seal 911 may be attached to flap 903 as shown in FIG. 33A, with the crease 913 at the flap edge or closer to the windowpane. The crease angle 915 is in some examples greater than 90 degrees and less than about 150 degrees, so that the creased seal contacts the windowpane with a small spring constant. Creased seal 911 may be attached to flap 903 using adhesive 919. Optional stiffener 905 may be adhered to one or both of flap 903 (using adhesive 907) and creased seal 911 (using adhesive 921). Maintaining a small spring constant is helpful in minimizing bowing along the edge. Creased seal 911 is in one example about 0.001 inch to about 0.005 inch thick, or in other examples about 0.001 inch to about 0.003 inch thick. Optionally, infiltration blocker 923 may be attached to stiffener 905 with adhesive 925 to cover the space between sash or frame 927, with infiltration blocker 923 shaped to contact one or both of sash or frame 927 and windowpane 909. Other configurations of a creased seal with optional stiffener attached to flap 903 are illustrated in FIGS. 33B through 33L. In addition, a second crease bent in the same direction as the crease just described and outward from the flap may optionally be added when the creased seal extends in an outward direction (FIGS. 33G through 33L) from flap 903. While FIGS. 33A through 33L illustrate a cross-sectional view of creased seal 911, in a further embodiment, creased seal 911 may be made with a crown in the portion of creased seal 911 that has a substantial projection parallel to windowpane 909 when mounted. Such a crown feature results in this portion of the creased seal having a crease angle more parallel to flap 903 near the midpoint of its edge dimension than the crease angle near the corners at which the supplemental window apparatus is fastened. In this embodiment, the crown feature enables closure of trapped air gap 917 to be maintained when bowing of the supplemental apparatus occurs.

FIG. 33M, FIG. 33N, FIG. 33O and FIG. 33P illustrate an embodiment that incorporates edge sealing and stiffener functions along each supplemental window apparatus edge without a flap. In this embodiment, as illustrated in FIG. 33N viewing along J-J′ at L-L′, stiffener 929 is formed in a trapezoidal shape so that sloped surface 931 closest to windowpane 933 is at a small angle with respect to the plane of windowpane 933 held by sash 934 in frame 936. In this example, stiffener 929 is adhered along an edge region of sheet 935 and seal 937 is adhered to the sloped surface 931. This configuration forces seal 937 into sealing contact with windowpane 933, in this case under and/or inward from the stiffener. This embodiment is particularly useful when very low clearance is needed, such as for sliding windows having a clearance of about 0.25 inch, as described in U.S. Pat. No. 10,533,364. It will be appreciated that the direction of the slope may be reversed so that seal 935 contacts the windowpane under and/or outward from stiffener 929. In this embodiment, stiffener 929 has a width projection when viewed perpendicular to windowpane 933 of about 0.1875 inch to about 0.375 inch and a height measured perpendicular to windowpane 933 of about 0.125 inch to about 0.23 inch. Though stiffener 929 is illustrated in cross-section as an acute trapezoid, a right trapezoid shape may be used to minimize the viewing area of windowpane 933 that is obstructed by stiffener 929.

In a further embodiment illustrated in FIG. 33O, when a clearance of about 0.25 inch is desired, fastener 939 may be attached to corner region 941 of sheet 935 so that the fastener corner edges and sheet corner edges are substantially aligned as illustrated in FIG. 33O and FIG. 33P. Stiffeners 929 may be mitered or otherwise shaped to abut an edge of fastener 939, thereby substantially closing the corner. The ends of seals 937 may be shaped so that seals on adjacent edges nearly contact each other or contact each other immediately inward from windowpane mating fastener 943. Optionally, a gel, putty, caulk or grease-like colorless, transparent material may be placed within fastener 939 or fastener 943 to substantially close the corner. Such colorless, transparent material is beneficially chosen to have a refractive index substantially the same as the fastener material to minimize optical impact of the fastener. Alternatively or in addition, a corner closure 945 may optionally be adhered to sheet 935 with wings 947 contacting and/or adhered to stiffeners 929 as illustrated in FIG. 33P.

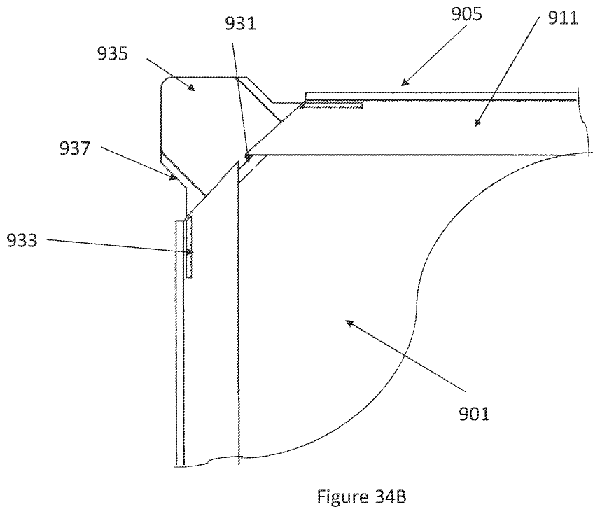

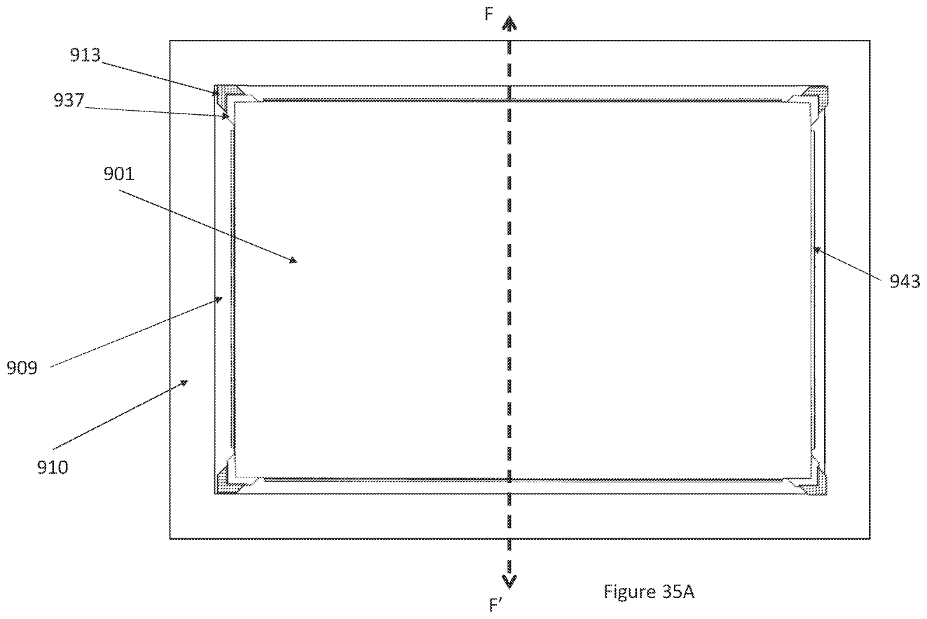

FIGS. 34A and 34B illustrate an embodiment for corner closure when using a flap as described above. FIG. 34A illustrates a corner isometric view from the exterior side (windowpane side) prior to mounting. Along each edge of the supplemental window apparatus are flap 903, stiffener 905 and creased seal 911. At the corner where two edges meet is shown a corner closure spacer 931 that has a wing 933 directed along each edge and fastener 935 attached to foot 937 that extends outward from spacer 931. Each wing 933 may contact respective flap 903 or, optionally, there may be a thin layer of grease or adhesive (not shown) between each wing 933 and respective flap 903 to ensure closure. FIG. 34B illustrates the same corner when viewed from the exterior side prior to mounting. When fastener 935 engages with its mating fastener (not shown) on the windowpane, creased seal 911 along each edge will contact the windowpane and force a decrease in the crease angle. The corner tip of each creased seal 911 is forced toward the spacer 931 surface nearest to the windowpane. When mounted, the corner tip of each seal 911 may be pressed toward the windowpane creating a closure between spacer 931 and the windowpane. The corner tips of creased seals 911 may touch or overlap, similar to FIGS. 11B and 11C, or may leave a very small space between the corner tips. An alternative closure may be provided by a creased seal attached to the inward face of spacer 931 with the seal extending outward under spacer 931 and contacting each seal 931 of adjacent edges that meet at the corner.

When using configurations with the creased seal extending outward, such as those illustrated in FIGS. 33G through 33L, a further embodiment may be used to inhibit bowing. Placement along a perimeter edge, especially a perimeter edge over about thirty inches in length, of one or more of constraint 380 such as illustrated in FIG. 12B, inhibits bowing of the sheet along the perimeter edge. When used in this way, only constraint 380, post 382 and attachment mechanism 376 are required, preferably comprising transparent materials. In an alternative embodiment, constraint 380 may engage in a hole or notch of a stiffener that is attached to a flap as described above. This has the additional advantage of not adding to the overall supplemental window apparatus distance from the windowpane, which is particularly useful on the stationary windowpane of low clearance sliding windows. In one example, at least one of the one or more constraints is placed within the middle fifty percent of the overall edge length of the perimeter edge.

In another embodiment, when a flap is present, an edge constraint may pierce the flap through a via hole that is substantially filled by the edge constraint. When such an edge constraint/flap configuration is used along all four edges of a rectangular supplemental window apparatus, the portion of each constraint inward of each flap may function to confine or hold another element within the air gap. Non-limiting examples of such an element are an aerogel slab, an encapsulated aerogel slab, an electrochromic device, a solar cell array or visible light transparent solar or photovoltaic device that absorbs only non-visible light such as those described in US Published Pat. Appl. Nos. 20190036480, 20200144960 and U.S. Pat. Nos. 10,403,774; 10,741,713; and 10,903,438. In another embodiment, such non-limiting examples of elements may be laminated to the sheet material of the supplemental window apparatus technology. It may be beneficial in such an embodiment to use a sheet material with low water vapor transmission rate, such as flexible glass. Alkali metal aluminosilicate or alkaline earth boro-aluminosilicate flexible glass is beneficial for elements or active devices containing materials that degrade when contacted by excessive amounts of moisture over time.

When using an edge constraint as described above, a portion of the edge constraint attachment mechanism may be located between the flap and windowpane such that bowing force on the attachment mechanism is, as much as possible, a tensile force.

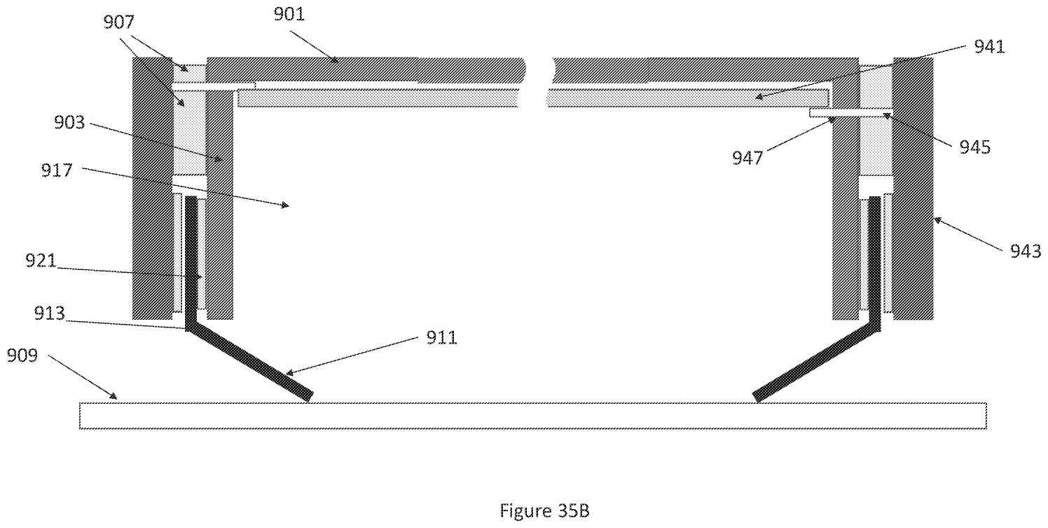

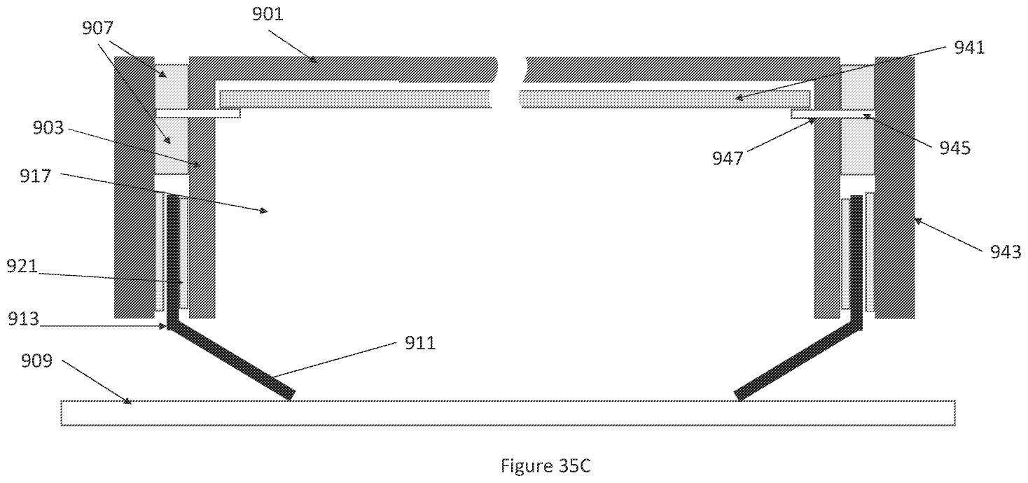

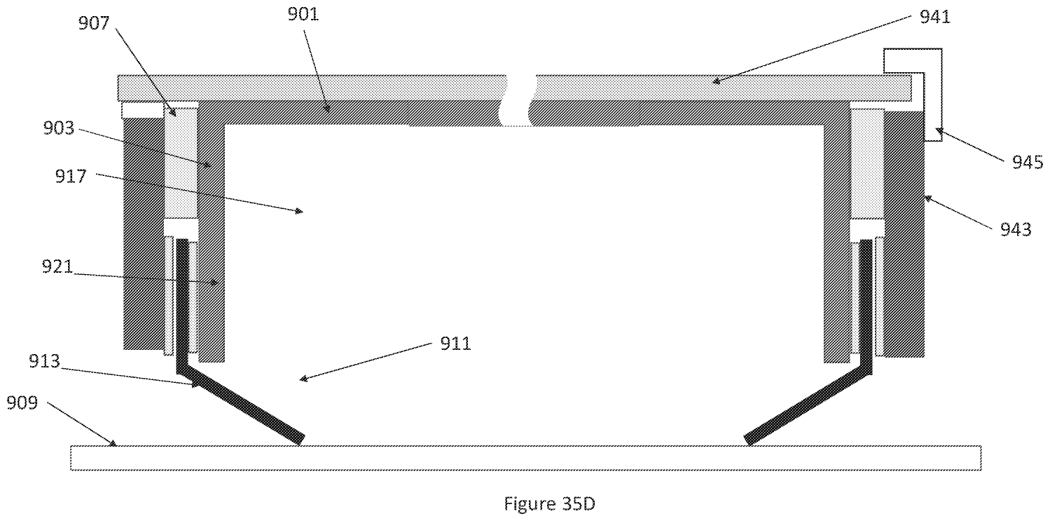

When incorporating an active device with a supplemental window apparatus, electrically conductive stiffeners as described above may act as busbars to aid in the delivery or collection of current or voltage to or from the active device. Electrically conductive stiffeners may also be used as part of an electrical circuit, for example, as part of a window security or alarm circuit, as are known in the art. When used in this way, the stiffener's small width when viewing through the window is advantageous since it does not require hiding for aesthetic reasons and has very little impact on the viewing area of the window. FIGS. 35A through 35C illustrate supplemental window apparatus cross-sectional views incorporating an active device. FIG. 35A illustrates active device 941 attached to sheet 901. Electrical power may be supplied to busbar stiffener 943 from outside air gap 917. Electrical contact of busbar stiffener 905 with active device 941 is accomplished using conductor 945 that connects to busbar stiffener 905 and a contact pad near an edge of active device 941. Conductor 945 substantially fills the cross-sectional area of via hole 947 in flap 903 to prevent air leakage and pierces adhesive 907. In this embodiment, two busbar stiffeners are shown at opposing edges of the supplemental window apparatus, respectively contacting opposite sides of the active device. FIG. 35B illustrates a similar supplemental window apparatus with opposing edge busbar stiffeners contacting the same side of the active device. Optionally, busbar stiffeners on the edges perpendicular to those shown in FIG. 35B may also contact either the same side or the opposite side of the active device as the contacts shown. FIG. 35C illustrates use of busbar stiffeners with an active device located on the sheet surface opposite the air gap. In this embodiment, via holes are not required for making electrical connection between the busbar stiffeners and the active device contact pads. While the above describes an independently fabricated active device 941 attached the sheet 901, it will be appreciated that active device 941 may be printed on sheet 901 using methods known in the art.

Conductor 945 may be a conductive material, conductive paste or conductive polymer. In one example, the via holes are filled with transparent conductive material as are known in the art. Non-limiting examples include PEDOT-PSS, silver nanowire ink, or graphene. In addition to filling via holes with transparent conductive material, such materials may be used to provide electrical conductivity from via hole 947 to a contact pad of active device 941.

When an edge flap is provided along an edge that is less than about 30 inches in length, a stiffener may optionally be omitted while avoiding bowing. For active devices having such an edge length, a thin film busbar may be printed on the edge flap using methods known in the art. Such a configuration also maximizes the viewable area of such a supplemental window apparatus and may optionally be used with an opaque conducting material for the busbar.

In an alternative embodiment, active device 941 is within air gap 917 but not attached to sheet 901. Active device 941 may be parallel to sheet 901 and divide air gap 917 into two substantially equal air gaps. In this embodiment, it is preferred to substantially close the perimeter area between active device 941 and each flap 903 to provide improved insulation performance. In a further embodiment in which the active device is a solar cell array, it may be beneficial for active device 941 to be tilted within air gap 917 so that when mounted on a windowpane, light is captured more efficiently and sound attenuation is improved. It is noted that while these embodiments have described an active device as dividing the air gap or being tilted within the air gap, a passive element, for example another substantially transparent sheet, an aerogel slab or an encapsulated aerogel slab, may be used to provide additional insulation and/or sound attenuation.

Referring again to FIG. 21C, the optional tab 880 may be provided as an attachment to the spacer 854, by way of example only by an adhesive, although optional tab 880 may be formed from the same continuous material as the spacer 854. The optional tab 880 may be used by the end user to hold the supplemental window apparatus 840 and to obtain additional leverage for insertion and/or removal of the frameless supplemental window apparatus 840. The optional tab 880 further provides support for holding the frameless supplemental window apparatus 840 when dismounted from a stationary window pane 846 of a sliding window, when opening the sliding window is desired.

An exemplary operation of the frameless supplemental window apparatus 840 when employing constraint 842 will now be described with reference to FIGS. 21C-21K.

In a first step, in order to apply the frameless supplemental window apparatus 840 to an existing window having a sash/frame 848 holding a window pane 846, the constraint 842 is attached to the window pane 846 of the existing window using an adhesive 844. The constraint 842 advantageously allows for easy mounting and removal of the frameless supplemental window apparatus 840 as described below. The adhesive 844 is placed along and/or abutting the edges of the sash/frame 848 at the corners of the window pane 846. The adhesive 844 is applied along the entire length of each outward edge of the constraint 842 to form an “L” shape. The application of adhesive 844 in this manner provides for a slot 850 formed between at least a portion of the constraint 842 and the window pane 846. The edges of the constraint 842 are then aligned parallel and adjacent or abutting to the sash/frame 848 at each inward facing corner of the sash/frame 848. The adhesive 844 holds the constraint 842 to the window pane 846 adjacent and parallel to each edge of the sash/frame 848 edge at the corner in which the constraint 842. In this example, the constraint 842 is applied to each of the four corners of the window pane 846 of the existing window, resulting in the use of four constraints 842 for the rectangular windowpane 846.

Next, the foot 852 of the frameless supplemental window apparatus 840 is inserted into the slot 850 created by the constraint 842 as shown in FIG. 21C. The insertion of the foot 852 into the slot 850 provides a substantial corner closure for the frameless supplemental window apparatus 840 at the windowpane 846 surface. Although a single foot 852 is described and illustrated, it is to be understood that a foot is inserted into a constraint located at each corner of the window pane 846 of the existing window. The constraint 842 when adhered by adhesive 844 to the window pane 846 is rigid to facilitate insertion of the foot 852 into the slot 850 as discussed below and to maintain contact of the foot 852 with the windowpane 846. The slot 850 has dimensions parallel to the window pane 846 that allow for movement of the foot 852 within the slot 850 to adjust the positioning to aid in accommodating measurement error and on site adjustment during installation of the frameless supplemental window apparatus 840. In this example, a portion of the foot 852 extends beyond the truncated edges 864 when installed in the slot 850 below the constraint 842 to expose the tips 862 of the foot 852.

Insertion of the foot 852 into the slot 850 is aided by the first intersection 866 between the sheet 856 and the spacer 854 and the second intersection 868 between the spacer 854 and the foot 852, as shown in FIG. 21D, which act as cantilever springs that allow further bending when pressure is applied by the end user during insertion for the feet 852 into the slot 850 of the constraint 842. Sheet 856 may also flex when this pressure is applied by the end user. The optional tab 880 as shown in FIG. 21C may also be utilized by the user to assist in the necessary bending to insert the foot 852 into the constraint 842 in all four corners of the existing window. The first intersection 866 and the second intersection 868 acting as cantilever springs, as well as the optional tab 880, also facilitate removal of the frameless supplemental window apparatus 840. Removal may be accomplished by applying inward pressure on the spacer 854 causing flexing at the intersections 866 and 868 between the spacer 854 and foot 852, respectively, and the sheet 856, as well as flexing of the sheet 856 itself. Such inward pressure may be applied directly by the end user, for example using one's fingertips, or may be applied through optional tip 880. In one example, the constraint 842 is fabricated with a notch (not shown) along the non-adhered edge to allow for insertion and removal of the foot 852 from the slot 850 with less force required.

Once the frameless supplemental window apparatus 840 is installed by inserting the foot 852 into the slot 850, the sheet 856 extends parallel to the windowpane 846 to provide an air gap 857 between the sheet 856 and the window pane 846, as shown in FIG. 21D. When using constraint 842, the thickness or spacing of the air gap 857 is determined by the combination of the height of the foot 852 perpendicular to the windowpane 846 and the height of the spacer 854 in the direction perpendicular to the window pane 846 and may be adjusted based on the intended application to provide an optimal thickness for the air gap 857. When constraint 842 is omitted and foot 852 is adhesively attached to pane 846, air gap 857 thickness is determined by foot 852, spacer 854 and adhesive 844 that is between the foot 852 and windowpane 846.

Next, each edge seal 860 constrained along each edge of the frame/sash 848 may be adjusted. The edge seal 860 is located around the edges of sash/frame 848 may provide sealing between the edges of the frameless supplement window apparatus 840 and the sash/frame 848 in addition to or instead of sealing to pane 846. In this example, the outward edge of each edge seal 860 is advantageously mechanically isolated from each adjacent edge seal 860, each spacer 854 and each foot 852. The edge of the edge seal 860 furthest from the attachment point to the sheet 856 is unconstrained so that, upon mounting, the position of this edge of the edge seal 860 may be adjusted in position and shape when constrained by the frame/sash 848 that holds the window pane 846 to which the frameless supplemental window apparatus 840 is attached. For example, this edge may rest on the sheet 856 surface furthest from the windowpane 846 or it may be forced between the sheet 856 and windowpane 846. Importantly, these on site adjustments require minimal end user ability and take place at the perimeter of the window pane 846, resulting in minimal impact on the optical viewing area through the existing window and the aesthetics of the window on which the frameless supplemental window apparatus 840 is mounted. In addition, contact of the edge seal 860 with the sash/frame 848 along each edge may beneficially constrain and adjust each edge seal 860.

Referring now to FIGS. 21G-21H, the edge seal 860 may be bonded (using adhesive or welding) to the flaps 870/872 located at the edges of the sheet 856. The opposing end of the edge seal 860 from the attachment to flaps 870/872 may then be constrained by the sash/frame 848, as shown in FIGS. 21G and 21I, or may spiral over on itself to form an additional air gap located at the edges of the sash/frame 848, as shown in FIGS. 21H and 21J. The flaps 870 and 872 allow for substantially aligning seal materials with the profile of the cut edge 858 of the spacer 854 or other corner closure when the edge seal 860 is attached to the flaps 870/872 of the sheet 856.

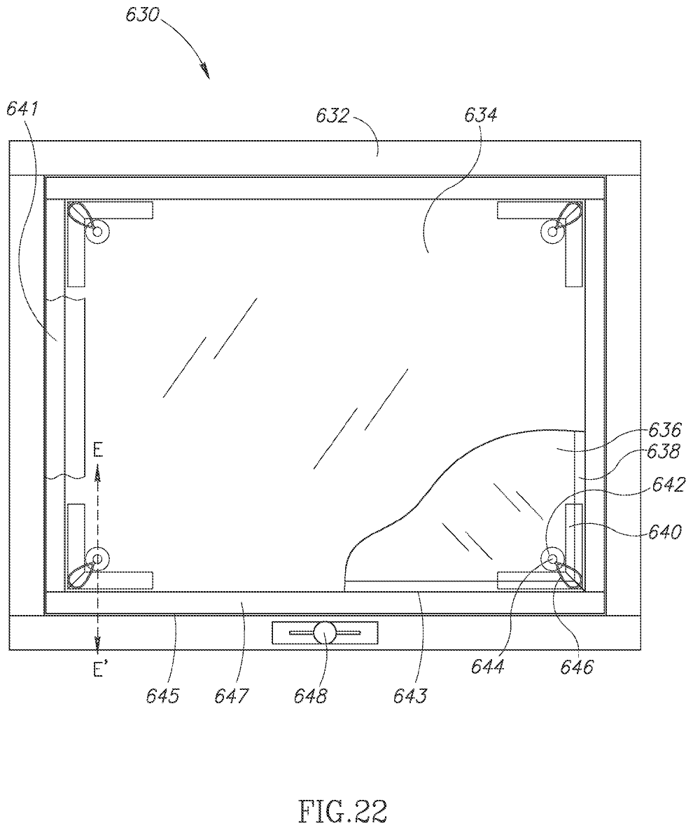

A diagram illustrating a front view of a frameless supplemental window with infiltration blockers at each sealing interface is shown in FIG. 22. This embodiment is useful for windows that open and close by rotation at hinges, such as casement or awning windows. The infiltration blocker shown in this case is similar to that shown in FIG. 14 for the top of the top sash in the vertical sliding window. In FIG. 22, a windowpane held by a sash that closes against a stop to the interior of the sash is shown. The infiltration blocker is formed such that it bends to the interior to that it contacts the stop and covers the sealing interface between the sash and the stop. Such a mechanism is useful along each sealing interface of this type of window. At the corners, where the infiltration blockers meet, the ends of infiltration blockers may be made to overlap, abut or a space may be left between the ends. In each of these cases, the corners may be closed by any means known in the art including, but not limited to, use of miter cuts, foam or pile inserts, or tape. Alternatively, the infiltration blockers shown may be modified to comprise pile, foam, felt, etc. to aid in blocking air infiltration.

Although the front view shown, generally referenced 630, is for a hinged window, such as a casement or awning window, the principles can be applied to other window types as well. The hinged window with frameless supplemental window comprises an existing window frame 632 such as found in awning windows, that is hinged along the top of the window sash. Opening and closing of the window is activated by turning a knob or crank 648. The awning window shown has a frameless supplemental window with infiltration blockers installed on the window pane 634. The sheet material 636 is partially shown for clarity purposes and normally covers nearly all or all of the window pane. The window comprises an existing window frame 632, hinged sash 647 holding the window pane 634, the frameless supplemental window 643 which includes infiltration blockers 641 along each of its four perimeter edges. For clarity, only a portion of the left infiltration blocker is shown. The supplemental window 643 comprises sheet material 636, edge seal 638, corner brace 640, post 644 with attachment mechanism 642 (e.g., suction cup), stop 645, sash 647 and spring 646. Optionally, seal materials (e.g., pile, O-ring, gel, dry adhesive material, foam, etc.) as described supra may be used. Note that the springs 646 may comprise the springs as shown in FIG. 6A describes supra.

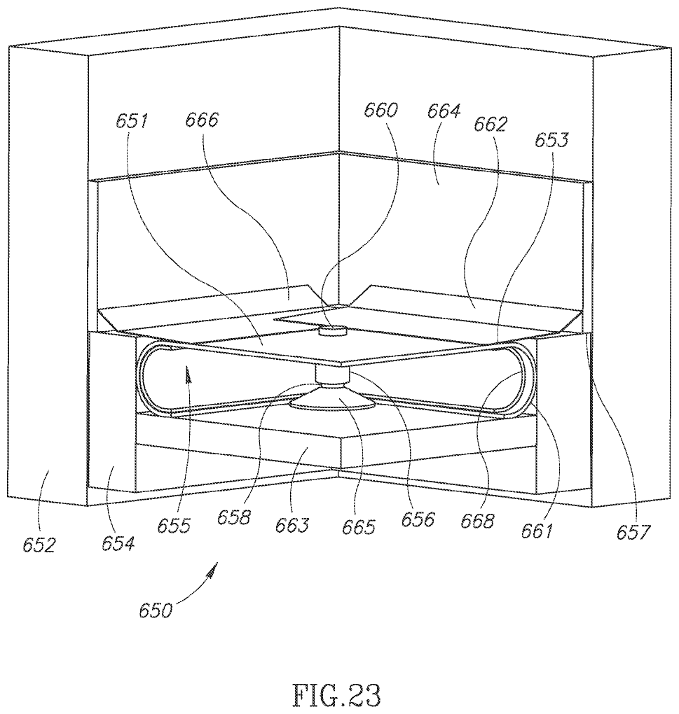

A diagram illustrating an isometric view of a corner portion of the window of FIG. 22 is shown in FIG. 23. The view, generally referenced 650, shows the exterior of the window at the bottom and the interior at the top of the diagram. The isometric view comprises frame or sill 652, sash stile or rail 654, stop 664, windowpane 663, sheet 651, post 658 with attachment mechanism 665 (e.g., suction cup), cap 660, spring 656, corner brace 668 and bullnose or edge seal 661. Infiltration blockers 662 and 666 are attached at the side and bottom perimeter edges, respectively, of the supplemental window 655. When the window is in the closed position as shown in FIG. 23, each infiltration blocker is forced to bend toward the interior somewhat due to contact with stop 664 and cover the sealing interface 657 between sash 654 and stop 664. When the window is opened, the bent end of each infiltration blocker that contacts stop 664 along the non-hinged sides slides across or off the surface of stop 664 while remaining attached to the supplemental window 655. When subsequently closing the window, it may be beneficial to use a thin stiff card or the like to help guide infiltration blockers inward of stop 664. The infiltration blockers are shown attached 653 to the sheet 651. In an alternative embodiment, attachment of the infiltration blockers may be made to the bullnose or edge seal 661. As described supra, the infiltration blockers may be pre-formed to have a bend, angle or arc. Note that the springs 656 may comprise the springs as shown in FIG. 6A describes supra.

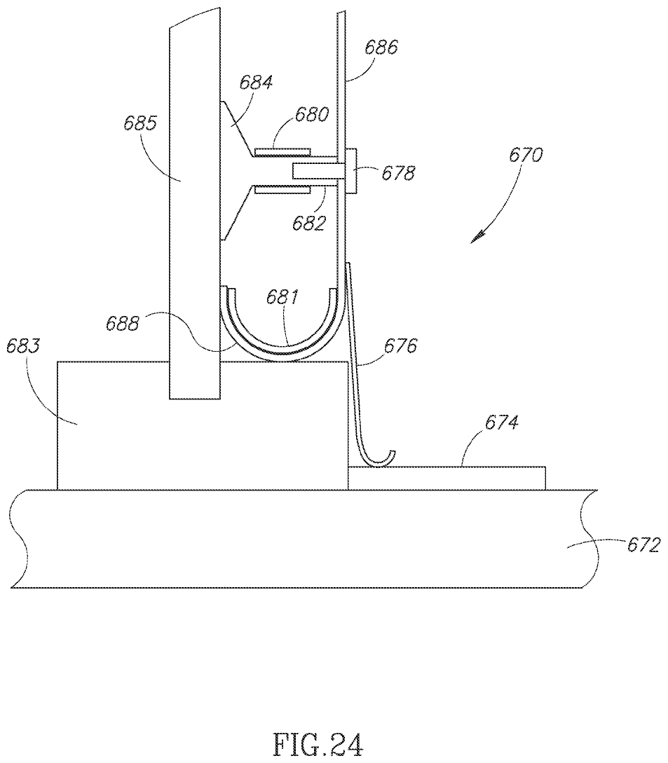

A diagram illustrating side sectional view E-E′ of the example window of FIG. 22 is shown in FIG. 24. The side sectional view, generally referenced 670, comprises sill 672, sash 683, stop 674, windowpane 685, sheet 686, post 682, attachment mechanism 684 (e.g., suction cup), cap 678, spring 680, bullnose or edge seal 688, corner brace 681 and infiltration blocker 676. The supplement window creates a substantially enclosed or trapped space (e.g., air) between the windowpane 685 and sheet 686. Note that the springs 680 may comprise the springs as shown in FIG. 6A describes supra. Note also that in slice E-E′ of FIG. 22, most of the spring 680 is not shown. The only portion visible is a slice of the portion 680 that wraps around the post. In addition, the infiltration blocker 676 is shown in this example embodiment attached to the sheet 686 and having a ‘J’ shaped tip that functions to make a mechanical seal with stop 674. Alternatively, the infiltration blocker can be configured to make a seal with the window sash 683 and the stop 674.

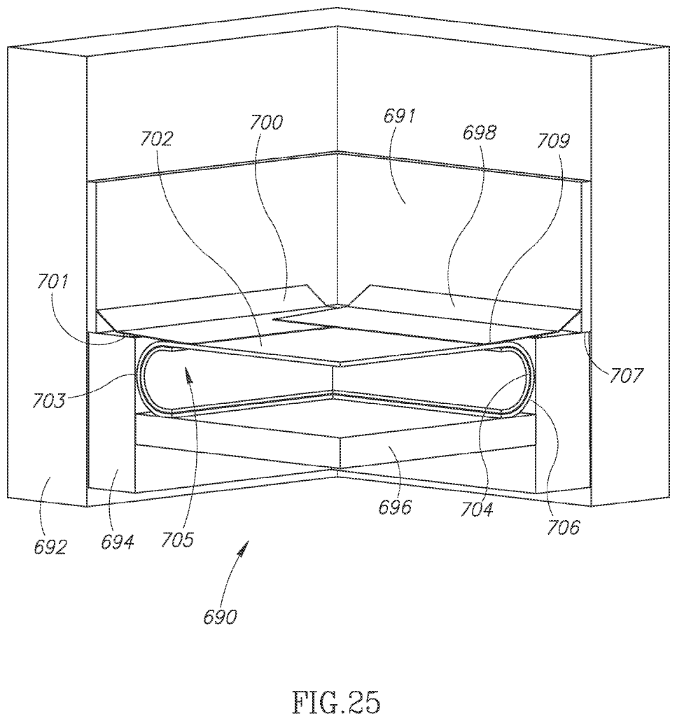

A diagram illustrating an isometric view of a lower corner portion of a window with a frameless supplemental window where attachment is via the infiltration blockers is shown in FIG. 25. The isometric view, generally referenced 690, shows the exterior of the window at the bottom and the interior at the top of the diagram. In this embodiment, the suction cup attachment mechanism is replaced with attachment via the infiltration blockers. The isometric view comprises frame, jamb or sill 692, sash stile or rail 694, stop 691, window pane 696, sheet 702, corner brace 704, optional spring (not shown) and bullnose or edge seal 706. For the embodiment shown, the infiltration blockers 698 and 700 are preferably more flexible than edge seal 706 so that the pane to sheet separation may be determined by the shape of edge seal 706. Infiltration blockers 698 and 700 are attached at the side and bottom perimeter edges, respectively, of the supplemental window 705. When the window is in the closed position as shown in FIG. 25, each infiltration blocker is forced to bend inward somewhat due to contact with stop 691 and cover the sealing interface 707 between sash 694 and stop 691. When the window is opened, the bent end of each infiltration blocker that contacts stop 691 along the non-hinged sides slides across or off the surface of stop 691 while remaining attached to the supplemental window 705. When subsequently closing the window, it may be beneficial to use a thin stiff card or the like to help guide infiltration blockers inward of stop 691. The infiltration blockers are shown attached 709 to the sheet. In an alternative embodiment, attachment of the infiltration blockers may be made to the bullnose or edge seal. As described supra, the infiltration blockers may be pre-formed to have a bend, angle or arc. Note that the springs (not shown) may comprise the springs as shown in FIG. 6A describes supra.

In one embodiment, the infiltration blocker provides the attachment of the supplemental window to the window and pane via adhesive strip 701 sandwiched between the infiltration blocker and the sash 694. Here, the infiltration blocker and adhesive 701 may function both to (1) prevent or minimize air leakage as well as (2) provide attachment to the window.

Alternatively, attachment of the supplemental window to the window and pane may be made via adhesive strip 703 sandwiched between the bullnose edge seal 706 and the sash 694. Here, the bullnose edge seal and adhesive 703 may function to trap and/or enclose a layer of air between the pane and sheet as well as provide attachment to the window.

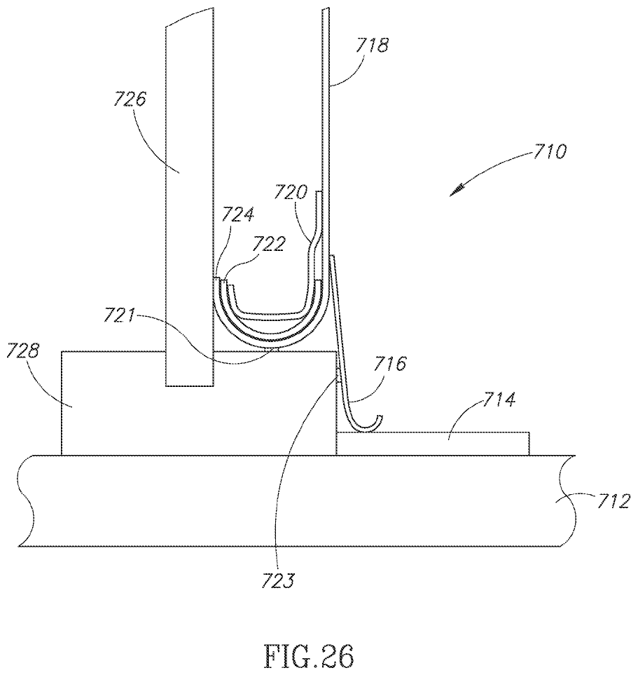

A diagram illustrating a side sectional view of the window of FIG. 25 is shown in FIG. 26. The side sectional view, generally referenced 710, comprises sill 712, sash 728, stop 714, windowpane 726, sheet 718, bullnose or edge seal 724, corner brace 722, spring 720 and infiltration blocker 716. The supplemental window creates a substantially enclosed or trapped space (e.g., air) between the windowpane 726 and sheet 718. Note that in this embodiment the suction cup attachment mechanism is replaced with adhesive strip 721 (on the sash inward facing surface) and/or 723 (on the sash interior facing surface). Note that adhesive strip 721 and/or 723 may be used when considering a vertical or horizontal sliding window, though strip 721 may be preferred if the thickness strip 723 leads to obstruction, for example, of the opening of a vertical sliding window by sliding the lower sash upwards (or the upper sash downwards). Depending on the type of window, adhesive strip 723 may impede the opening and closing of the window while adhesive strip 721 minimizes any interference with the movement of the window. Spring 720 attached to the sheet 718 is configured to apply a force against the corner brace 722 and edge seal 724. The distance between the window pane and the sheet is set optimize the thermal insulating properties of the supplemental window. The distance may be determined by either of the edge seal, corner brace or spring by being constructed of sufficient mechanical stiffness such that the optimal distance between the pane and sheet is set and maintained. For example, the spring sets the distance when pushed toward the window pane by the end user to the point of sensing spring 720 resistance. At that point, the distance between the pane and the sheet is optimal.

The infiltration blocker 716 is shown in this example embodiment attached to the sheet 718 and having ‘J’ shaped tip that functions to make a mechanical seal with stop 714. Alternatively, the infiltration blocker can be configured to make a seal with the window sash 728 and the stop 714.

Attachment to the window can be provided either via (1) adhesive strip 721 which functions to attach the edge seal 724 to the sash 728, and/or (2) adhesive strip 723 which functions to attach the infiltration blocker 716 to the sash 728.

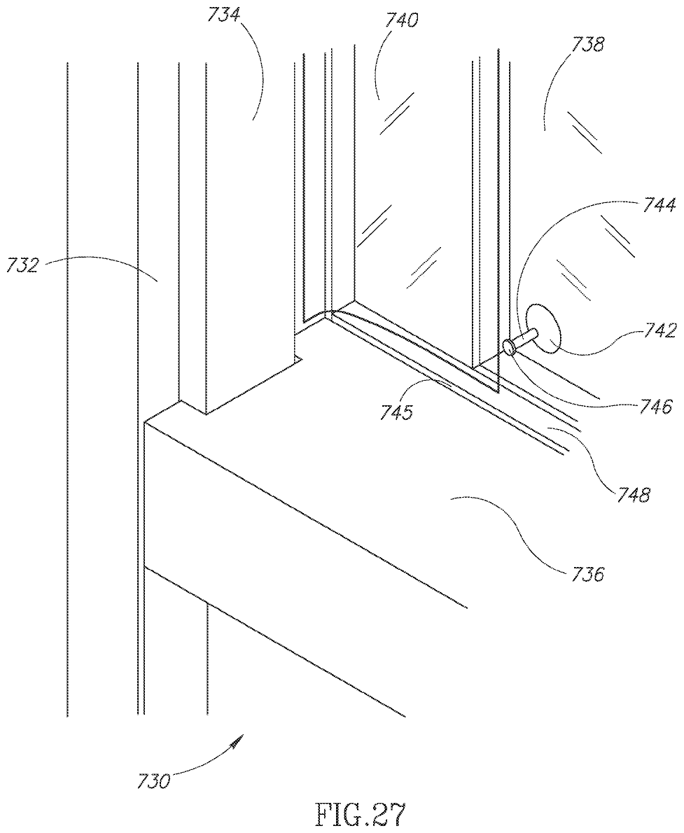

A diagram illustrating a perspective view of an example supplemental window with infiltration blocker in the area of the check rail and jamb of a sliding window (e.g., double hung window) is shown in FIG. 27. In this perspective view, generally referenced 730, the infiltration blocker 740 is shown attached to the sheet 738 which is held attached to the window pane via attachment mechanism (e.g., suction cup, etc.) 742. The optimum distance between the sheet and the pane is set by the combination of the post 744 and compressed suction cup 742. The post is fastened to the sheet via cap 746. In this example, the view is of a portion of the check rail 736 and 748, respectively of the lower and upper sash, jamb or window frame 732 and track 734 of a vertical sliding window (e.g., double hung window). There is an upward facing top sash checkrail surface 748 above which that infiltration blocker 740 (shown on the left side but contemplated on both sides of the window) normally lies after installation of the supplemental window. The infiltration blocker 740 arcs or bends to fit in the space between the left edge of the lower sash and the inward facing portion of the jamb to the exterior side of the track 734 and possibly gap 745. Configuring the infiltration blocker to fit above surface 748 or the checkrail gap 745 and in the track area enables the lower sash to slide freely up as well as the upper sash to slide freely down without blocking the travel of the windows normally present without the present technology installed as well as prevent any damage to the infiltration blocker or other parts of the supplemental window when the windows are opened. It is noted that in this embodiment, the edge seal is attached to the sheet but is not shown for clarity.

In an alternative embodiment, the edge seal is omitted. In this case, the sealing function is performed by the infiltration blocker and the attaching and optimum distance setting is performed by the post and attachment mechanism.

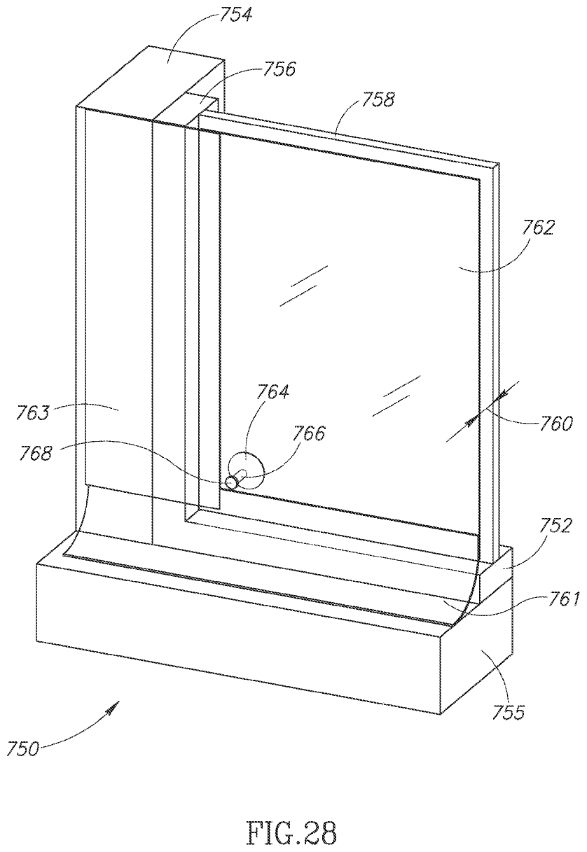

A diagram illustrating a first example frameless supplemental window without an edge seal and incorporating infiltration blockers is shown in FIG. 28. In the perspective view, generally referenced 750, the supplemental window comprises a vertical infiltration blocker 763 attached to sheet 762 and a horizontal infiltration blocker 761 attached to sheet 762. In this embodiment, there is no edge seal as in many of the embodiments described supra. Rather, the sealing function, whether mechanical, adhesive strips or other means, is provided by (1) the vertical infiltration blocker 763 which seals against the side (stile) portions of the sash 756 and (2) the horizontal infiltration blocker 761 which seals against the upper and lower (rail) portions of the sash 752. The attachment mechanism is fastened to the sheet via post 766 and cap 768. The optimum thickness for the enclosed gas layer 760 between the sheet 762 and the window pane 758 is determined by a combination of the post 766 and attachment mechanism 764. Note that in this example embodiment, infiltration blocker 761 flexes to form a smooth arc from the sheet 762 to the sill 755 and functions to prevent or minimize air leakage through one or more window elements and infiltration blocker 763 contacts jamb or frame 754 to prevent or minimize such air leakage.

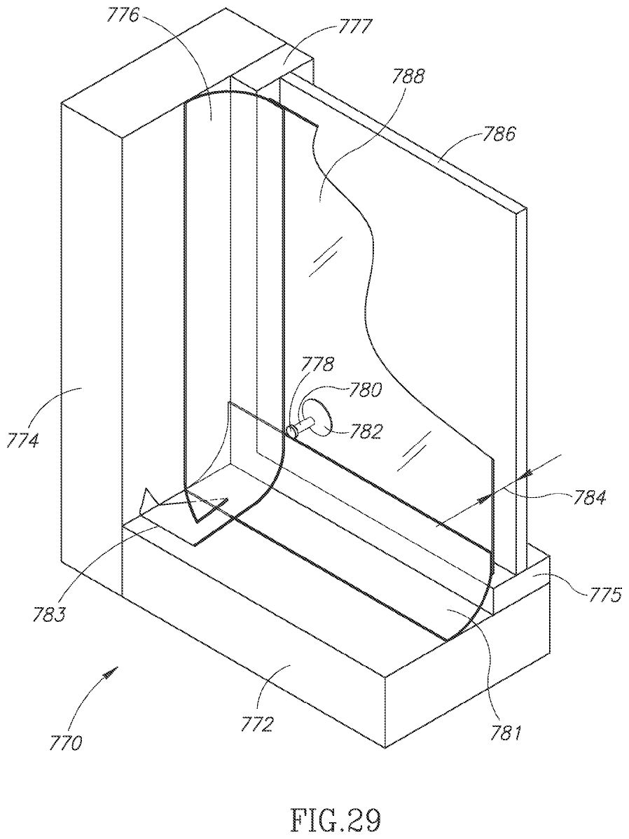

A diagram illustrating a second example frameless supplemental window without an edge seal and incorporating infiltration blockers overlapping in corner areas is shown in FIG. 29. The perspective view, generally referenced 770, comprises sill 772, side frame or jamb 774, vertical sash (stile) 777, bottom sash rail 775, window pane 786, sheet 788, post 780, cap 778, attachment mechanism (e.g., suction cup, etc.) 782, vertical infiltration blocker 776 and horizontal infiltration blocker 781. This example embodiment lacks an edge seal for sealing. Rather, the infiltration blockers 776 and 781 function (1) to provide sealing, via mechanical, adhesive, or other means, of the enclosed or trapped layer 784 between the window pane 786 and the sheet 788, and (2) to prevent or minimize air leakage around one or more window elements. Note that in this example embodiment, infiltration blocker 776 flexes to form a smooth arc from the sheet 788 to the frame or jamb 774 while infiltration blocker 781 flexes to form a smooth arc from the sheet 788 to the sill 772. Infiltration blocker 776 is shown having been cut at its outward corner 783 to allow overlapping of each side of the cut region and enabling the infiltration blocker to easily flex in two directions. Also note that while this example embodiment lacks an edge seal for sealing to the pane for enclosing layer 784 between the pane and sheet, configuration of infiltration blockers overlapping in corners as shown in FIG. 29 may be used in embodiments that have edge seals.

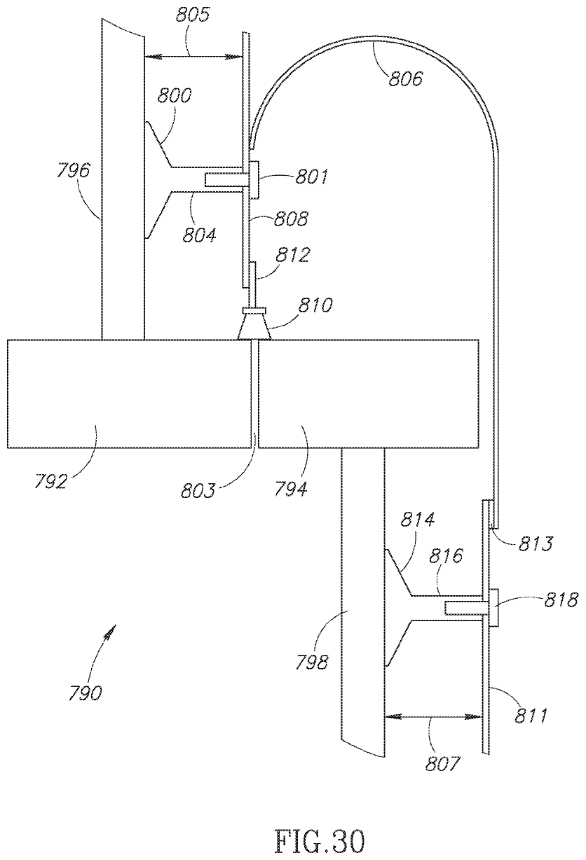

A diagram illustrating a side sectional view in the region of the checkrail of a third example frameless supplemental window without an edge seal and incorporating infiltration blockers is shown in FIG. 30. Note that this embodiment is similar to that of FIG. 19 with the key difference being that the embodiment of FIG. 30 lacks an edge seal.

This sectional view, generally referenced 790, comprises a lower sash and an upper sash of a vertical sliding window. The lower sash comprises a top rail 794, window pane 798, sheet 811, post 816, cap 818, attachment mechanism 814 (e.g., suction cups) and infiltration blocker 806 that extends past the top of the sash window forming an arc and seals (e.g., mechanical, etc.) against the sheet 808 on the upper sash. The post and attachment mechanism 816, 814 sets the optimum distance between the plastic sheet 811 and window pane 798 to maximize thermal insulating properties. The upper sash comprises a bottom rail 792, window pane 796, sheet 808, post 804, attachment mechanism 800 (e.g., suction cups), cap 801 and infiltration blocking portion 810 attached to extension arm 812. The post and attachment mechanism 804, 800 sets the optimum distance between the plastic sheet 808 and window pane 796 to maximize thermal insulating properties.

The infiltration blocking portion 810 may comprise a strip of pile, foam, felt or other insulating material that is offset from the supplemental window such that it covers and preferably contacts the portions of the lower and upper sashes so as to prevent or greatly minimize air leakage through any existing gap 803 between the lower and upper sashes.

The infiltration blocker 806 is attached to sheet 811 of the supplemental window attached to the lower sash and extends over the check rail members 792 and 794 contacting sheet 808 of the upper sash. The infiltration blocker in combination with infiltration blocking portion 810 functions to enclose the close the space immediately above the check rail which may be a source of air leakage between the upper and lower sashes through gap 803 as well as prevent the transfer of gas between the enclosed air layer 807 of the supplemental window installed on the lower sash and the enclosed air layer 805 of the supplemental window installed on the upper sash.

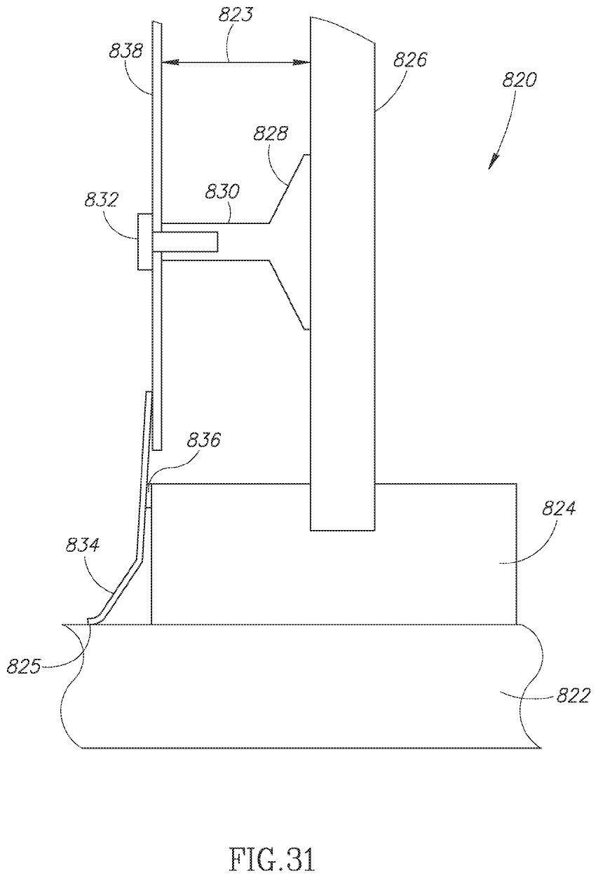

A diagram illustrating a side sectional view of a fourth example frameless supplemental without an edge seal and incorporating infiltration blockers is shown in FIG. 31. This example embodiment, like the embodiments of FIGS. 28, 29 and 30, do not comprise an edge seal. Rather, sealing is achieved via an adhesive strip attached between the infiltration blocker and the sash rail or stile 824. The side sectional view, generally referenced 820, comprises sill or window frame or jamb 822, sash or stile 824, window pane 826, sheet 838, post 830, cap 832, attachment mechanism (e.g., suction cup, etc.) 828 and infiltration blocker 834. Lacking an edge seal, this embodiment is dependent on the seal provided by adhesive strip 836 that attaches the infiltration blocker 834 to the sash rail or stile 824. Note that the infiltration blocker 834, attached to the edge of the sheet 838, serves to seal the enclosed air layer 823 between the window pane 826 and the sheet 838. The mechanical seal 825 between the infiltration blocker and sill, window frame or jamb 822 also prevents or minimizes air leakage around one or more window elements, such as between the sash 824 and sill, jamb or frame 822.

If the sealing interface is wider than the thickness of the infiltration blocker, this enables additional methods for infiltration and exfiltration blocking at higher indoor/outdoor pressure differential by insertion of an infiltration blocker edge into the sealing interface. When the window frame has a channel, such as the jamb of a vertical sliding window, forming the edge of the infiltration blocker into a “V” or “N” shape may be beneficial. When such a shape inserted into the channel may be mechanically trapped by the sash, channel and pressure from either direction. In addition, the infiltration blocker may be formed to provide an optimal spacing over the sash/frame to provide additional insulation or the infiltration blocker may have an aerogel layer or aerogel slab that provides additional insulation over the sash/frame.

In a further embodiment, a separate transparent insulation panel comprising an aerogel layer or aerogel slab, for example a silica aerogel layer or slab, may be attached or adhered to a window element, such as a sash, a frame or a mullion, to decrease heat transfer through the window element. For example, such a panel may be formed by sandwiching the aerogel layer or slab between two layers, where the layers may be plastic, thin glass (less than ⅛ inch thick) or flexible glass. Such a panel is best dimensioned to be substantially the same dimensions as the large planar interior surfaces of the window element to which it is attached. Making this transparent insulation panel less than about 0.2 inches allows for convenient use on the stationary sash of a low clearance sliding window. An adhesive such as strong, clear adhesive materials that are compatible with glass, plastic and aluminum, such as 4905 or 4910 VHB acrylic may be used to attach the separate transparent insulation panel to a sash, frame or mullion while maintaining the aesthetic appearance of the underlying sash, frame or mullion.

Infiltration blockers illustrated in FIGS. 22 through 31 may be mounted with outward edge regions inserted into respective sealing interfaces or outward edge regions may be modified to have “V” or “N” shapes which may be inserted into the respective sealing interfaces. In such a configuration, closure of the window forces the outward edge to contact both the outward facing surface of the sash and the inward facing surface of the jamb that form the sealing interface. In this case, the outward edge region is shaped in an “N” shape, such that the outwardmost line is shorter than the jamb channel (sliding windows). This allows the infiltration blocker to be forced into either the interior or exterior facing surface of the jamb channel if a significant pressure differential exists between the indoors and outdoors.

In another embodiment, the infiltration blocker may be shaped to form a surface substantially parallel to the sash/frame and have a width similar to the sash/frame width. In such a case, it would be preferable for the end user to provide the depth of the pane in the sash to allow for design of the infiltration blocker surface parallel to the sash/frame surface gap that is optimal, similar to that preferred for the sheet to pane distance.

The infiltration blockers shown in the Figures described supra may comprise a non porous flexible material. Thin pieces of thermoplastic film or sheet may be used, for example, polyethylene terephthalate having a thickness of approximately 0.002 to about 0.020 inch and preferably approximately 0.003 to about 0.010 inch. The thin pieces of non-porous flexible material may be attached to the plastic sheet or the edge seal along each perimeter edge of the supplemental window. The attachment to the sheet or edge seal may be accomplished by any of the means described supra, including welding (e.g., ultrasonic, laser, RF, etc.) or adhesive means. The infiltration blockers on the window sides and top are sized such that they deform, compress or bend, relative to their relaxed shapes, when in contact the window stop, jamb, frame, sill or header, thus covering potential infiltration regions between the sash stiles or sash rails and the respective jambs, frames, sill or header when the window is in the closed position. The edges of the edge seal and infiltration blockers that are not attached to the supplemental window may be curled, curved, polished or beaded to avoid exposed sharp edges.

The infiltration blockers described herein may be used in conjunction with any of the embodiments described supra. In addition, such infiltration blockers may be used in embodiments that omit the sheet of a supplemental window. Thus, in general, the infiltration blockers may be attached directly to a supplemental window part such as a post, seal or sheet. When used without the sheet material, attachment of the infiltration blocker to the window directly, or indirectly by attachment to a post or seal which in turn is attached to the window, is accomplished by the mechanisms described herein, e.g., suction cups, adhesives, dry adhesives, etc. or welding or adhering to other parts described herein.

While the embodiments described supra provide for attachment of the infiltration blocker to the supplemental window which in turn is attached to a window pane, attachment mechanisms may be used to releasably attach the infiltration blocker to one or more of the pane, sash rail or stile, jamb, frame casing, sill or header of the window.

As described supra, the infiltration blocker may form an angle, bend or arc such that sealing surfaces or extensions of such sealing surfaces through which infiltration may occur are contacted by the infiltration blocker on two sides of the sealing interface to the interior or inward of the sealing interface. Angles, bends or arcs in the infiltration blockers may be pre-formed by thermoforming or cold forming or bending such that the infiltration blocker may still undergo deformation when mounted, due to contacting a window surface (e.g., sill, jamb, frame, sash or header) or another supplemental window.

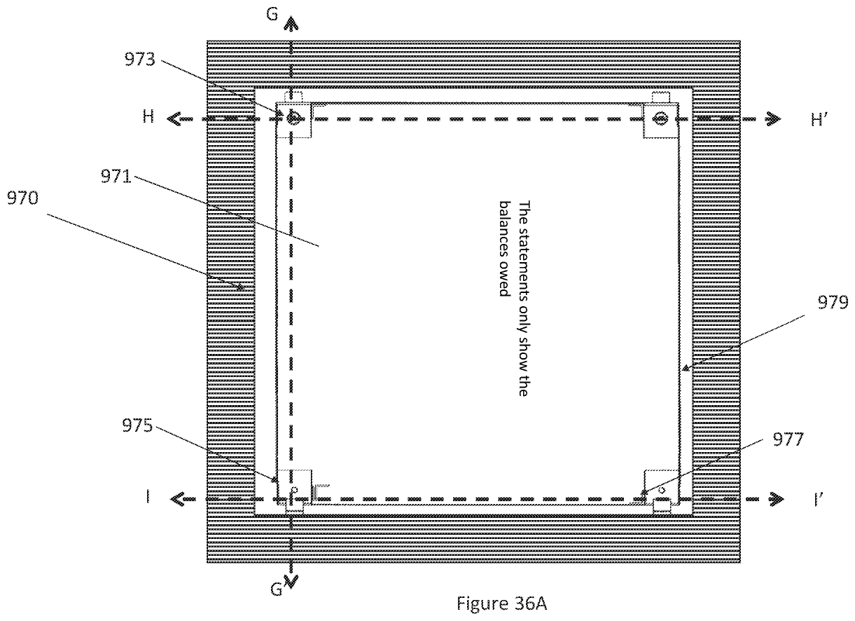

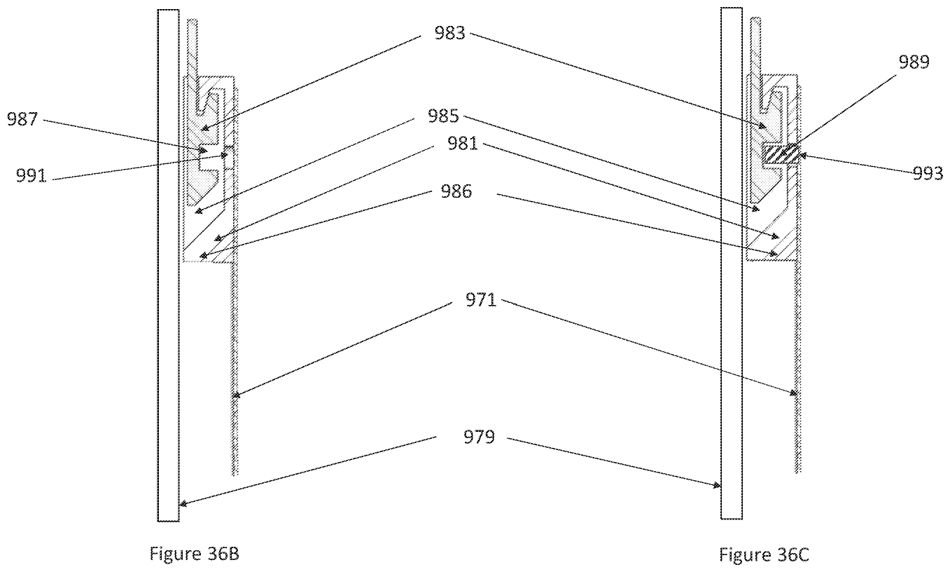

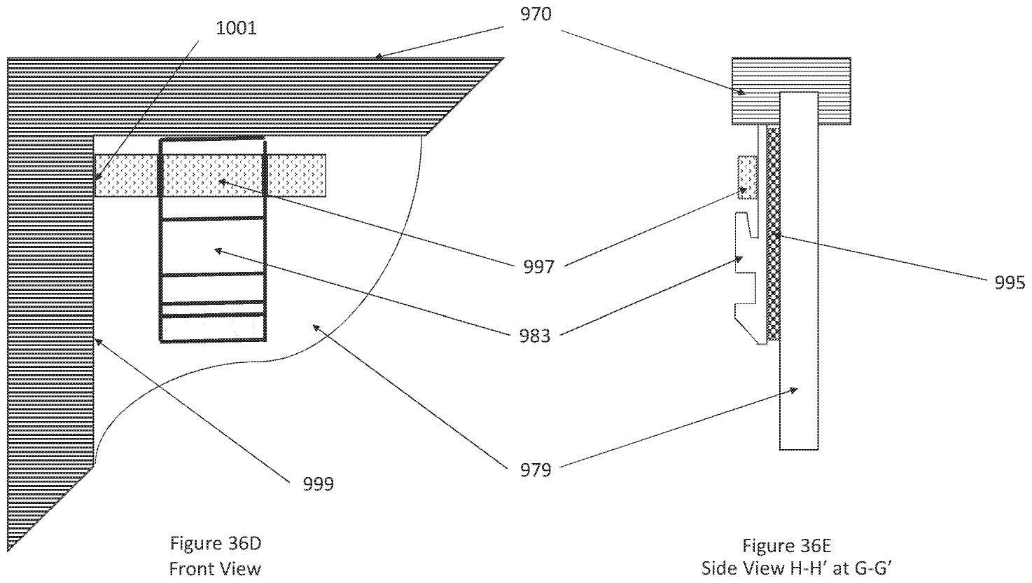

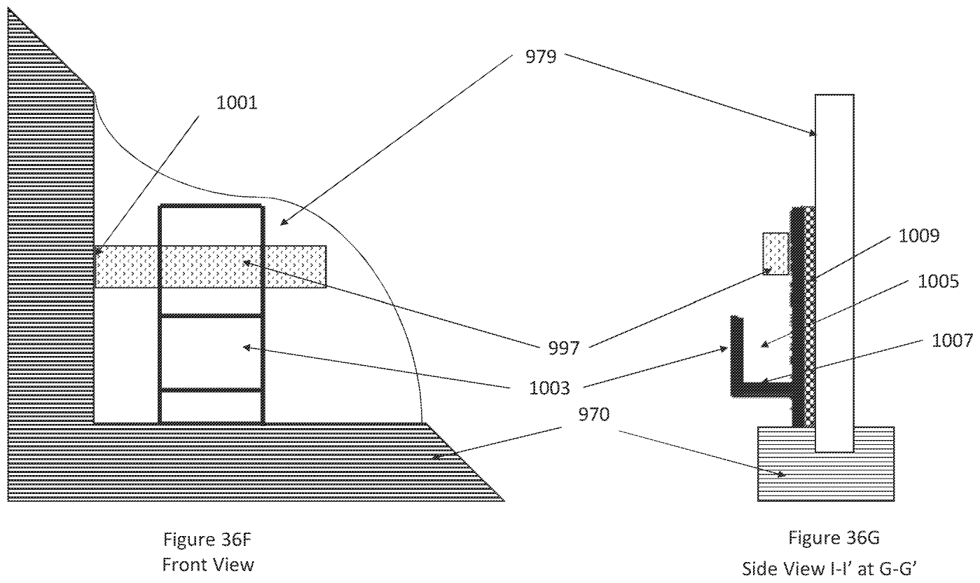

FIGS. 36A through 36E illustrate a further embodiments for attaching a supplemental window apparatus to a window with seals omitted for clarity. In this embodiment, attachments and constraints are made such that the supplemental window apparatus can lengthen or contract horizontally or vertically, such as during extreme temperature excursions, while held by the top attachments. This embodiment is particularly useful when the supplemental window apparatus dimensions are large and/or the sheet material is comprised of a material with a high thermal expansion coefficient. This embodiment combines two hook and hanger engagement mechanisms 973 spaced apart near each of the top windowpane corners and two slot and foot engagement mechanisms 975 spaced apart near each of the bottom windowpane corners, such that sheet 971 is substantially centered within windowpane 979 held by sash or frame 970. In one embodiment, a combination of hook and hanger engagement mechanisms 973 at the top corners of the supplemental window apparatus with slot and foot engagement mechanisms 975 at the bottom corners of the supplemental window apparatus in a single supplemental window apparatus may be used. Hanger 981 (FIGS. 36B, 36C, 36D and 36E) and the foot of slot and foot engagement mechanism 975 may be structurally the same, shown in cross sectional view G-G′ looking along H-H′ of FIG. 36A.

FIG. 36B illustrates engagement of hanger 981 with hook 983. To allow for engagement, hanger 981 has cavity 985 into which hook 983 resides upon mounting. Cavity 985 allows engagement and corner closure to occur while sheet 971 to windowpane 979 distance can be set to a desired distance. Creating thickness 986 of hanger 981 to match that of the hook hanger engagement thickness enables corner closure. Such engagement is especially useful when a low profile is needed to accommodate low clearance sliding windows. Further, cavity 985 is shaped to allow the supplemental window apparatus to be raised off hook 983 for dismounting, when desired.

A further optional embodiment is also illustrated in FIG. 36B and FIG. 36C. This embodiment comprises slot 987 and locking element 989 that fits through hole 991 in hanger 981. This embodiment inhibits dismounting of the supplemental window apparatus sheet portion. Nonlimiting examples of locking element 989 are a pin, rivet, screw and bolt. In one example, the head portion 993 of locking element 989 not protrude above the plane of sheet 971. The locking element is desirable in situations where the supplemental window apparatus is likely to be subject to incidental bumping or access by small children who may try to remove the sheet portion.

FIGS. 36D and 36E illustrate an embodiment for accurate placement of hook 983 relative to a top windowpane corner. Hook 983 is attached to windowpane 979 using adhesive 995. Preferably, adhesive 995 is transparent, such as an acrylic based adhesive, for example as found in 3M VHB adhesives. Positioner 997 is reversibly attached to hook 983 so that hook 983 may easily be placed at a predetermined distance from inward frame vertical edge 999 when positioner 997 outward edge 1001 aligns with or contacts inward frame vertical edge 999. Once hook 983 is adhered to windowpane 979, positioner 997 is removed so that it does not interfere with mounting of hanger 981. In a one embodiment, the hook-hanger attachment illustrated in FIGS. 36B and 36C, or FIGS. 36D and 36E is used at the top corners of a rectangular windowpane and a foot-slot attachment, for which the slot is illustrated in FIGS. 36F and 36G are used at the bottom corners of the same rectangular windowpane. Again, a positioner 997 is reversibly attached, in this case to constraint 1003, to enable bottom corner placement as described above. Sizing of sheet 971 portion of the supplemental window apparatus may be made such that, when hanging on the hook, the bottom of the foot fits into slot 1005 after removal of positioner 997, if used, without reaching the bottom inward surface 1007, of constraint 1003. Adhesive 1009, as described above for FIGS. 36D and 36E, is used to attach constraint 1003 to windowpane 979. Such a configuration allows for both easy mounting by first inserting the foot at each bottom corner into its respective slot 1005 followed by a slight vertical lift so that hook 983 fits into cavity 985, and completing the engagement by lowering hanger 981 onto hook 983 at each top corner.

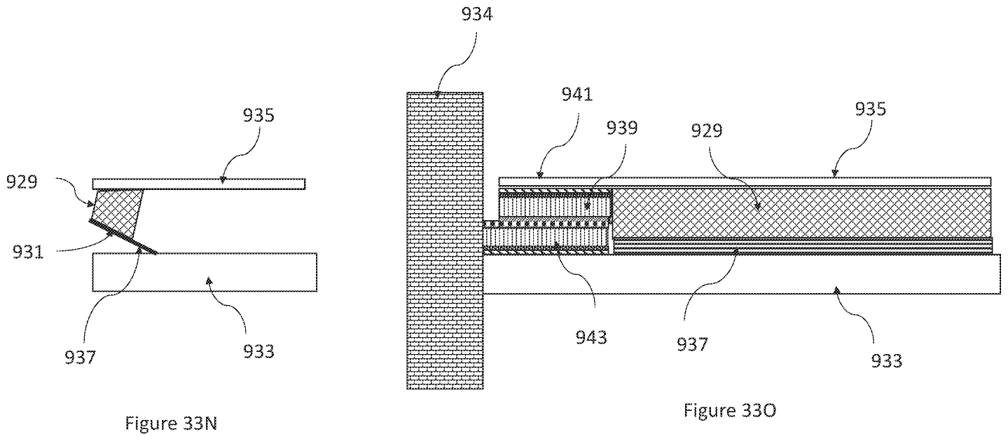

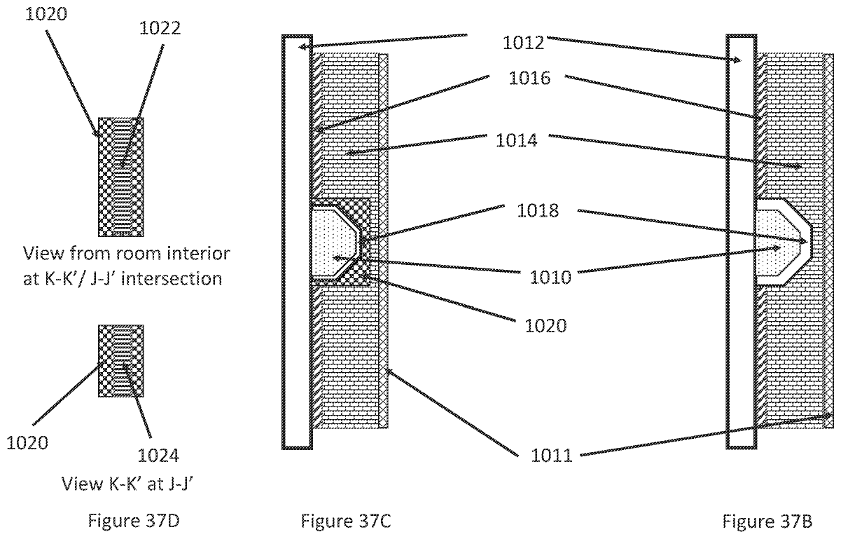

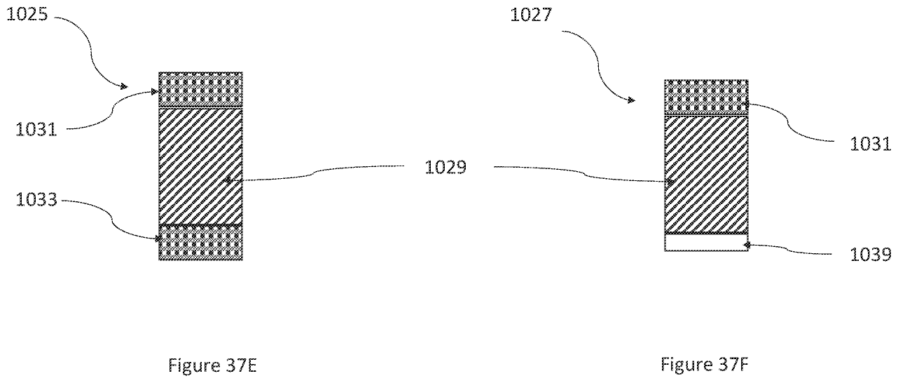

When protruding muntins are present on a window to which the present technology is attached, a supplemental window apparatus having a flap 872 directed toward the windowpane, as shown in FIGS. 21I and 21J, may be modified. As illustrated in FIG. 37A, a supplemental window apparatus may attach to a windowpane 1012 such that protruding muntins 1010 cross each flap 1014 near the windowpane perimeter. To avoid lifting sheet 1011 away from the windowpane, thereby creating a larger air gap and disruption of closure around the air gap, FIG. 37B illustrates a notch 1018 cut out of each flap at and around the crossing area of each protruding muntin. In this way, seal 1016 remains in contact with windowpane 1012 and sheet 1011 remains substantially parallel to windowpane 1012, and at the desired distance from windowpane 1012. The area of notch 1018 between protruding muntin 1010 and flap 1014 may be filled with gel or putty material, which is preferable optically transparent and colorless, for example similar to the relatively viscous and stiff polysiloxane based combined mass described in U.S. Pat. No. 7,618,349. FIG. 37C illustrates an alternative notch 1018 shaped as a rectangle into which closure 1020 is attached. FIG. 37D illustrates closure 1020 with grooves 1022 and 1024 along its edges to accept flap 1014 in a friction fit manner. Closure 1020 has a notch through which protruding muntin 1010 crosses. In this case, the notch in closure 1020 may be filled with gel or putty material. Alternatively, closure 1020 may comprise compressible spring material that compresses around protruding muntin 1010 so that a friction clip engagement is formed that fills the area between protruding muntin 1010 and flap 1014 not filled by closure 1020.

When the interior-most surface of protruding muntins 1010 are more than about 0.75 inch from windowpane 1012, it may be desirable to provide a supplemental window apparatus having seals or infiltration blockers (not shown) that extend to contact sash 1013 or frame 1015 while a single sheet covers all of the protruding muntins 1010. In such cases, offset 1025, illustrated in FIG. 37E or offset 1027, illustrated in FIG. 37F may be used. Offset 1025 may be used when a mating fastener 1035 is provided on windowpane 1012. Offset 1025 is provided with fastening material 1031 on the interior and exterior ends. In this case, foot portion 1037 of the supplemental window apparatus with fastening material (not shown) on the windowpane side of foot portion 1037 fastens to fastening material 1031 is provided at the interior end. Fastening material 1033 at the exterior end of offset 1025 engages mating fastener 1035. The offset material 1029 may be a colorless, transparent plastic material. In another embodiment, offset 1027 is provided with adhesive 1039 at one end to allow direct adhesion to windowpane 1012 when no mating fastener is provided on windowpane 1012. Using an offset allows for more uniformity part size for supplemental window apparatus corners while accommodating variation in protruding muntin dimensions.

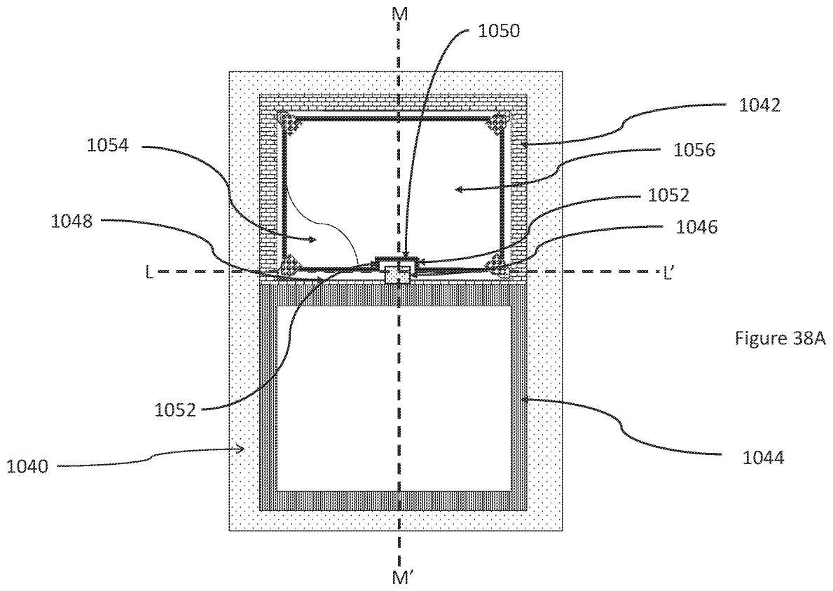

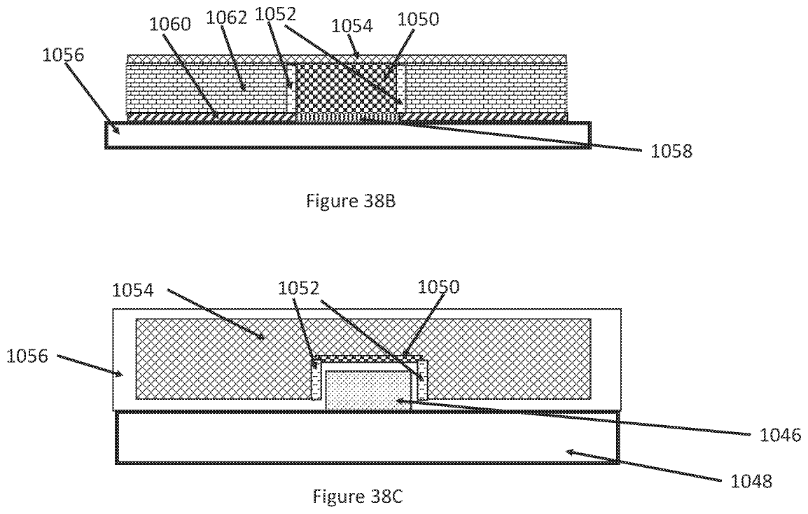

Many windows have hardware components that encroach on a windowpane area inward from the sash or frame holding the windowpane when viewed from the interior or exterior. In some cases, such encroachment may occur less than one inch of the interior windowpane surface such that the hardware component interferes mounting of a supplemental window apparatus to a windowpane. One example of such encroachment is illustrated in FIG. 38A, in which window frame casing 1040 holds top sash 1042 and bottom sash 1044 of a double hung window. In this illustration, sash lock elements 1046 are present at checkrail 1048. Various sash lock elements are generally attached respectively to the top sash checkrail or bottom sash checkrail to allow locking closure of the window. Other non-limiting examples of encroaching window hardware include, handles, latches, locking pins, crank mechanisms, security hardware, etc. which may be attached to one or both of sashes 1042 and 1044. When such a hardware component is present, it is beneficial to incorporate a cutout portion of the supplemental

Illustrated in FIG. 38B is a cutout region viewed from the bottom along M-M′ at L-L′, omitting lock 1046 for clarity. Illustrated in FIG. 38C is the cutout region viewed from the room side of the window, further showing bottom sash checkrail 1048, and seals omitted for clarity. The cutout is substantially bounded by cutout flaps 1050 and 1052, each of which may be formed by bending of a perimeter portion of sheet 1054 or may be separate parts adhered to sheet 1054. Sealing between each cutout flap 1050 and 1052 and the windowpane 1056 is accomplished by a seal 1058 that is attached to the cutout flap for which it provides sealing, a seal attached to another cutout flap or a seal 1060 attached to flap 1062. Seals 1058 and 1060 may be attached to the inward or outward side of their respective flap 1050, 1052 and 1062 and extend inward or outward from their respective flap. Though FIGS. 38A, 38B and 38C are shown without a stiffener attached to each flap, it is understood that one or more of the cutout flaps may have a stiffener attached along its length.

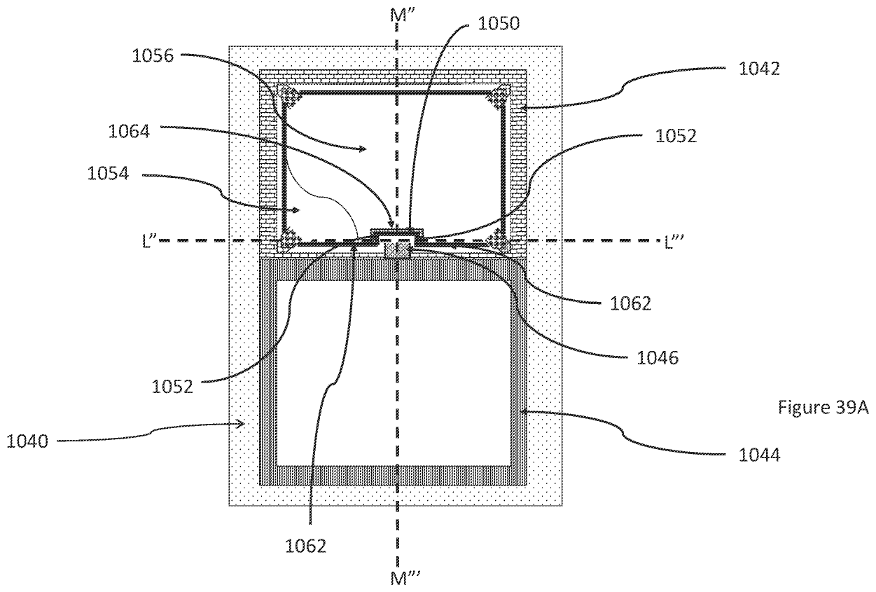

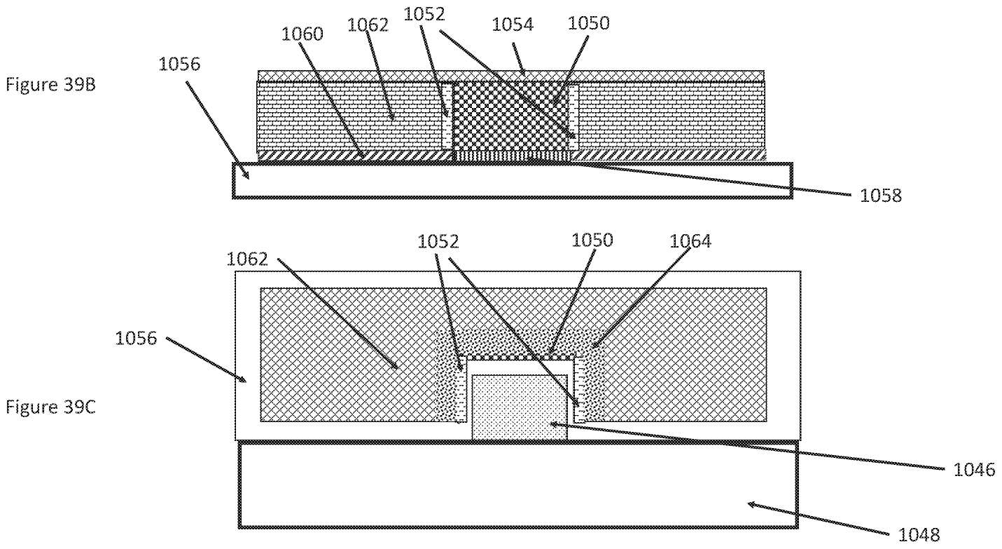

In further embodiments, a cutout brace may be used inward or outward of cutout flaps 1050 and 1052 as illustrated in FIG. 39A for an inward cutout brace 1064. As illustrated in FIG. 39B (upward view M″-M′″ at L″-L′″ omitting lock elements 1046 for clarity) and FIG. 39C (interior side viewing to exterior), in each embodiment cutout brace 1064 attaches to cutout flaps 1050 and 1052 (illustrated inward) and substantially reinforces and closes any openings that may exist between the cutout flaps 1050, 1052 and flaps 1062. Further, cutout brace 1064 may attached to sheet 1054 by, for example, adhesive, welding or other attachment which may provide closure at the attachment interface between cutout brace 1064 and sheet 1054. A seal 1058 may be attached to cutout brace 1064 such that the seal 1058 compresses against windowpane 1056 to trap air between sheet 1054 and windowpane 1056. Cutout brace 1064 is preferably colorless and transparent, such as an injection molded colorless, transparent plastic. To mitigate bowing that may occur along the perimeter edge having the cutout, cutout brace 1064 may be attached to windowpane 1056 using an attachment mechanism, for example, adhesive or fastener as described supra or infra. While the cutout brace just described is shown inward of cutout flaps 1050 and 1052, it will be appreciated that the cutout brace may alternatively be continuously attached, adhered or welded outward of the cutout flaps. When a cutout brace is used at a location having a protruding muntin, the cutout brace may have a notch similar to that described for closure 1020 to allow the protruding muntin to cross the cutout brace without forcing the cutout brace away from the windowpane.

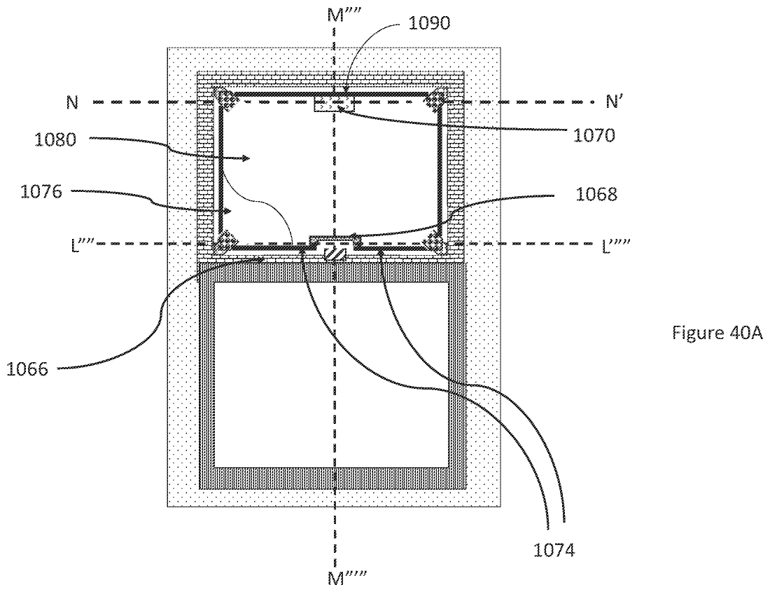

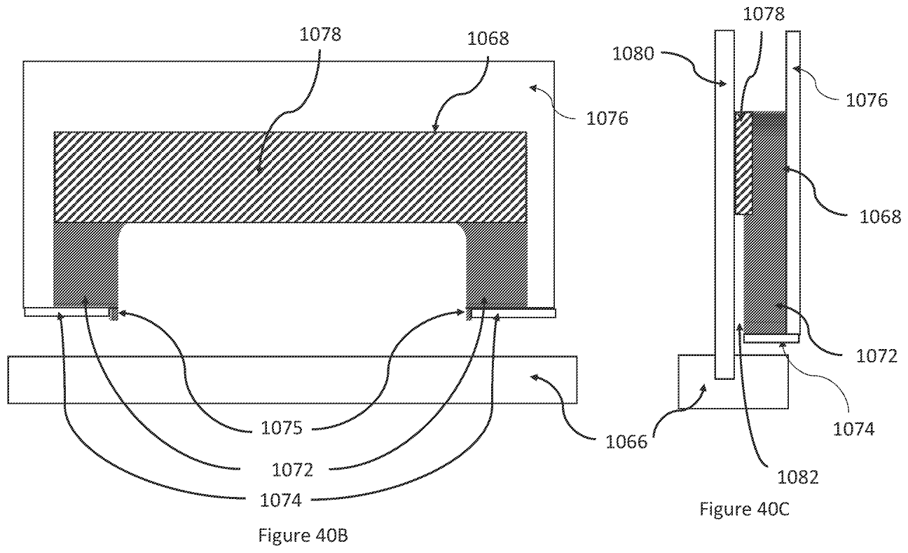

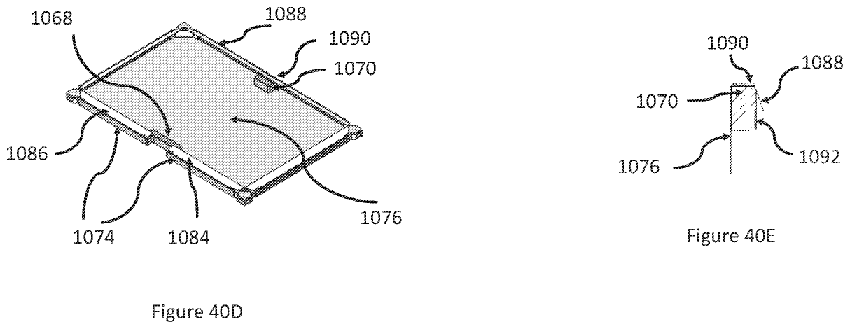

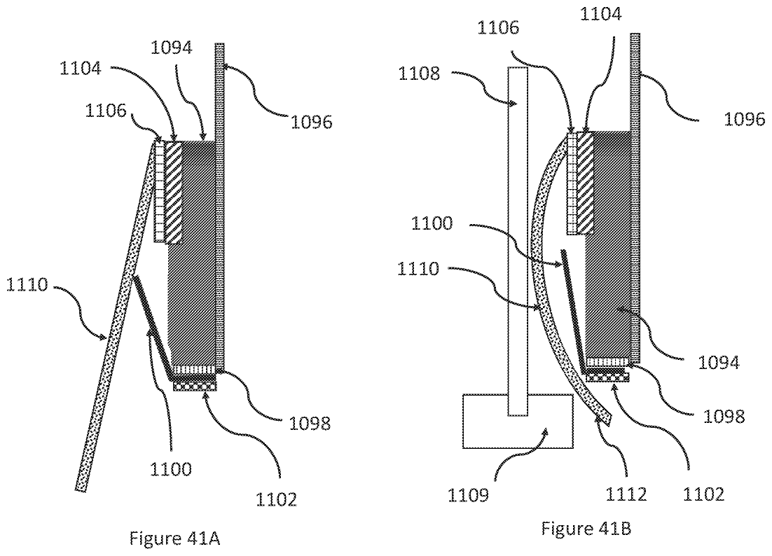

In another embodiment, FIG. 40A, FIG. 40B, FIG. 40C, FIG. 40D, FIG. 40E and FIG. 40F illustrate, near the intersection of L″″-L′″″ and M″″-M′″″ near checkrail 1066, a cutout brace 1068 having no cutout flaps of a vertically sliding window and an edge spacer 1070 at the intersection of N-N′ and M″″-M′″″. As illustrated in FIG. 40B viewing from the windowpane side of the cutout, legs 1072 of cutout brace 1068 contact or are adhered to flaps 1074 while being adhered to sheet 1076. Flaps 1074 may have stiffeners (not shown) attached as described supra. Optionally, as illustrated in FIG. 40B, alignment tabs 1075 may be provided on cutout brace legs 1072 to aid in positioning within flaps 1074 on each side of the cutout. Cutout brace 1068 may be formed to accept adhesive strip 1078 that adheres cutout brace 1068 to windowpane 1080 as illustrated in FIG. 40C. Adhesive 1078 is placed on the inward windowpane side cutout brace 1068 as illustrated in FIG. 40C in such a way as to adhere to the windowpane while creating a thin space 1082 for the seal to press against the windowpane. Cutout brace 1068 may be attached, for example by adhesive or welding, to sheet 1076.

FIG. 40D illustrates a windowpane side isometric view of the supplemental window apparatus of this embodiment, with seals 1084 and 1086 adjacent to cutout brace 1068. Seals 1084 and 1086 compress to windowpane 1080 when the supplement window apparatus is mounted. Portions of seals 1084 and 1086 may fit into thin space 1082 and be compressed to windowpane 1080 by cutout brace 1068 for substantial closure of the cutout opening region when mounted.

In one embodiment illustrated in FIG. 40E for a side view of an edge spacer, seal 1088 is adhered to flap 1090 and bends under a portion of edge spacer 1070 so that edge spacer 1070 and inward extending portions of seal 1088 substantially close the volume of air between the sheet and the windowpane, in a manner similar to that just described above for a seal fitting into a thin space between a cutout brace and windowpane. Edge spacer 1070 may an adhesive strip 1092 on the inward windowpane side to adhere to windowpane 1080. Edge spacer 1070 may be attached, for example by adhesive or welding to sheet 1076 and/or flap 1090.

Cutout braces and edge spacers that adhere to the windowpane may perform an additional function to prevent bowing along long dimensions of the supplemental window apparatus and act as a spacer along the edge on which it is located. As illustrated in FIG. 40D and FIG. 40E an edge spacer 1070 may also be used along an edge that does not require a cutout. FIG. 40D illustrates an isometric exterior view of the top supplemental window apparatus illustrated in FIG. 40A. Edge spacer 1070 is configured to contact seal 1088 attached along the same edge flap 1090 while adhering to both sheet 1076 and the windowpane (not shown). FIG. 40E illustrates a side view of edge spacer 1070 contact with seal 1088, viewed along N-N′ at M″″-M′″″, which may be such that seal 1088 is between edge spacer and windowpane (not shown) and adhesive 1092 provides adhesion to the windowpane in a manner similar to that described for FIG. 40C, or contact may be with a seal portion that is oriented substantially perpendicular to the sheet and windowpane. In an alternative embodiment, such an edge spacer may be created with two parts, one part each adhered to the sheet and windowpane, respectively, where the two parts fasten together using a mechanism such as mushroom heads or hook and loop as described supra. Optionally, a stiffener may also be provided along the same edge as edge spacer 1070.

For ease of installing supplemental window apparatus technologies having sealing material on a seal, or an edge spacer or cutout brace having adhesive, a liner may be provided to cover a sealing material or an adhesive. FIG. 41A illustrates a side view of a cutout brace 1094 attached to sheet 1096 and flap 1098. Also illustrated is creased seal 1100 attached to flap 1098 and stiffener 1102. Cutout brace 1094 is shown with adhesive strip 1104 that is protected by liner 1106. Liner 1106 may be substantially the same size and shape as exposed adhesive strip 1104 that adheres to windowpane 1108 held by sash, mullion, muntin or frame 1109. Alternatively, liner 1106 may be larger than adhesive strip 1104. In a further embodiment, liner 1106 may have a tab 1110 or be formed in a “J” shape or be creased to a “V” shape to create tab 1110. Tab 1110 extends outward from adhesive strip 1104. As illustrated in FIG. 41B, such a configuration allows mounting of supplemental window apparatus, for example by first fastening at another location such as corners, followed by pulling accessible tab portion 1112 of tab 1110 to peel liner 1106 from adhesive 1104 while the supplemental window apparatus is held on the window. After removal of liner 1106, pressure may be applied perpendicular to and toward the windowpane to force adhesive 1104 into contact with windowpane 1108. When such pressure is applied, seal 1100, which is attached to flap 1098 in this example, bends toward cutout brace leg 1114 while contacting windowpane 1108. It will be appreciated that such liners as just described may also be used to protect sealing material provided on seals and adhesive on edge spacers. Materials suitable for use as liners are those known in the art, such as plastic films which may have a release layer, such as a silicone or other low surface energy release layer, that contacts the adhesive or sealing material.

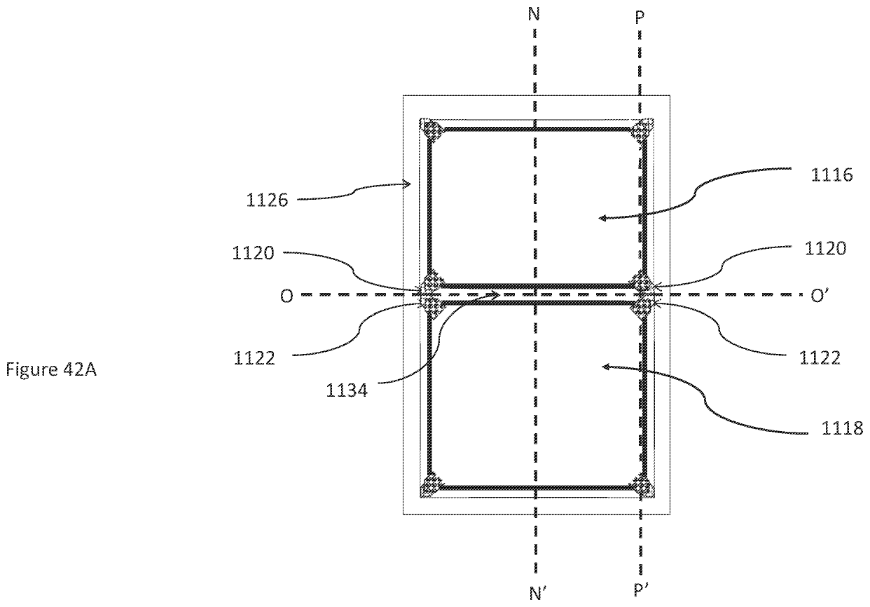

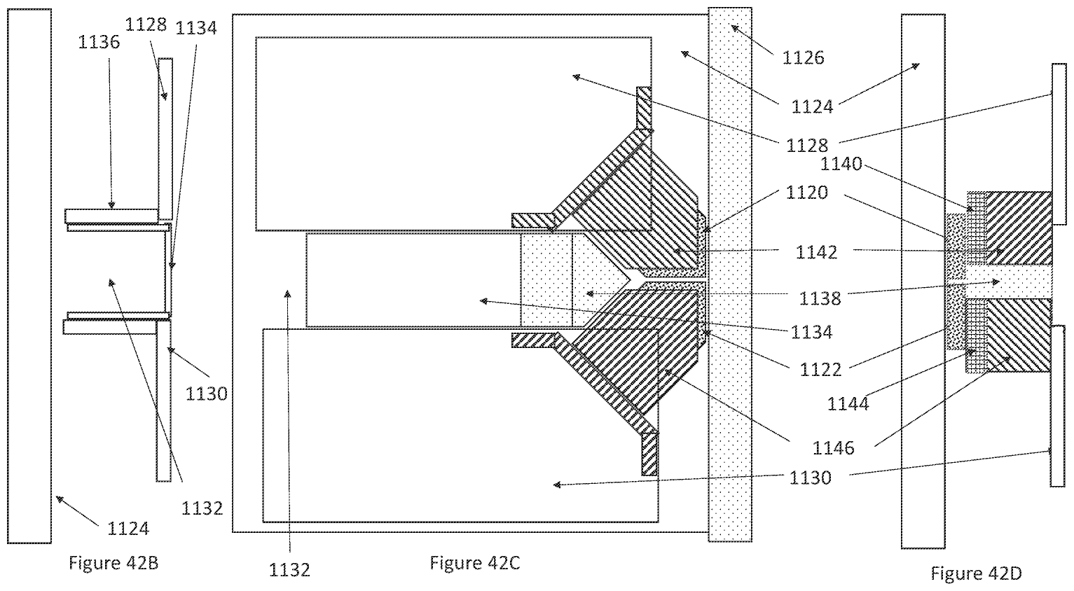

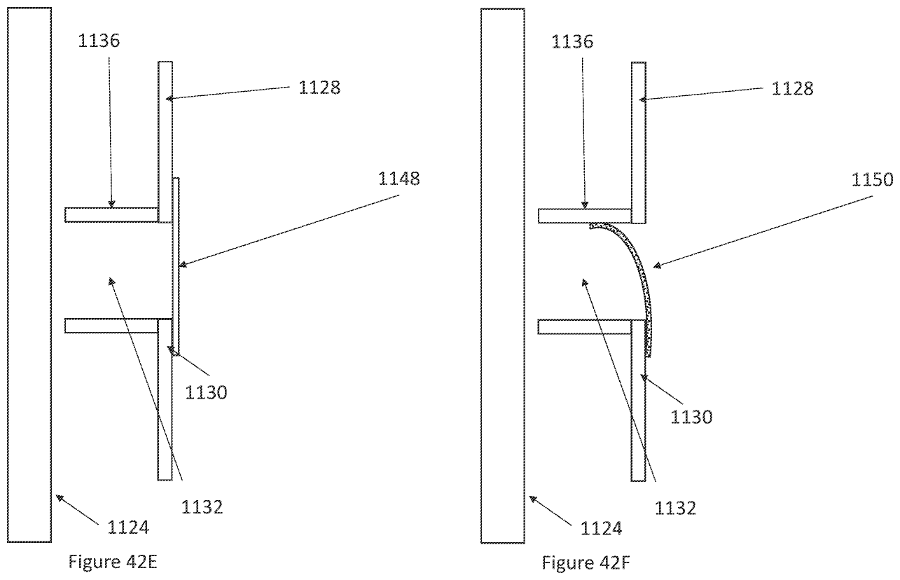

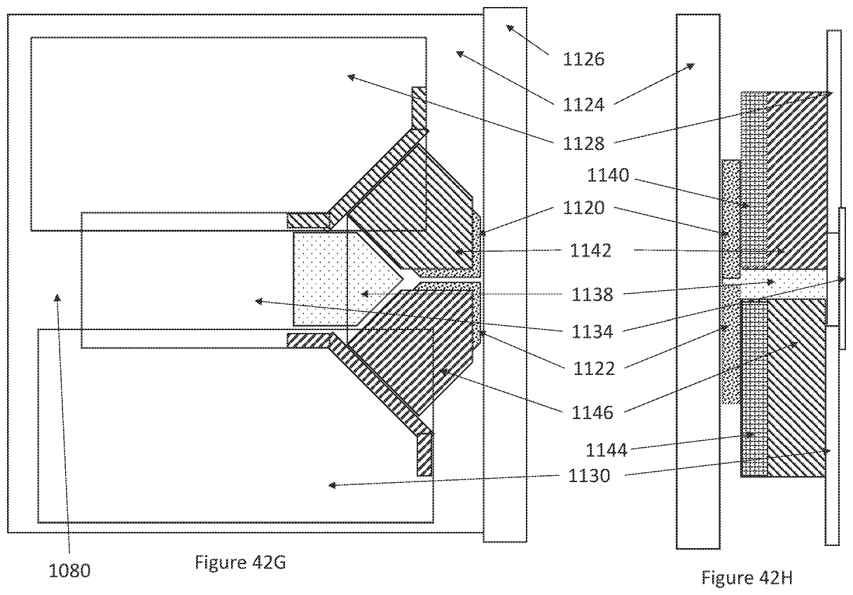

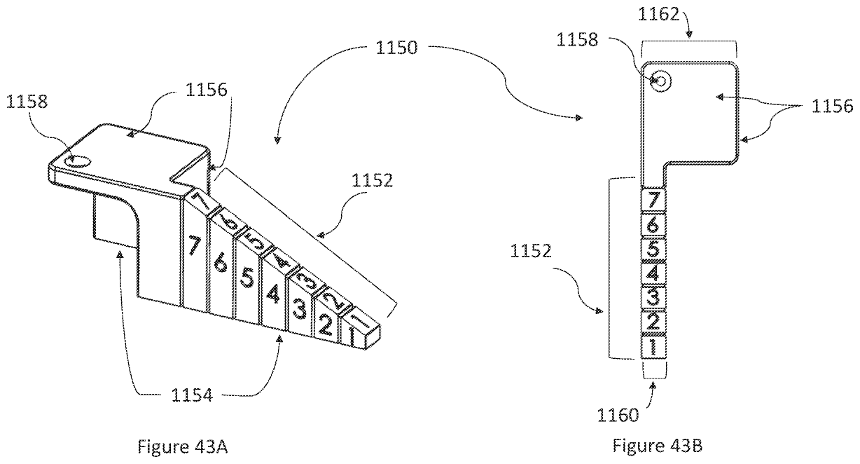

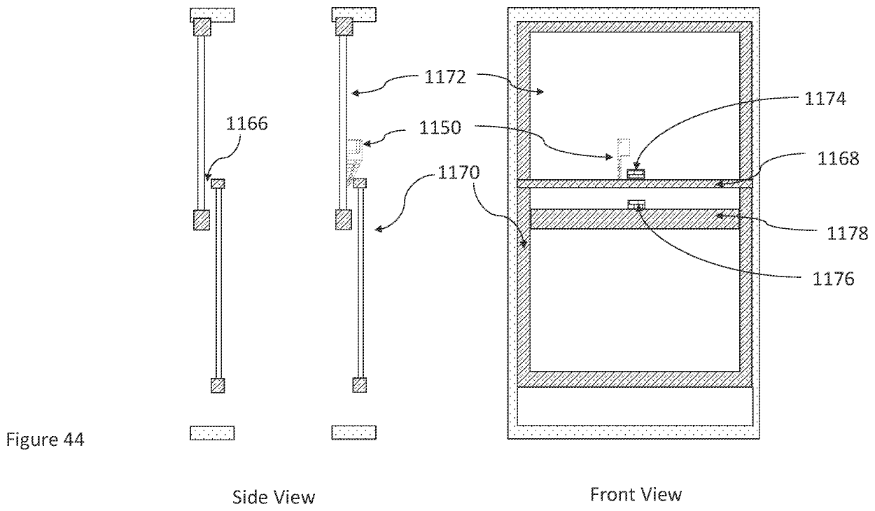

For very large windowpanes, tiling of more than one supplemental window apparatus may be used to substantially insulate the entire windowpane area. FIG. 42A illustrates use of two tiles disposed one above the other, each tile being a supplemental window apparatus. Top tile 1116 and bottom tile 1118 fasten to the windowpane corners in a manner similar to that described supra. FIGS. 42B, 42C and 42D illustrate an embodiment that includes top tile and bottom tile edge mating fasteners 1120 and 1122, respectively, which are provided at windowpane 1124 edges adjacent frame 1126 edge for fastening of the bottom corners of top tile 1116 and top corners of bottom tile 1118. When such tiling is used, top tile sheet 1128 and bottom tile sheet 1130 may leave a channel 1132 between adjacent tiles 1116 and 1118. Viewing along O-O′ at N-N′, channel 1132 is beneficially covered as illustrated in FIG. 42B. Inter-tile channel cover 1134 contacts the respective flap 1136, or a stiffener or seal (not shown) attached to flap 1136, at the interface edge of each tile, and may optionally contact the interior surface of sheets 1128 and 1130. Such contact with flap 1136 may be by friction fitting or attachment, such as with adhesive to one or both tiles on each side of the interface. Inter-tile cover 1134 may be transparent to visible light or, optionally, made to have an opaque color substantially matching that of other window elements that may be present, such as frame, sash or mullion elements, or contain tinting, infrared or ultraviolet reflecting or absorbing materials, or low emissivity materials. As illustrated in FIG. 42B, air may be trapped between inter-tile channel cover 1134 and windowpane 1124 so the channel region may provide additional insulation. Further confinement of the air within channel 1132 may be provided as illustrated in FIG. 42C and FIG. 42D using plug 1138. Plug 1090 substantially closes an end of channel 1132, thus creating a substantially “dead-air” space in channel 1132 for insulation and blocking access to the channel by insects and dust particles. Alternatively, the channel ends may be blocked using an extension (not shown) of channel cover 1134 that is bent toward windowpane 1124 to substantially cover a channel end. When configured as shown in FIG. 42B, the air in channel 1132 may be in communication with the air space created when top tile 1116 and bottom tile 1118 are mounted to windowpane 1060. Alternatively, seals (not shown), such as those described supra, may be used to create separate a “dead-air” space in channel 1132 between the “dead-air” spaces created by each of tiles 1116 and 1118 and their respective portions of windowpane 1124.

FIG. 42C and FIG. 42D also illustrate a windowpane edge fastening location at a tiling interface. FIG. 42C illustrates P-P′ at O-O′ when viewed from the interior side of the window shown in FIG. 42A. FIG. 42D illustrates view O-O′ at P-P′. Mating fasteners 1120 and 1122, which may abut each other, provide fastening locations for lower right fastener 1140 on the exterior side of foot 1142 of top tile 1116 and upper right fastener 1144 on the exterior side of foot 1146 of bottom tile 1118.

Alternative embodiments for covering an inter-tile channel are illustrated in FIG. 42E, FIG. 42F, FIG. 42G and FIG. 42H. In one embodiment, FIG. 42E illustrates, viewing along O-O′ at N-N′, channel cover 1148 may be adhered one or both of the interior surfaces of sheet 1128 and sheet 1130. When adhered to only one sheet interior surface, channel cover 1148 contacts the second sheet interior surface on the opposite side of channel 1132. In another embodiment, viewing along O-O′ at N-N′, FIG. 42F illustrates that channel cover 1150 may be adhered to only one of the sheets, in this case bottom tile sheet 1030, while being shaped (either prior to or upon installation) so that it bends toward windowpane 1124 while contacting or adhering to flap 1136, or a stiffener or seal attached (not shown) to flap 1136 of an adjacent tile on the other side of channel 1132. Channel cover 1148 or 1150 may comprise a material similar to an infiltration blocker. In a further embodiment, channel cover 1148 may also be combined with channel cover 1134 features that are substantially perpendicular to windowpane 1124 and, optionally, may be made as a unitary extrusion (not shown). Alternatively, when channel cover 1148 or 1150 is adhered to a first sheet of sheet 1128 and 1130, a second channel cover may be adhered to the second sheet of an adjacent tile such that the two channel covers overlap with each other.

FIG. 42G and FIG. 42H illustrate, respectively, an interior to exterior view at the intersection of O-O′ and P-P′ and a view along O′-O at P-P′ in which a plug 1138 at each end of channel 1132 confines air in channel 1132 in combination with inter-tile channel cover 1148. In a further embodiment, channel cover 1148 may be adhered to a plug 1138 at each end of channel 1132, with adhesive from sheet 1128 to sheet 1130, such that channel cover 1148 contacts at least one of the sheet, flap, stiffener or seal of each tile adjacent to channel 1132. While the above descriptions and FIGS. 42A-G illustrate tiling with one tile above a second tile, it will be appreciated that similar tiling may be provided with the tiles mounted side-by-side such that the above-described channels have their longest dimension in a vertical orientation.

The fasteners described supra for supplemental window apparatuses may be, for example, mushroom head fasteners such as 3M Dual Lock fasteners or similar snap together fasteners. When used with corners that are made of, for example an injection molded plastic, it can be beneficial to add materials that absorb or otherwise stabilize plastic material that can degrade when exposed to excessive ultraviolet light. For example, seals may contain ultraviolet absorbing material. When such seals compress between the spacer and windowpane, this ultraviolet absorbing material can protect the spacer. Foot portions of corner elements may be protected by placing within the fastener a material similar to ultraviolet absorber containing seal. In such cases, the film may be patterned with holes or slits that conform to the locations of fastener engagement elements such as mushroom heads and stems. Alternatively, a layer of ultraviolet absorber containing material may be sprayed on one or both sides of a fastener used to connect a foot portion to a windowpane

In supplemental window apparatus embodiments described supra, it is helpful to obtain accurate dimensions for clearance of sliding windows, and/or location and size of window locks, handles and/or latches, if present, for which cutouts are beneficial. In addition, the width and depth dimensions of protruding muntins, if present on a window, is beneficial for designing and fabricating a supplemental window apparatus that will fit onto such a window. Obtaining such dimensions may be aided by the use of a tool or gauge. An embodiment of such a tool or gauge is illustrated in FIG. 43A (isometric view) and FIG. 43B (top view). Gauge 1150 is comprised of a known variable thickness portion 1152, a flat planar portion or surface 1154 (hidden) and a grip portion 1156. Variable thickness portion 1152 may be provided with indicia, for example numbers, colors and/or lines, to identify different thicknesses along variable thickness portion 1152. Such indicia may be placed on a side opposite and/or perpendicular to flat planar surface 1154 so that indicia may be easily observed by the user or a recording device when placed on a window for measurement. For example, the line immediately below each number illustrated in FIG. 43B may correspond to each ⅛th inch of height from flat planar surface 1154. As an alternative to flat planar surface 1154, at least three planar non-colinear features may be provided so that the variable thickness portion 1152 maintains accurate distance measurement perpendicular to stationary windowpane as described infra. Variable thickness portion 1152 or grip portion 1156 may be provided with a known width 1160 or 1162, respectively, that may also be used for measurement.

FIG. 44 illustrates a front view and side view of a partially opened double hung window 1164 with clearance 1166 between checkrail 1168 of bottom sash 1170 and having gauge 1150 is inserted between bottom sash checkrail 1168 and stationary top sash windowpane 1172. In this embodiment, a portion of variable thickness portion 1152 remains visible above checkrail with flat planar portion 1154 contacting and substantially parallel to top sash windowpane 1172. When positioned in this way, the lowest number visible provides indication of clearance 1166 dimension. The user of the gauge may then record the number that appears immediately adjacent checkrail. Recording may be performed by writing the number or capturing the number in a digital recording device, for example in a spreadsheet on a computing device, a voice audio recorder or a digital image on a computing device such as a table or smartphone.

When a digital image is recorded of gauge 1150 and lock element 1174 in the same image, dimensions of lock element 1174 may be estimated using known width 1160 or 1162 using, for example, methods described in U.S. Pat. Nos. 8,923,650 and 9,208,581, the disclosures of which are incorporated by reference herein in their entirety, where known width 1160 or 1162 is used as a reference object dimension. Clearance between stationary top sash lock element 1176 and windowpane 1172 may be determined by closing bottom sash 1170 and by placing variable thickness portion 1152 parallel to stationary top sash checkrail 1178 and between lock element 1176 and windowpane 1172 with flat planar portion 1154 contacting and substantially parallel with windowpane 1172.

Gauge 1150 may, optionally, be provided with a hole 1158 to allow for convenient carrying by a user of the gauge on a lanyard or similar loop. In another embodiment, feeler gauges may be used to obtain the above-described measurements. It will be appreciated that horizontal sliding window clearance measurement may be made in an analogous manner as described for a double hung window.

In each embodiment described supra, in addition to the attachment mechanisms described for mounting, a safety feature (e.g., a clip) attaching to a portion of the window not used for mounting (e.g., a frame, a sash or a protruding muntin) may be included. When provided, the safety feature is in mechanical communication with the frameless supplemental window such that in case of failure of the various attachment mechanisms described supra, the safety feature inhibits the frameless supplemental window from falling away from the fenestration.

Note that corner braces and constraints can be fabricated, for example, by injection molding, thermoforming or three-dimensional printing methods. As part of extrusion for fabricating the sheet and edging parts, injection molding or 3D printing operations for fabricating corner braces and constraints, printing, embossing or other means of part identification, material type and recyclability, installation instructions and mating indicators may be imparted on each such part. Other aspects of fabrication may include the chopping, cutting or slitting of materials, application of adhesives and associated protective covers for applied adhesives and packaging material. Another example of fabrication may include, prior to packaging, edge seals as shown in FIGS. 21A through 21F may each be wound tightly back on itself and kept tightly wound using adhesive (e.g., glue or tape attachment to the sheet material) or a clip to keep the edge seal in a tube-like state through mounting. Once mounted, the adhesive connection may be broken or the clip removed to allow the wound edge seal to relax and compress against the window pane and/or sash/frame. Formation of the sheet, edge seal and other supplemental window parts described supra into a custom supplemental window during fabrication may be performed to minimize installation complexity. Such formation may be by adhesive, or preferably welding, heat sealing, mechanically, etc. to aid in end-of-life recycling or re-use of the materials.

When an end user no longer wishes to use the custom supplemental parts, for example due to moving to a different location, the custom supplemental parts may be recycled or re-used by a subsequent occupant at the location of the installation. When recycling the custom supplemental parts, such recycling may be achieved by the end user through a local recycling program, sent to a local retailer for recycling or sent to the service provider for recycling. When sent to the service provider for recycling, the custom supplemental parts may also be resold, with refurbishment or remanufacturing if necessary, to a different end user having similar, though perhaps slightly different, design requirements as the original end user. For example, the shape of a plastic sheet might be altered slightly by cutting along an edge while other components are re-used without modification.

Alternatively, the service provider may separate the custom supplemental parts from multiple end users so that such parts may be recombined in different combinations to meet the design requirements of a new end user. Another recycling route that may be used by the service provider or fabricator is to have the received parts enter a recycling stream in which the parts re-enter a manufacturing stream at a raw material stage where they are reformed into a new shape or part. The materials used for corner braces, the plastic sheet, or the edging may be chosen to optimize certain characteristics, depending on the part and end user design choices. It is preferred that the materials used for each part are chosen so that each part may be reused, recycled or remanufactured.

For use as corners, corner braces, cutout braces, edge spacers, supports, or posts, materials having sufficient stiffness while providing the supplemental window mechanical stability are desirable. As the custom supplemental parts may be exposed to sunlight for extended periods, ultraviolet stabilizers can be added to the materials to maintain optical and mechanical properties or materials with inherent stability to ultraviolet and visible light may be chosen. Suitable materials for the plastic sheet, corner, cutout brace, edge spacer or edging include, polyethylene terephthalate, polyethylene terephthalate glycol-modified, acrylic such as polymethylmethacrylate, polyvinyl chloride, cellulose acetate, or polycarbonate, each of which may contain ultraviolet stabilizer material, as well as ultraviolet stabilized polypropylene or polyethylene. Flexible glass may also be suitable for use as a sheet material.

Plastic materials that may be useful for one or more of the supplemental window components may include vinyl, such as polyvinyl chloride or acrylic, polyethylene, polypropylene, or polycarbonate. When polycarbonate is used, polycarbonates may include those that are made by reacting carbon dioxide with organic compounds such as epoxides.

For use as edging material, materials that are also flexible and easily bent and shaped are preferred. For example, polyethylene terephthalate may be used in a thickness range of approximately 3 to 8 mil to allow for on site adjustment of the edge seal by the spring, though a larger thickness may be used if no adjustment capability is required. If the supplemental window apparatus is used to provide protection of the window pane from potentially destructive forces, edging material thickness up to that of the sheet thickness may be beneficial as well, as destructive forces may be dissipated through deformation of the edge seal as well as deformation of the sheet. If transparency of the window opening is desired, materials having relatively high transparency, clarity and gloss as well as low haze are useful in the present technology. For use as spring material, polyethylene terephthalate strip and ring in a thickness range, respectively, of approximately 10 to 60 mil and approximately 5 to 20 mil has been found to yield acceptable results. For use as infiltration blocker material, a transparent, flexible non-porous material may be used such as polyethylene terephthalate in a thickness range of approximately 2 to 10 mil.

Additionally, the plastic sheet, edge seal and/or infiltration blocker may comprise other materials dispersed within it or in the form of layers. For example, a plastic sheet, edge seal or infiltration blocker comprising other materials is particularly useful when emissivity, transmittance, absorptance and/or reflectance control is desired. One type of such material may be the addition of a laminate, for example a multilayer laminate comprising an infrared reflective layer and a scratch resistant layer such as those found in currently available window films or an amorphous diamond-like carbon film, which may be fluorinated and/or hydrogenated. When used in the present technology, having such scratch resistant layer on the interior side of the supplemental window apparatus sheet is beneficial to inhibit scratching due to sliding by a movable sash over the apparatus on a stationary windowpane. When a scratch resistant layer is applied to the sheet as part of a laminate as found in window films, it can be beneficial to include a UV blocking cap layer on the exterior facing side of the sheet or to incorporate a UV stabilizer within the bulk of the sheet material. When a laminate as found in window films is applied to the exterior side of the sheet, such laminate generally provide UV protection for the sheet material. Such sheets, edge seals or infiltration blockers may include materials such as transparent plastic that has been metalized or dyed, or may comprise ceramic (inorganic oxides such as tin oxide or indium oxide, or metal hexaboride or metal nitride or metal oxynitride or metal silicide, preferably less than 200 nm in diameter, more preferably less than 100 nm in diameter or hydrogenated metal nitride, such as aluminum nitride, titanium nitride or titanium aluminum nitride dielectric layer less than about 150 nm in thickness as described in US 20200139935) film laminates that are applied as a thin layer to transparent sheets. Such materials may also act as a filter for reflecting most ultraviolet and/or infrared wavelengths while allowing transmission of visible light. For the purpose of laser welding, the plastic sheet or edging may comprise an infrared absorber near the joining surface of one of the parts to be welded.

Alternatively, the plastic sheet and/or edging may comprise materials that control the visible light transmitted for effecting privacy purposes. When using emissivity or reflectivity control layers or treatments, the sheet may be mounted on the interior or exterior side of the window pane to provide the surface treatment location that provides optimal energy savings. For example, during cold weather seasons, mounting a low-e or infrared reflective material to the interior of the pane is preferred, while during hot weather seasons it is preferable to mount the low-e or infrared reflective material to the exterior of the pane.

The plastic sheet may also have printing on the portion through which the window pane is visible. Such printing may include logos, decals or figures for desired aesthetic purposes, or line patterns, such as those used to inhibit bird strikes on the window. For plastic sheet parts, mechanical, optical and thermal conduction properties of the sheet may be optimized in different ways depending upon the end user product choices. When used on the exterior of the original window, high impact resistance may be desirable.

In the foregoing, use of expressions such as “comprise”, “include”, “incorporate”, “is”, “are”, “have”, “contain” are not intended to be exclusive, namely such expressions are to be construed to allow other unspecified items also to be present. Reference to the singular is to include reference to the plural and vice versa. In the accompanying claims, numerals included within parentheses (if any) are for assisting understanding of the claims and are not intended to influence claim scope.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the technology and the practical application, and to enable others of ordinary skill in the art to understand the technology for various embodiments with various modifications as are suited to the particular use contemplated.

1.-52. (canceled)

53. A supplemental window apparatus comprising:
a substantially non porous sheet;
a stiffener attached to an edge portion of the sheet, the stiffener is configured to be spaced from a windowpane when the supplemental window apparatus is mounted to the window;
an edge seal configured to contact at least one of a windowpane and a first window element when the supplemental window apparatus is mounted to the window, wherein the substantially non porous sheet has a sheet area substantially similar to a windowpane area defined by the interior surfaces of the first window element.

54. The supplemental window apparatus as set forth in claim 1, the edge seal has a cross-sectional dimension smaller than the sheet thickness.

55. The supplemental window apparatus as set forth in claim 1, wherein the seal is creased.

56. The supplemental window apparatus as set forth in claim 1, further comprising a corner closure.

57. The supplemental window apparatus as set forth in claim 4, wherein the corner closure comprises a spacer.

58. The supplemental window apparatus as set forth in claim 1, wherein the edge portion of the sheet comprises a flap.

59. The supplemental window apparatus as set forth in claim 1, further comprising a constraint configured to be attached to a windowpane constraint at a corner area of a first window element of an existing window, the corner area defined by interior surfaces of the first window element holding the windowpane,

60. The supplemental window apparatus as set forth in claim 1, wherein the stiffener is located between the sheet and the windowpane.

61. The supplemental window apparatus as set forth in claim 1, wherein the stiffener is located outward from the sheet and substantially perpendicular to the windowpane.

62. The supplemental window apparatus as set forth in claim 1, further comprising an active device.

63. The supplemental window apparatus as set forth in claim 62, wherein the active device is one of an electrochromic device, polymer dispersed liquid crystal device, or a solar cell array device.

64. The supplemental window apparatus as set forth in claim 1, further comprising a cutout brace at a sheet edge.

65. The supplemental window apparatus as set forth in claim 1, further comprising a notch cut out along a sheet edge.

66. The supplemental window apparatus as set forth in claim 65, wherein the notch is cut out of a flap.

67. A supplemental window apparatus comprising:
a substantially non porous sheet;
a cutout brace at a sheet edge;
a constraint configured to be attached to a windowpane constraint at a corner area of a first window element of an existing window, the corner area defined by interior surfaces of the first window element holding the windowpane, wherein the substantially non porous sheet has a sheet area substantially similar to a windowpane area defined by the interior surfaces of the first window element.

68. The supplemental window apparatus as set forth in claim 67, further comprising an edge seal.

69. A method of adding insulation to a windowpane comprising:
mounting at least two supplemental window apparatuses to the windowpane, the supplemental window apparatuses forming a channel along edges of adjacent supplemental window apparatuses; and
covering the channel with an inter-tile channel cover wherein the inter-tile channel cover contacts each supplemental window apparatus.

70. The method set forth in claim 69, wherein the method further comprises closing an end of the channel.
